(19) United States
(12) Patent Application Publication
(10) Pub. No.: US 2025/0145792 A1
(43) Pub. Date: May 8, 2025

(54) POLYMER COMPOSITIONS HAVING DENSIFICATION ACCELERATORS AND ROTATIONAL MOLDING PROCESSES FOR MAKING HOLLOW ARTICLES THEREFROM

(71) Applicant: Cytec Industries Inc., Princeton, NJ (US)

(72) Inventors: Jerry Mon Hei Eng, Wilton, CT (US); Ram B. Gupta, Stamford, CT (US); Joseph Kozakiewicz, Trumball, CT (US); Jian-Yang Cho, Easton, CT (US); Gregory Martin Treich, Somerset, NJ (US)

(73) Assignee: Cytec Industries Inc., Princeton, NJ (US)

(21) Appl. No.: 18/726,075

(22) PCT Filed: Dec. 22, 2022
(86) PCT No.: PCT/US2022/053773

§ 371 Date: Jul. 1, 2024

Related U.S. Application Data
(60) Provisional application No. 63/295,879, filed on Jan. 1, 2022.

(51) Int. Cl. C08K 5/06; B29C 41/00; B29C 41/04; B29K 23/00; B29K 77/00; B29K 105/00; B29L 22/00; C08K 5/098; C08K 5/103; C08K 5/1545; C08K 5/17; C08K 5/3492; C08K 5/526

(52) U.S. Cl. CPC C08K 5/06; B29C 41/003; B29C 41/042; C08K 5/098; C08K 5/103; C08K 5/1545; C08K 5/17; C08K 5/34924; C08K 5/526; B29K 2023/06; B29K 2023/0625; B29K 2077/00; B29K 2105/0005; B29K 2105/0044; B29L 2022/00; C08K 2201/014

(57) ABSTRACT

Rotational molding processes for producing hollow articles include the steps of: a) filling a mold with a polymer composition comprising: i) an organic polymer; and ii) a rotational molding densification accelerator (RMDA) selected from the group consisting of alkoxylated fatty alcohols, alkoxylated fatty esters, alkoxylated fatty amines, alkoxylated fatty amides, and combinations thereof; b) rotating the mold around at least one axis while heating the mold in an oven, thereby fusing the composition and spreading it to the walls of the mold; c) cooling the mold; and d) opening the mold; and e) removing the hollow article from the mold. The rotational molding processes using such polymer composition results in faster densification, which allows for reduction in overall cycle times for making the hollow articles.

### CROSS REFERENCE TO RELATED APPLICATIONS

This application claims benefit of U.S. Provisional Application No. 63/295,879 filed Jan. 1, 2022 and is incorporated herein by reference in its entirety.

### BACKGROUND

### Field

The present invention generally relates to the production of hollow articles using the rotational molding process. More particularly, the present invention relates to the use of additives described hereinbelow as Rotation Molding Densification Accelerators (RMDAs) in the rotational molding process. These RMDAs provide cycle time reduction and a broader processing window for the rotational molding process.

### Description of the Related Art

Rotational molding, or rotomolding, is a high-temperature, low-pressure forming process that uses heat and biaxial rotation to produce hollow, one-piece parts, from organic polymers. Hollow parts made by rotomolding include, for example, gasoline containers, garbage cans, agricultural storage vessels, septic tanks, toys, and sporting goods such as kayaks.

The rotational molding process is described, for example, by R. J. Crawford and J. L. Throne in Rotational Molding Technology; Plastics Design Library, William Andrew Publishing, 2001. Rotational molding requires a mold (shell) with means for rotating the mold in two or three axes in an oven. Finely divided polymer particles are loaded into the mold, and the mold is then rotated (usually, on two axes) while heating it to a target temperature above the melting point of the polymer, referred to as the Peak Internal Air Temperature. The molten polymer flows through the mold cavity under the rotational forces and rotation continues for sufficient time and temperature to allow the molten polymer to cover the entire surface of the mold at a uniform thickness. The mold is then cooled to permit the polymer to freeze into a solid. The final step is the removal of the hollow article from the rotomolding machine. The total time required for the combined steps of filling the mold, rotating the mold, cooling the mold, opening the mold, and removing the hollow article is known in the art as the “cycle time” of the process.

There are three main physical processes that occur in polymer particles used in rotational molding: sintering or coalescence brought about by melting the polymer particles to form a continuous phase, densification of the polymer continuous phase caused by bubble removal, and crystallization of the polymer brought about by cooling.

Bubble removal and the resulting densification of the polymer continuous phase is an important part of the rotomolding process, which affects the physical properties of the part formed.

The time required to complete the molding cycle (“cycle time”) is also a function of the bulk properties of the polymer which is being molded. For example, the polymer which is charged into the mold is preferably finely divided (i.e., ground into a powder) and has a high bulk density and a narrow particle size distribution to facilitate the “free flow” of the polymer particles.

The time and temperature the polymer-filled mold is in the oven (“cooking” time and temperature) are critical to the quality of the hollow part. If the time is too short and the temperature is too low, the sintering and laydown of the molten polymer and dissipation of air bubbles will be incomplete, thereby negatively affecting the final mechanical and physical properties of the molded article (reduced impact strength). The part is said to be “undercooked”. T. Pick and E. Harkin-Jones, Third Polymer Processing Symposium, Jan. 28-29, 2004, Belfast, p. 259-268 teaches that there is a correlation between the number of air bubbles in a rotomolded article and its impact strength, with a higher number of bubbles resulting in lower impact strength and lower optical qualities, such as clarity. If the time is too long and the temperature too high, the polymer will degrade, leading to discoloration and also to reduced impact strength of the part. The part is said to be “overcooked”, and in reference to the discoloration, “burnt”, and has to be discarded. Thus, there are narrow time and temperature ranges for achieving optimal mechanical and physical properties of the molded article. The optimal time and temperature range is referred to herein as the “processing window”. It is desirable to widen this processing window so that parts that have been exposed to longer than necessary times and higher than necessary temperatures still exhibit optimal mechanical and physical properties (are not “overcooked”). It is also highly desirable to have as short a cycle time as possible. Advantageously, reducing the cycle time reduces energy costs, and improves the productivity of the expensive rotomolding machinery. Widening the processing window further improves productivity by reducing the number of overcooked parts which must be discarded.

Additives can be used in the rotomolding process to reduce thermal degradation and to reduce microstructural defects such as trapped air bubbles by acceleration of bubble removal. The use of hindered phenols in combination with phosphites or phosphonites can reduce thermal degradation, which results in a broader process window, but results in a longer time to optimal properties (cycle time). The use of hydroxylamine derivatives in combination with HALS and phosphites or phosphonites can reduce cycle times by acceleration of bubble removal, but the processing window remains very narrow. There remains a need in the art for further improvements in rotomolding cycle time and for concurrent improvements in both cycle time and processing window.

### SUMMARY

A rotational molding process for producing a hollow article comprises the steps of: a) filling a mold with a polymer composition comprising: i) an organic polymer; and ii) a rotational molding densification accelerator (RMDA) selected from the group consisting of alkoxylated fatty alcohols, alkoxylated fatty esters, alkoxylated fatty amines, alkoxylated fatty amides, and combinations thereof; b) rotating the mold around at least one axis while heating the mold in an oven, thereby fusing the composition and spreading it to the walls of the mold; c) cooling the mold; d) opening the mold; and e) removing the hollow article from the mold.

A hollow article composed of the polymer composition comprising i) an organic polymer; and ii) a rotational molding densification accelerator (RMDA) selected from the group consisting of alkoxylated fatty alcohols, alkoxylated fatty esters, alkoxylated fatty amines, alkoxylated fatty amides, and combinations thereof is produced by the rotational molding process.

These and other objects, features and advantages of the rotational molding process, methods, hollow articles, polymer compositions, and RMDAs will become apparent from the following detailed description in conjunction with the accompanying drawings and examples.

### BRIEF DESCRIPTION OF THE DRAWINGS

### Referring Now to the Drawings:

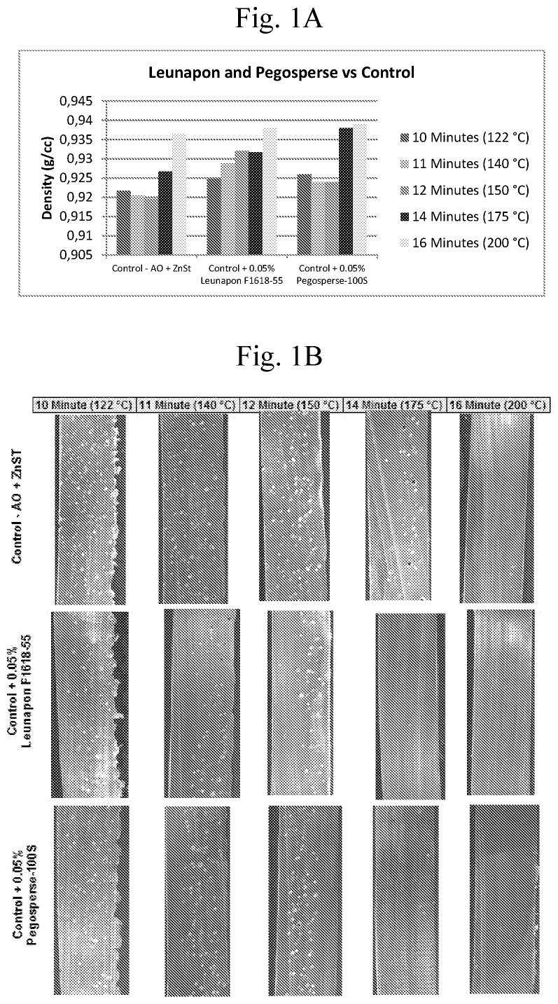

FIG. 1A is a bar graph showing the density of a rotomolded LLDPE parts as a function of oven time and temperature for 0.05 wt. % LEUNAPON™ F1618-55 (C₁₆-C₁₈ alkyl alcohol ethoxylate) and PEGOSPERSE™ 100-S(DEG monostearate) and a control.

FIG. 1B depicts cross-sections of the rotomolded parts of FIG. 1A showing air bubbles.

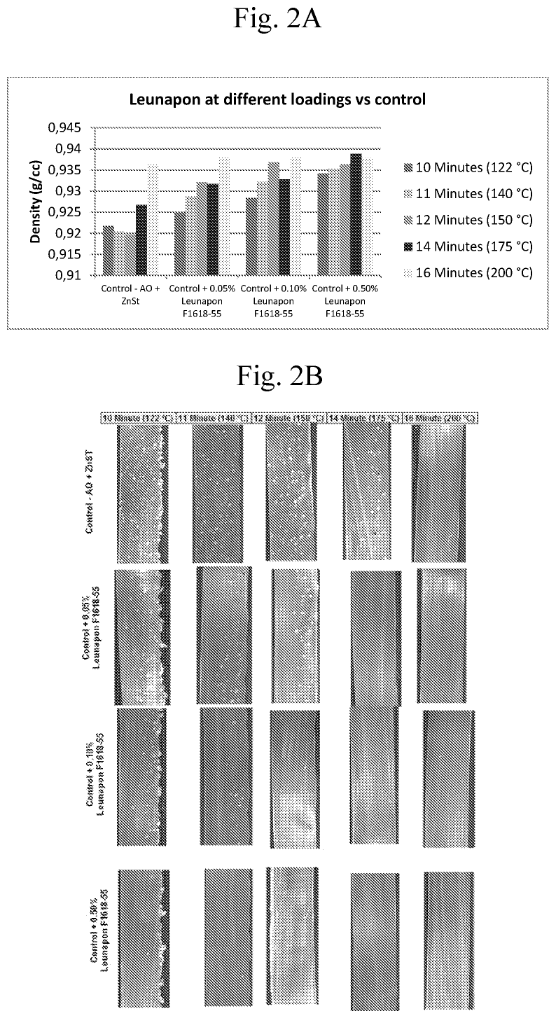

FIG. 2A is a bar graph showing the density of a rotomolded LLDPE parts as a function of oven time and temperature for LEUNAPON™ F1618-55 at 0.05, 0.10, and 0.50 wt. % loadings and a control.

FIG. 2B depicts cross-sections of the rotomolded parts of FIG. 2A showing air bubbles.

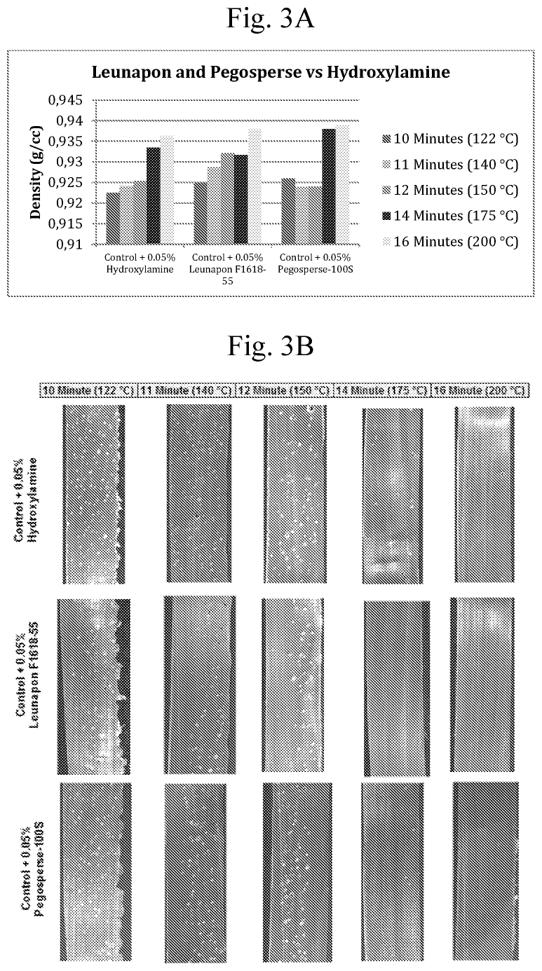

FIG. 3A is a bar graph showing the density of a rotomolded LLDPE parts as a function of oven time and temperature for 0.05 wt. % LEUNAPON™ F1618-55, PEGOSPERSE™ 100-S and IRGAFOS™ FS-042 (hydroxylamine).

FIG. 3B depicts cross-sections of the rotomolded parts of FIG. 3A showing bubbles.

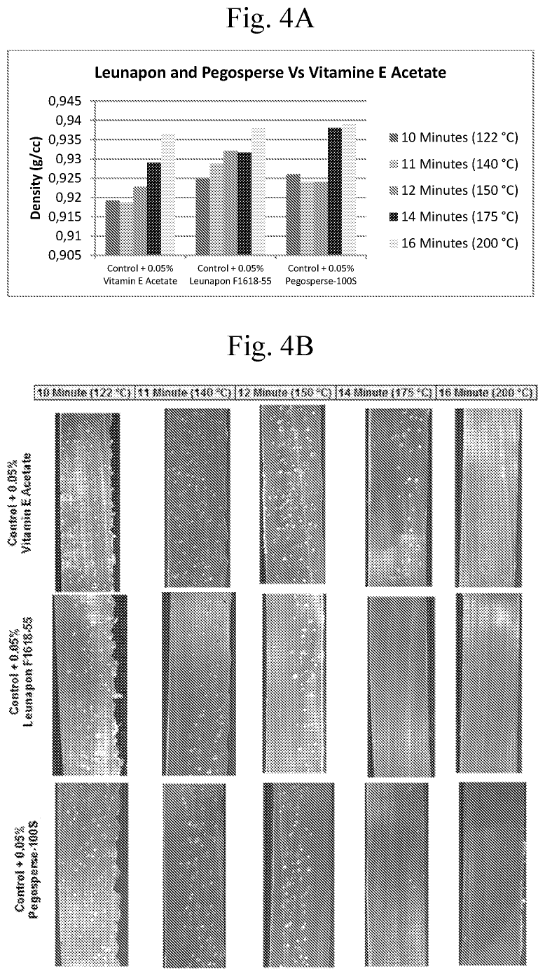

FIG. 4A is a bar graph showing the density of a rotomolded LLDPE parts as a function of oven time and temperature for 0.05 wt. % LEUNAPON™ F1618-55, PEGOSPERSE™ 100-S, and α-tocopherol acetate.

FIG. 4B depicts cross-sections of the rotomolded parts of FIG. 4A showing air bubbles.

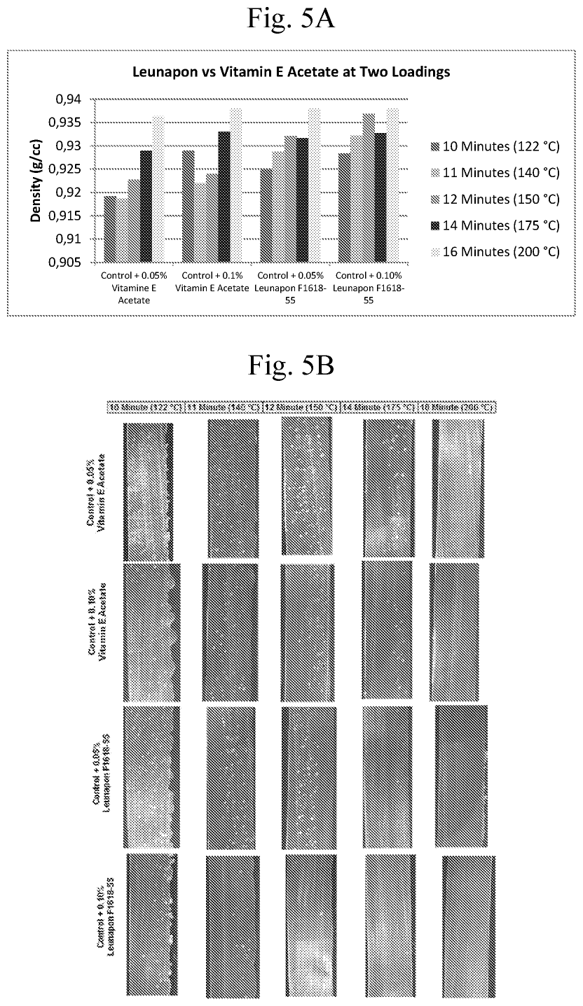

FIG. 5A is a bar graph showing the density of a rotomolded LLDPE parts as a function of oven time and temperature for 0.05 and 0.10 wt. % LEUNAPON™ F1618-55 and 0.05 and 0.10 wt. % α-tocopherol acetate.

FIG. 5B depicts cross-sections of the rotomolded parts of FIG. 5A showing air bubbles.

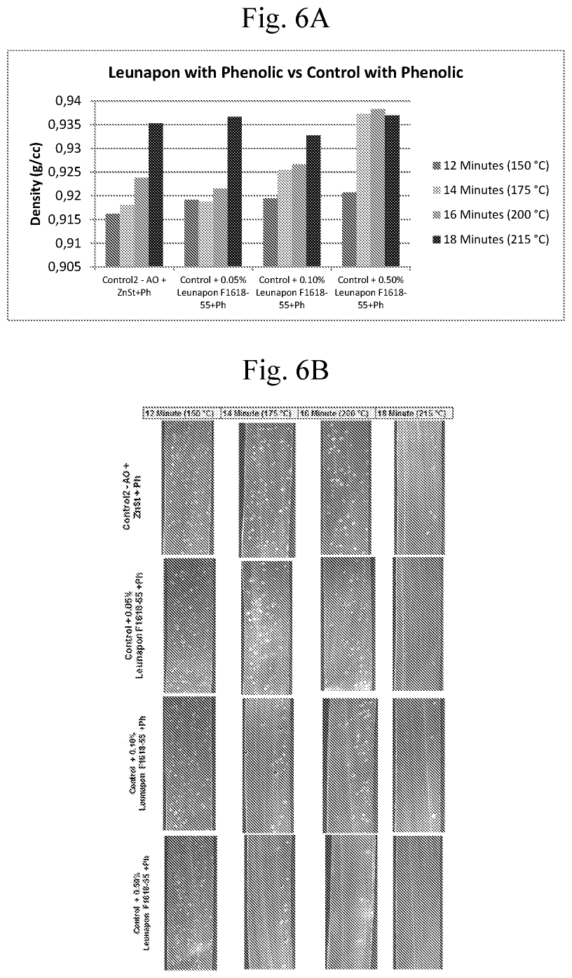

FIG. 6A is a bar graph showing the density of a rotomolded LLDPE parts as a function of oven time and temperature for LEUNAPON™ F1618-55 at 0.05, 0.10, and 0.50 wt. % loadings and a control with CYANOX™ AO-1790.

FIG. 6B depicts cross-sections of the rotomolded parts of FIG. 6A showing air bubbles.

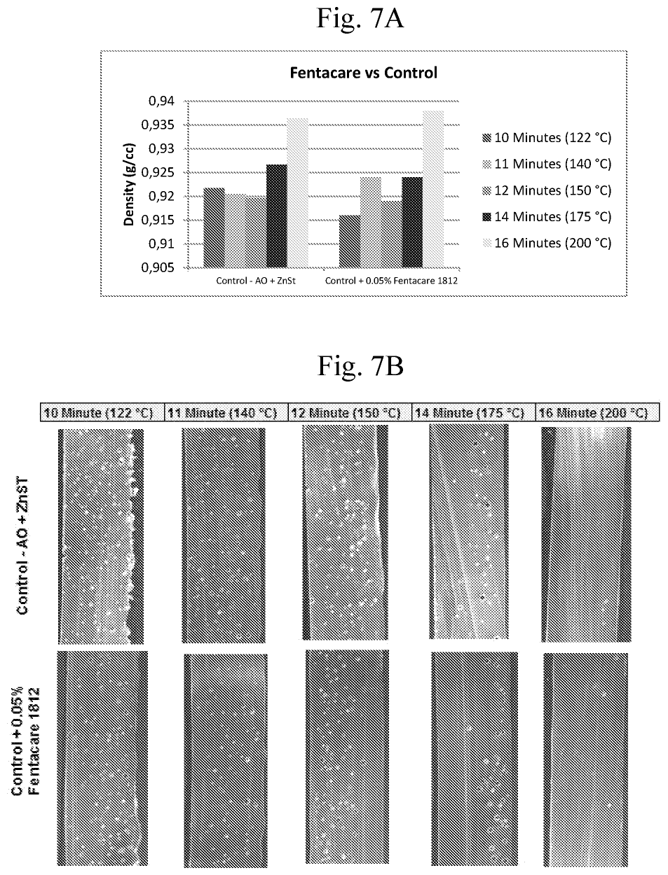

FIG. 7A is a bar graph showing the density of a rotomolded LLDPE parts as a function of oven time and temperature for 0.05 wt. % FENTACARE™ 1802 (N,N-bis(2-hydroxyethyl)octadecylamine) and a control.

FIG. 7B depicts cross-sections of the rotomolded parts of FIG. 7A showing air bubbles.

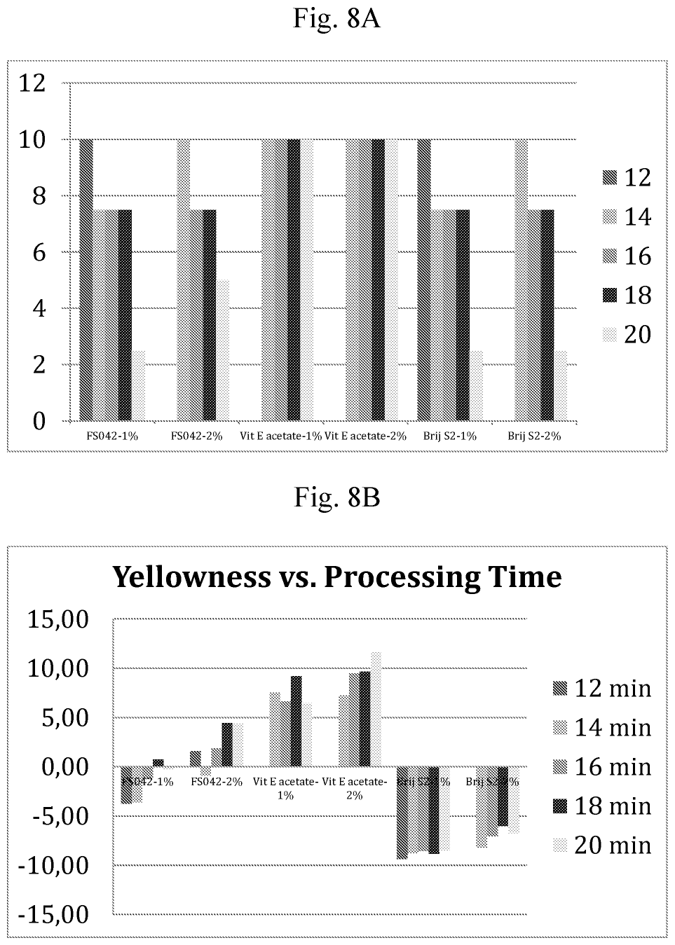

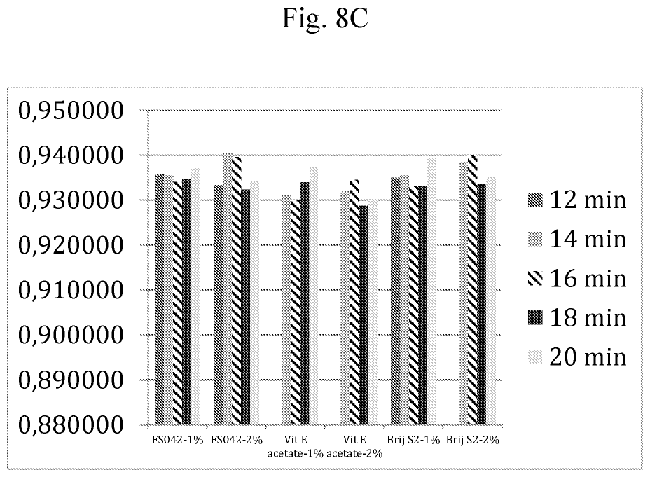

FIG. 8A is a bar graph depicting the number of bubbles (scale of 2.5, 5, 7.5, and 10) in PE plaques as a function of processing time for BRIJ™ S2 (C₁₈ mono-ether of diethylene glycol), α-tocopherol acetate, and IRGASTAB™ FS-042 at 1 wt. % and 2 wt. % loadings in ¼″ PE plaques.

FIG. 8B is a bar graph depicting Yellow Index as a function of processing time at 246° C. for BRIJ™ S2, α-tocopherol acetate, and IRGASTAB™ FS-042 at 1 wt. % and 2 wt. % loadings in ¼″ PE plaques.

FIG. 8C is a bar graph depicting density as a function of processing time at 246° C. for BRIJ™ S2, α-tocopherol acetate, and IRGASTAB™ FS-042 at 1 wt. % and 2 wt. % loadings in ¼″ LLDPE plaques.

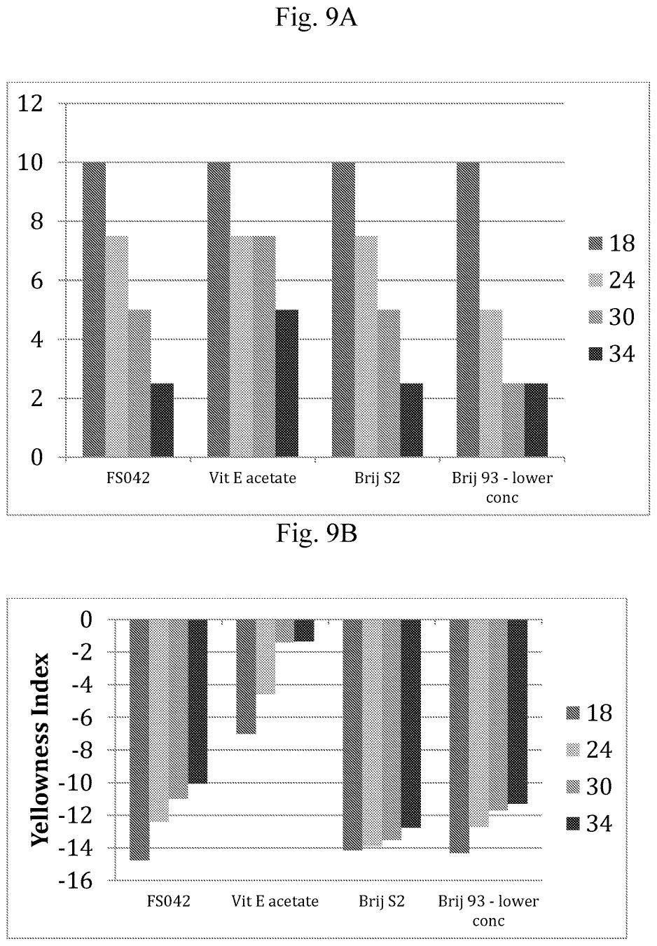

FIG. 9A is a bar graph depicting the number of bubbles (scale of 2.5, 5, 7.5, and 10) in ½″ LLDPE plaques as a function of processing time for BRIJ™ S2 (C₁₈ mono-ether of diethylene glycol), α-tocopherol acetate, and IRGASTAB™ FS-042 at 1 wt. % and 2 wt. % loadings in the polymer compositions.

FIG. 9B is a bar graph depicting Yellow Index in PE plaques as a function of processing time for BRIJ™ S2 (C₁₈ mono-ether of diethylene glycol), α-tocopherol acetate, and IRGASTAB™ FS-042 at 1 wt. % and 2 wt. % loadings in ½″ PE plaques.

### DETAILED DESCRIPTION

The rotational molding (rotomolding) process and rotational molding densification accelerators (RMDAs) described hereinbelow reduce the time for bubble removal and achieving optimal physical and mechanical properties such as impact strength compared to controls with antioxidants. In other words, the rotomolded process and RMDAs reduce cycle time. Advantageously, reducing the cycle time reduces energy costs and improves the productivity of the expensive rotomolding machinery. In addition, the rotomolding process and RMDAs can provide a wider/broader processing window in terms of time and temperature in which the properties, such as impact strength and color, of the hollow article are optimal, thereby minimizing rejects. Thus, the rotomolding process and RMDAs provide an attractive alternative to prior art rotomolding processes and additives.

Unless otherwise defined, all terms of art, notations and other scientific terminology used herein are intended to have the meanings commonly understood by those of skill in the chemical arts. As used herein and in the appended claims, the singular forms include plural referents unless the context clearly dictates otherwise.

Throughout this specification the terms and substituents retain their definitions. A comprehensive list of abbreviations utilized by organic chemists (i.e. persons of ordinary skill in the art) appears in the first issue of each volume of the Journal of Organic Chemistry. The list, which is typically presented in a table entitled “Standard List of Abbreviations” is incorporated herein by reference.

The term “hydrocarbyl” is a generic term encompassing aliphatic, alicyclic and aromatic groups having an all-carbon backbone and consisting of carbon and hydrogen atoms, except where otherwise stated. In certain cases, as defined herein, one or more of the carbon atoms making up the carbon backbone may be replaced by a specified atom or group of atoms. Examples of hydrocarbyl groups include alkyl, cycloalkyl, cycloalkenyl, carbocyclic aryl, alkenyl, alkynyl, alkylcycloalkyl, cycloalkylalkyl, cycloalkenylalkyl, and carbocyclic aralkyl, alkaryl, aralkenyl and aralkynyl groups. Such groups can be optionally substituted by one or more substituents as defined herein. Accordingly, the chemical groups or moieties discussed in the specification and claims should be understood to include the substituted or unsubstituted forms. The examples and preferences expressed below apply to each of the hydrocarbyl substituent groups or hydrocarbyl-containing substituent groups referred to in the various definitions of substituents for compounds of the formulas described herein unless the context indicates otherwise.

Preferred non-aromatic hydrocarbyl groups are saturated groups such as alkyl and cycloalkyl groups. Generally, and by way of example, the hydrocarbyl groups can have 12 to 60 carbon atoms, unless the context requires otherwise. Hydrocarbyl groups with from 12 to 30 carbon atoms are preferred.

Alkyl is intended to include linear, branched, or cyclic hydrocarbon structures and combinations thereof. Lower alkyl refers to alkyl groups of from 1 to 6 carbon atoms. Examples of lower alkyl groups include methyl, ethyl, propyl, isopropyl, butyl, sec- and tert-butyl and the like. Preferred alkyl groups are those of C₃₀ or below.

An aliphatic compound refers to a compound in which its main functional group is bonded to a saturated carbon atom. The rest of the carbon atoms can be aliphatic or aromatic. For example, benzyl alcohol is an aliphatic alcohol and benzyl amine is an aliphatic amine, because the hydroxy group and amino group are each bonded to saturated benzylic carbon atoms, respectively.

The term “interrupted by one or more heteroatoms” refers to an alkyl group containing one or more of —O—, —NH—, or —S— linking two carbon atoms.

Alkoxy or alkoxyalkyl refers to groups of from 1 to 20 carbon atoms of a straight, branched, cyclic configuration and combinations thereof attached to the parent structure through an oxygen. Examples include methoxy, ethoxy, propoxy, isopropoxy, cyclopropyloxy, cyclohexyloxy and the like.

Acyl refers to formyl and to groups of 1, 2, 3, 4, 5, 6, 7, 8, 9, 10, 11 and 12 carbon atoms of a straight, branched, cyclic configuration, saturated, unsaturated and aromatic and combinations thereof, attached to the parent structure through a carbonyl functionality. Examples include acetyl, benzoyl, propionyl, isobutyryl, tert-butoxycarbonyl, benzyloxycarbonyl and the like. Lower-acyl refers to groups containing one to six carbons.

References to “carbocyclic” or “cycloalkyl” groups as used herein shall, unless the context indicates otherwise, include both aromatic and non-aromatic ring systems. Thus, for example, the term includes within its scope aromatic, non-aromatic, unsaturated, partially saturated and fully saturated carbocyclic ring systems. In general, such groups may be monocyclic or bicyclic and may contain, for example, 3 to 12 ring members, more usually 5 to 10 ring members. Examples of monocyclic groups are groups containing 3, 4, 5, 6, 7, and 8 ring members, more usually 3 to 7, and preferably 5 or 6 ring members. Examples of bicyclic groups are those containing 8, 9, 10, 11 and 12 ring members, and more usually 9 or 10 ring members. Examples of non-aromatic carbocycle/cycloalkyl groups include c-propyl, c-butyl, c-pentyl, c-hexyl, and the like. Examples of C₇ to C₁₀ polycyclic hydrocarbons include ring systems such as norbornyl and adamantyl.

Aryl (carbocyclic aryl) refers to a 5- or 6-membered aromatic carbocycle ring containing; a bicyclic 9- or 10-membered aromatic ring system; or a tricyclic 13- or 14-membered aromatic ring system. The aromatic 6- to 14-membered carbocyclic rings include, e.g., substituted or unsubstituted phenyl groups, benzene, naphthalene, indane, tetralin, and fluorene.

Substituted hydrocarbyl, alkyl, aryl, cycloalkyl, alkoxy, etc. refer to the specific substituent wherein up to three H atoms in each residue are replaced with alkyl, halogen, haloalkyl, hydroxy, alkoxy, carboxy, carboalkoxy (also referred to as alkoxycarbonyl), carboxamido (also referred to as alkylaminocarbonyl), cyano, carbonyl, nitro, amino, alkylamino, dialkylamino, mercapto, alkylthio, sulfoxide, sulfone, acylamino, amidino, phenyl, benzyl, halobenzyl, heteroaryl, phenoxy, benzyloxy, heteroaryloxy, benzoyl, halobenzoyl, or lower alkylhydroxy.

The term “halogen” means fluorine, chlorine, bromine or iodine.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant figures and ordinary rounding approaches.

All ranges disclosed herein are inclusive of the endpoints, and the endpoints are independently combinable with each other (e.g., ranges of “less than or equal to 25 wt. %, or, more specifically, 5 wt. % to 20 wt. %”, is inclusive of the endpoints and all intermediate values of the ranges, including for example, “5 wt. % to 25 wt. %). Reference to “about” a value or parameter herein includes (and describes) embodiments that are directed to that value or parameter per se. The term “about” can also include the indicated amount ±10%, ±5%, or ±1%.

“At least one of” as used herein in connection with a list means that the list is inclusive of each element individually, as well as combinations of two or more elements of the list, and combinations of at least one element of the list with any like elements not named.

“Combinations” is inclusive of blends, mixtures, reaction products, and the like. Singular articles indicate plural referents as well, unless the context clearly dictates otherwise. For example, the articles “a” and “an” and “the” as used herein do not denote a limitation of quantity and are to be construed to cover both the singular and the plural, unless otherwise indicated herein or clearly contradicted by context.

“Or” means “and/or” unless clearly stated otherwise.

In addition to the RMDA and organic polymer, the polymer compositions suitable for use with the processes disclosed herein may further contain at least one stabilizer or co-additive which are further described below.

A rotational molding process for producing a hollow article comprises the steps of: a) filling a mold with a polymer composition comprising: i) an organic polymer; and ii) a rotational molding densification accelerator (RMDA) selected from the group consisting of alkoxylated aliphatic alcohols, alkoxylated aliphatic esters, alkoxylated aliphatic amines, alkoxylated aliphatic amides, and combinations thereof; b) rotating the mold around at least one axis while heating the mold in an oven, thereby fusing the composition and spreading it to the walls of the mold; c) cooling the mold; d) opening the mold; and e) removing the hollow article from the mold. Similarly, a polymer composition for producing a hollow article by rotational molding comprises: i) an organic polymer; and ii) a rotational molding densification accelerator (RMDA) selected from the group consisting of alkoxylated aliphatic alcohols, alkoxylated aliphatic esters, alkoxylated aliphatic amines, alkoxylated aliphatic amides, and combinations thereof.

The organic polymer can be any organic polymer suitable for rotational molding. For example, the organic polymer can be at least one of polyolefins, thermoplastic olefins (TPO), poly(ethylene-vinyl acetate) (EVA), polyesters, polyethers, polyketones, polyamides, natural and synthetic rubbers, polyurethanes, polystyrenes, polyacrylates, polymethacrylates, polybutyl acrylates, polyacetals, polyacrylonitriles, polybutadienes, acrylonitrile-butadiene-styrene (ABS), styrene-acrylonitrile (SAN), acrylonitrile-styrene-acrylate (ASA), cellulosic acetate butyrate, cellulosic polymers, polyimides, polyamideimides, polyetherimides, polyphenylene sulfides, polyphenylene oxides, polysulfones, polyethersulfones, polyvinyl chlorides, polycarbonates, amino resin cross-linked polyacrylates and polyesters, polyisocyanate cross-linked polyesters and polyacrylates, phenol/formaldehyde, urea/formaldehyde and melamine/formaldehyde resins, alkyd resins, polyester resins, acrylate resins cross-linked with melamine resins, urea resins, isocyanates, isocyanurates, carbamates, or epoxy resins, cross-linked epoxy resins derived from aliphatic, cycloaliphatic, heterocyclic, and aromatic glycidyl ethers, which are cross-linked with anhydrides or amines, polysiloxanes, Michael addition polymers, addition polymers of amines or blocked amines with activated unsaturated and activated methylene compounds, addition polymers of ketimines with activated unsaturated and activated methylene compounds, polyketimines in combination with unsaturated acrylic polyacetoacetate resins, coating compositions, radiation curable compositions, epoxy melamine resins, organic dyes, cosmetics, cellulose based paper, photographic film paper, fibers, waxes, or inks.

In any or all embodiments, the organic polymer comprises a thermoplastic, for example at least one polyolefin, polyolefin copolymer or terpolymer, polyamide, copolyamide, polyester, such as poly(ethylene terephthalate) or poly(butylene terephthalate), polystyrene, polycarbonate, polyacrylate, or poly(vinyl chloride).

In any or all embodiments, the organic polymer comprises at least one of a polyamide or copolyamide. The polyamide or copolyamide is derived from diamines and dicarboxylic acids, from arninocarboxylic acids, or from the corresponding lactams. The polyamide can be, for example, an aromatic polyamide prepared from m-xylene diamine and adipic acid or a polyamide prepared from hexamethylenediamine and isophthalic and/or terephthalic acid, with or without an elastomer as modifier, for example poly(2,4,4-trimethylhexamethylene terephthalamide) or poly-m-phenylene isophthalamide. The polyamide or copolyamide can also be a block copolymer of the aforementioned polyamides with polyolefins, olefin copolymers, ionomers, or chemically bonded or grafted elastomers, or with polyethers, e.g. with polyethylene glycol, polypropylene glycol or polytetramethylene glycol. The polyamide or copolyamide can be modified with EPDM or ABS or a polyamide produced during processing (reaction injection molding, or RIM, polyamide compositions).

In any or all embodiments, the organic polymer can comprise a polyolefin. The polyolefin can be, for example, at least one of polymers of monoolefins and diolefins, for example polyethylene, polypropylene (PP), polyisobutylene, polybut-1-ene, poly-4-methylpent-1-ene, polyisoprene or polybutadiene; polymers or copolymers of cycloolefins, for example cyclopentene or norbornene; polyethylene, for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE), or crosslinked polyethylene; copolymers of monoolefins and diolefins with unsaturated monomers, for example vinyl monomers or (meth)acrylic monomers; or mixtures of any of the above polymers or copolymers, for example mixtures of polypropylene with polyisobutylene, polypropylene with polyethylene (for example PP/HDPE, PP/LDPE), or mixtures of different types of polyethylene (for example LDPE/HDPE). The diolefin can be, for example, butadiene, isoprene, ethylidene norbornene, dicyclopentadiene, or vinyl norbornene. The other unsaturated monomers can be, for example, styrene, acrylonitrile, methyl methacrylate, ethyl acrylate, butyl acrylate, vinyl acetate, glycidyl methacrylate, or maleic anhydride. Thus, the polyolefin can comprise, for example at least one of polyethylene or polypropylene. The polyolefin can also comprise at least one of linear low density polyethylene (LLDPE), medium density polyethylene (MDPE), or high density polyethylene (HDPE).

The polyolefin can be prepared by radical polymerisation, under high pressure high temperature) or by catalytic polymerisation using a catalyst that normally contains one or more than one metal of groups IVb, Vb, VIb, or VIII of the Periodic Table. These metals usually have one or more than one ligand, typically oxides, halides, alcoholates, esters, ethers, amines, alkyls, alkenyls and/or aryls that may be either p- or s-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, for example metal alkyls, metal hydrides, metal alkyl halides, metal alkyl oxides, or metal alkoxides, said metals being elements of groups Ia, IIa and/or IIIa of the Periodic Table. An example of an activator is an aluminoxane. The activators can be modified with ester, ether, amine, or silyl ether groups. These catalyst systems are usually termed Phillips, Standard Oil Indiana, Ziegler(-Natta), TNZ (DuPont), metallocene, or single site catalysts (SSC). Each catalyst/activator system provides a different micro-structure to the polyolefin, for example degree of polymer branching, branch chain lengths, molecular weight distribution, polymer density, types of end-groups, and catalyst residues. In any of all embodiments, the polyolefin can comprise a polyethylene prepared by catalytic polymerization using a metallocene catalyst.

In any or all embodiments, the RMDA can be at least one alkoxylated aliphatic alcohol according to Formula (I):

R—(OCHR¹CH₂)_{y}—OH (I),

wherein R is C₁₂-C₆₀ hydrocarbyl; R¹ is H or C₁-C₄ alkyl; and y is an integer from 1 to 100. R is a C₁₂-C₆₀ hydrocarbyl, preferably a C₁₂-C₂₅ hydrocarbyl, a C₁₂-C₂₂ hydrocarbyl, or a C₁₂-C₁₈ hydrocarbyl, optionally substituted by hydroxyl, and optionally interrupted by one or more heteroatom, for example —NH—, O, or S. R¹ is H or C₁-C₄ alkyl, preferably H, methyl, ethyl, or a combination comprising at least one of H, methyl, or ethyl. When R¹ is H, the aliphatic alcohol is said to be “ethoxylated”. When R¹ is methyl, the aliphatic alcohol is said to be “propoxylated”. The alkoxylated aliphatic alcohol of Formula (I) can be mixture of ethoxylated and propoxylated aliphatic alcohols, or an alcohol that is both ethoxylated and propoxylated, with ethoxylate blocks and propoxylate blocks, or that is a random copolymer of ethylene oxide and propylene oxide. The letter “y” is the “degree of alkoxylation” and is an integer from 1 to 100, preferably 1 to 75, 2 to 25, or 2 to 12.

In any or all embodiments, the RMDA can be at least one ethoxylated aliphatic ether according to Formula (Ia):

R—(OCH₂CH₂)_{y}—OH (Ia),

wherein R is C₁₂-C₆₀ hydrocarbyl; and y is an integer from 2 to 60. R and “y” are defined the same as in Formula (I).

In any or all embodiments of Formula (I) and (Ia), R can be derived from a fatty alcohol having the same number of carbon atoms. A fatty alcohol as defined herein is a C₁₂-C₆₀ aliphatic alcohol, optionally unsaturated or polyunsaturated, and optionally substituted by hydroxyl. They can be obtained from natural sources or from petrochemicals. For example, C₁₂-C₁₄ aliphatic alcohols can be obtained from coconut oil, C₁₆-C₁₈ aliphatic alcohols can be obtained from palm kernel oil, and C₁₂-C₁₄ aliphatic alcohols can be obtained from rapeseed or mustard seed oil. These naturally occurring oils are triglycerides (esters) of fatty acids. The fatty acids are produced industrially by hydrolysis of the triglycerides with removal of glycerol. They can also be produced industrially from petroleum feedstock by hydrocarboxylation of alkenes.

Fatty alcohols are produced from fatty acids by catalytic hydrogenation, for example by suspension hydrogenation, gas-phase hydrogenation, or trickle-bed hydrogenation. Synthetic aliphatic alcohols can also be obtained by oligomerization of ethylene (Ziegler process) followed by either air oxidation to make even-numbered aliphatic alcohols or by the oxo process (hydroformylation) and hydrogenation to make odd-numbered aliphatic alcohols. In the oxo process, alkenes are reacted with synthesis gas (mixture of H₂/CO) in the presence of a catalyst to form aldehydes, which are hydrogenated to form the fatty alcohol.

A variation of the oxo process is SHOP (Shell Higher Olefin Process), in which ethylene is oligomerized and metathesized to produce C₁₂-C₁₈ alpha-olefins and C₁₁-C₁₄ internal olefins, which are then hydroformylated and hydrogenated. In a subsequent step, the fatty alcohol is alkoxylated to provide the alkoxylated aliphatic alcohol.

The C₁₂-C₆₀ aliphatic alcohol can be a primary, secondary, linear, branched, or cyclic alcohol. The C₁₂-C₆₀ aliphatic alcohol can be, for example, 1-dodecanol, 1-tridecanol, 1-tetradecanol, 1-pentadecanol, 1-hexadecanol, 1-heptadecanol, 1-octadecanol, 1-nonadecanol, 1-eicosanol, 1-docosanol, 1-tetracosanol, 1-hexacosanol, 1-octacosanol, 1-triacontanol, 2-methyl-1-undecanol, 2-propyl-1-nonanol, 2-butyl-1-octanol, 2-methyl-1-tridecanol, 2-ethyl-1-dodecanol, 2-propyl-1-undecanol, 2-butyl-1-decanol, 2-pentyl-1-nonanol; 2-hexyl-1-octanol; 2-methyl-1-pentadecanol; 2-ethyl-1-tetradecanol, 2-propyl-1-tridecanol, 2-butyl-1-dodecanol, 2-pentyl-1-undecanol, 2-hexyl-1-decanol, 2-heptyl-1-decanol, 2-hexyl-1-nonanol, 2-octyl-1-octanol, 2-methyl-1-heptadecanol, 2-ethyl-1-hexadecanol, 2-propyl-1-pentadecanol, 2-butyl-1-tetradecanol, 1-pentyl-1-tridecanol, 2-hexyl-1-dodecanol, 2-octyl-1-decanol, 2-nonyl-1-nonanol, 2-dodecanol, 3-dodecanol, 4-dodecanol, 5-dodecanol, 6-dodecanol, 2-tetradecanol, 3-tetradecanol, 4-tetradecanol, 5-tetradecanol, 6-tetradecanol, 7-tetradecanol, 2-hexadecanol, 3-hexadecanol, 4-hexadecanol, 5-hexadecanol, 6-hexadecanol, 7-hexadecanol, 8-hexadecanol, 2-octadecanol, 3-octadecanol, 4-octadecanol, 5-octadecanol, 6-octadecanol, 7-octadecanol, 8-octadecanol, 9-octadecanol, 2,4,6-trimethyl-1-heptanol, 2,4,6,8-tetramethyl-1-nonanol; 3,5,5-trimethyl-1-hexanol, 3,5,5,7,7-pentamethyl-1-octanol, 3-butyl-1-nonanol, 3-butyl-1-undecanol, 3-hexyl-1-undecanol, 3-hexyl-1-tridecanol, 3-octyl-1-tridecanol, 2-methyl-2-undecanol, 3-methyl-3-undecanol, 4-methyl-4-undecanol, 2-methyl-2-tridecanol, 3-methyl-3-tridecanol, 4-methyl-3-tridecanol, 4-methyl-4-tridecanol, 3-ethyl-3-decanol, 3-ethyl-3-dodecanol, 2,4,6,8-tetramethyl-2-nonanol, 2-methyl-3-undecanol, 2-methyl-4-undecanol, 4-methyl-2-undecanol, 5-methyl-2-undecanol, 4-ethyl-2-decanol, 4-ethyl-3-decanol, or a mixture thereof.

The alkoxylated aliphatic alcohol can be an ethoxylated and/or propoxylated alkyl alcohol. In any of all embodiments, the alkoxylated aliphatic alcohol is at least one of an ethoxylated and/or propoxylated laurel alcohol, C₁₂-C₁₃ alcohol, C₁₂-C₁₄ secondary alcohol, C₁₂-C₁₅ oxo alcohol, isotridecyl alcohol, cetyl alcohol, C₁₆/C₁₈ alkyl alcohol, stearyl alcohol, oleyl alcohol, docosyl alcohol, or saturated, linear C₂₀-C₅₀ synthetic alcohol. The alkoxylated aliphatic alcohol can also be an ethoxylated and propoxylated C₁₂-C₃₀ alcohol or a C₁₂-C₁₅ alcohol having 2 to 5 ethylene oxide repeat units.

Alkoxylated aliphatic alcohols are readily available under a variety of trade names from a number of suppliers. Trade names and suppliers include BRIJ™ (Croda, Snaith, UK), LEUNAPON™ (Vantage Leuna GmbH, Leuna, Germany), JEECOL™ (Jeen International Corp.), NOVEL™ (Sasol Olefins & Surfactants, Hamburg, Germany), UNITHOX™ (Baker Hughes, Houston, TX), GENAPOL™ (Clariant, Muttenz, Switzerland), and HETOXOL™ (Global Seven, Rockaway, NJ). While alkoxylated aliphatic alcohols can be in any form (liquid, semi-solid, solid, flake, pastille), solid and semi-solid forms are preferred.

Commercial examples of alkoxylated aliphatic alcohols include BRIJ™ S2 (stearyl alcohol ethoxylate with 2 moles of ethylene oxide), BRIJ™ S3 (stearyl alcohol ethoxylate with 3 moles of ethylene oxide), LEUNAPON™ F1618-55 (C₁₆/C₁₈ alkyl alcohol ethoxylate with 55 moles of ethylene oxide), Laureth-2 (2-dodecyloxyethanol), Steareth-5 (stearyl alcohol ethoxylate with 5 moles of ethylene oxide), JEECOL™ SA-10 (stearyl alcohol ethoxylate with 10 moles of ethylene oxide), JEECOL™ LA-2 (Laureth-2, dodecyl alcohol ethoxylate with 2 moles of ethylene oxide), JEECOL™ LA-4 (Laureth-4, dodecyl alcohol ethoxylate with 4 moles of ethylene oxide), BRIJ™ 93 (oleyl alcohol ethoxylate with 2 moles of ethylene oxide), NOVEL™ 22-4 (docosyl alcohol ethoxylate with 4 moles of ethylene oxide), NOVEL™ 23E2 (C₁₂-C₁₃ alcohol ethoxylate with 3 moles of ethylene oxide), GENAPOL™ EP 2525 (C₁₂-C₁₅ oxo alcohol ethoxylate/propoxylate with 2 moles of ethylene oxide and 5 moles of propylene oxide), GENAPOL™ EP 2552 (C₁₂-C₁₅ oxo alcohol ethoxylate/propoxylate with 5 moles of ethylene oxide and 2 moles of propylene oxide), TERGITOL™ 15-S-3 (C₁₂-C₁₄ secondary alcohol ethoxylate with 2 moles of ethylene oxide, available from Dow, Midland, MI), UNITHOX™ 420 (saturated, linear C₂₀-C₅₀ synthetic alcohol ethoxylates with 2.6 moles of ethylene oxide), and HETOXOL™ OL-4 (oleyl alcohol ethoxylate with 4 moles of ethylene oxide).

In any or all embodiments, the RMDA can be at least one alkoxylated aliphatic ester according to Formula (II):

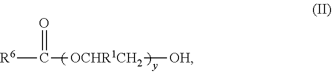

wherein R⁶ is C₁₁-C₅₉ hydrocarbyl; R′ is H or C₁-C₄ alkyl; and y is an integer from 1 to 100. In any or all embodiments, the RMDA can also be at least one ethoxylated aliphatic ester according to Formula (IIa):

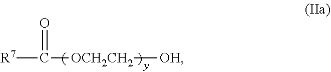

wherein R⁷ is a C₁₁-C₂₉ hydrocarbyl, preferably a C₁₁-C₂₄ hydrocarbyl, a C₁₁-C₂₁ hydrocarbyl, or a C₁₁-C₁₇ hydrocarbyl, and both R⁶ and R⁷ optionally substituted by hydroxyl, and optionally interrupted by one or more heteroatom, for example —NH—, O, or S. R¹ is H or C₁-C₄ alkyl, preferably H, methyl, ethyl, or a combination comprising at least one of H, methyl, or ethyl. When R¹ is H, the aliphatic alcohol is said to be “ethoxylated”. When R¹ is methyl, the aliphatic alcohol is said to be “propoxylated”. The alkoxylated aliphatic alcohol of Formula (I) can be mixture of ethoxylated and propoxylated aliphatic alcohols, or an alcohol that is both ethoxylated and propoxylated, with ethoxylate blocks and propoxylate blocks, or that is a random copolymer of ethylene oxide and propylene oxide. The letter “y” is the “degree of alkoxylation” and is an integer from 1 to 100, preferably 1 to 75, 2 to 25, or 2 to 12.

In any or all embodiments of Formula (II) and (IIa), R⁶ and R⁷ can each be derived from a fatty acid having one more carbon atom, i.e. from a fatty acid having the same number of carbon atoms as R—C(O)—. A fatty acid as defined herein is a C₁₂-C₆₀, C₁₂-C₃₀, C₁₂-C₂₂, or C₁₂-C₁₈ aliphatic carboxylic acid, optionally unsaturated or polyunsaturated, and optionally substituted by hydroxyl. They can be obtained from natural sources or from petrochemicals. For example, C₁₂/C₁₄ fatty acids can be obtained from coconut oil and palm kernel oil, and C₁₆/C₁₈ fatty acids can be obtained from palm oil and tallow. These naturally occurring oils and fats are triglycerides (esters) of the fatty acids. The fatty acids are produced industrially by hydrolysis of the triglycerides with removal of glycerol. They can also be produced by hydrocarboxylation of alkenes. In a subsequent step, the fatty acid is alkoxylated to provide the alkoxylated aliphatic ester. For example, the fatty acid can be ethoxylated by reaction with ethylene oxide or polyethylene glycol.

The alkoxylated aliphatic alcohol can be an ethoxylated and/or propoxylated alkyl alcohol. In any of all embodiments, the alkoxylated aliphatic alcohol is at least one of an ethoxylated and/or propoxylated laurate, C₁₆-C₁₈ alkanoate, stearate, oleate, or tallowate. Alkoxylated aliphatic esters are also readily available under a variety of trade names from a number of suppliers. Trade names and suppliers include LEUNAPON™ (Vantage Leuna, Leuna, Germany) and PEGOSPERSE™ (Croda, Snaith, UK). The alkoxylated aliphatic ester can be, for example, PEGOSPERSE™ 100-L (PEG-2 laurate, diethylene glycol monolaurate), LEUNAPON™ F1618-55 (a polyethylene glycol C₁₆-C₁₈ monoalkanoate with 55 moles of ethylene oxide), PEGOSPERSE™ 50-MS (ethylene glycol monostearate), PEGOSPERSE™ 100-S or BRIJ™ S2 (diethylene glycol monostearate), PEGOSPERSE™ 400-MS (PEG-8 Stearate, a polyethylene glycol monostearate with 8 moles of ethylene oxide), a polyethylene glycol monolaurate, diethylene glycol monooleate, a polyethylene glycol monooleate, a polyethylene glycol monotallowate, or a polyethylene glycol ricinoleate.

In any or all embodiments, the RMDA can be at least one alkoxylated aliphatic amine according to Formula (III):

R⁴—NR²R³ (III), or
alkoxylated aliphatic amide according to Formula (IV):

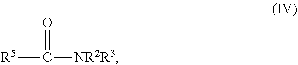

wherein R⁴ of Formula (III) is a C₈-C₆₀ hydrocarbyl and R⁵ of Formula (IV) is a C₇-C₅₉ hydrocarbyl, each optionally interrupted by one or more heteroatom; R² and R³ of Formula (III) and Formula (IV) are each independently H, C₁-C₃₀ alkyl, or —(CH₂CHR¹O)ₙ—H; at least one of R² or R³ of Formula (III) and Formula (IV) is —(CH₂CHR¹O)ₙ—H; R¹ is H or methyl; and each n is independently an integer from 1 to 100.

In any or all embodiments of the alkoxylated aliphatic amine of Formula (III), R⁴ can be a C₈-C₆₀ alkyl, preferably a C₈-C₃₆ alkyl or C₁₂-C₃₀ alkyl, optionally interrupted by one or more heteroatom, for example —NH—, O, or S, and optionally substituted by hydroxyl. R¹ is H or C₁-C₄ alkyl, preferably H, methyl, ethyl, or a combination comprising at least one of H, methyl, or ethyl. In any or all embodiments of the alkoxylated aliphatic amide of Formula (IV), R⁵ can be a C₇-C₅₉ alkyl, preferably a C₇-C₃₅alkyl, preferably a C₁₁-C₂₉ alkyl, optionally interrupted by one or more heteroatom. In any or all embodiments, R⁴ of Formula (III) can be a C₈-C₃₆ alkyl and R⁵ of Formula (IV) can be a C₇-C₃₅ alkyl, both optionally interrupted by one or more heteroatom. In any or all embodiments, R⁴ of Formula (III) can be a C₁₂-C₃₀ alkyl and R⁵ of Formula (IV) can be a C₁₁-C₂₉ alkyl, optionally interrupted by one or more heteroatom.

For the compounds of Formulae (III) and (IIIa), the letter “n” is the “degree of alkoxylation” and is an integer from 1 to 100, preferably 1 to 75, 2 to 25, or 2 to 12. If both R² and R³ are each independently —(CH₂CHR¹O)ₙ—H, the “n” for each of R² and R³, and for the combination of R² and R³, can likewise be an integer from 1 to 100, preferably 1 to 75, 2 to 25, or 2 to 12. For example, the alkoxylated aliphatic amine or amide can have 2 moles of ethylene oxide, or 5 to 100 moles of ethylene oxide. In any or all embodiments of the alkoxylated aliphatic amine of Formula (III) and the alkoxylated aliphatic amide of Formula (IV), each “n” can independently be an integer from 1 to 10.

In any or all embodiments, the RMDA can be at least one of an ethoxylated and/or propoxylated stearyl amine, oleyl amine, tallow amine, hydrogenated tallow amine, cetyl amine, capryl amine, or coco amine. Alkoxylated aliphatic amines are readily available under a variety of trade names from a number of suppliers. Trade names and suppliers include TOMAMINE™ (Air Products and Chemicals, Allentown, PA), ETHOMEEN™ (Akzo Nobel, Amsterdam, Netherlands), and GENAMIN™ (Clariant, Muttenz, Switzerland). Commercial examples of alkoxylated aliphatic amine include FENTACARE™ 1802 (N,N-bis(2-hydroxyethyl)octadecylamine available from Solvay Novecare, Cranbury, NJ), TOMAMINE™ E-T-2 (bis(2-hydroxyethyl)tallow amine), TOMAMINE™ E-17-5 (isotridecyloxypropylamine ethoxylate with 5 moles of ethylene oxide), ETHOMEEN™ C/12 (cocoalkyl amine ethoxylate with 2 moles of ethylene oxide), ETHOMEEN™ C/25 (cocoalkyl amine ethoxylate with 15 moles of ethylene oxide), GENAMIN™ S 020 (cetyl/stearyl amine ethoxylate with 2 moles of ethylene oxide), GENAMIN™ S 080 (cetyl/stearyl amine ethoxylate with 8 moles of ethylene oxide), GENAMIN™ O 020 (oleyl amine ethoxylate with 2 moles of ethylene oxide), and GENAMIN™ O 080 (oleyl amine ethoxylate with 8 moles of ethylene oxide).

In any or all embodiments, the RMDA can also be at least one of cocoamide monoethanol amine, cocoamide diethanol amine, a cocoamide ethoxylate, lauramide diethanol amine, oleamide diethanol amine, or oleic acid monoethanol amide. Alkoxylated aliphatic amides are also readily available under a variety of trade names from a number of suppliers. Trade names and suppliers include PROTAMIDE™ (Protameen Chemicals, Totowa, NJ) and SERDOX™ (Elementis Specialties, East Windsor, NJ). The alkoxylated aliphatic amide can be, for example, cocoamide monoethanolamine (PROTAMIDE™ CME), cocoamide diethanolamine (PROTAMIDE™ HCA-A), lauramide diethanolamine (PROTAMIDE™ L80-M), oleamide monoethanolamine, oleamide diethanolamine, oleamide diethanolamine further ethoxylated with 3 moles of ethylene oxide (SERDOX™ NXC-3), or a further ethoxylated and/or propoxylated derivative of any of these alkoxylated aliphatic amides.

In any or all embodiments of the alkoxylated aliphatic amine of Formula (III), R⁴ can be derived from a fatty acid having the same number of carbon atoms, and in any or all embodiments of the alkoxylated aliphatic amide of Formula (IIIa), R⁵ can be derived from a fatty acid having one more carbon atom, i.e. from a fatty acid having the same number of carbon atoms as R—C(O)—. A fatty acid as defined herein is a C₈-C₆₀ aliphatic carboxylic acid, optionally unsaturated or polyunsaturated. Fatty acids are mainly produced industrially by hydrolysis of triglycerides with removal of glycerol or by hydrocarboxylation of alkenes. Aliphatic amides can be produced from fatty acids by amidation with ammonia or primary of secondary amines. Aliphatic amines can be produced from fatty acids by the Nitrile Process, in which the fatty acid is reacted with ammonia and the resulting amide is dehydrated to provide a fatty nitrile. The fatty amine is obtained by catalytic hydrogenation of the fatty nitrile in the presence of Raney nickel, cobalt, or copper chromite catalyst in the presence of excess ammonia. In a subsequent step, the aliphatic amine is alkoxylated to provide the alkoxylated aliphatic amines.

The number average molecular weight of the RMDA is in the range of about 200 to about 5,000 g/mol, more preferably about 200 to about 4,000 g/mol. In the present examples, the total amount of RMDA was 0.05, 0.10, 0.50, 1, or 2 wt. %, based on the weight of the polymer composition. However, depending upon the type of light stabilizer, the polymeric organic material, and the degree of stabilization desired, the amount of RMDA can be 0.001 to 5 wt. %, preferably 0.01 to 2 wt. %, and more preferably 0.01 to 1 wt. %, based on the weight of the polymer composition.

In any or all embodiments, the polymer composition can further comprise an organic phosphite or phosphonite. The phosphite or phosphonite can be at least one of:
i) a compound according to any of Formulae (1) to (7):

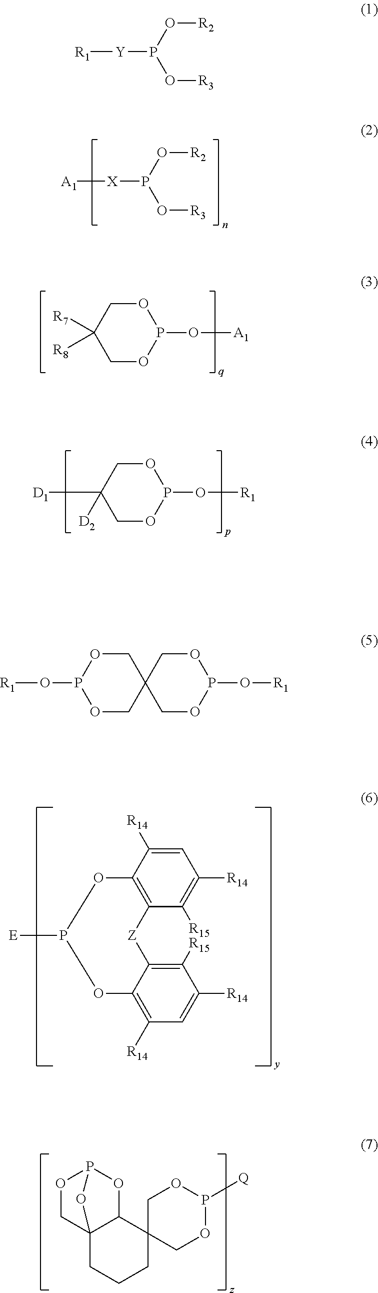

wherein:
the indices are integral and n is 2, 3 or 4; p is 1 or 2; q is 2 or 3; y is 1, 2 or 3; and z is 1 to 6;
A₁, if n or q is 2, is C₂-C₁₈ alkylene; C₂-C₁₂ alkylene interrupted by oxygen, sulfur or —NR₄—, a radical of the formulae:

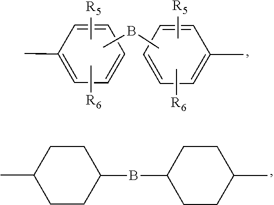

or phenylene;
A₁, if n or q is 3, is a divalent radical of the formula —CᵣH₂ᵣ₋₁—, wherein r is an integer from 4 to 12;
A₁, if n is 4, is

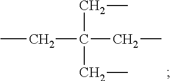

B is a direct bond, —CH₂—, —CHR₄—, —CR₁R₄—, sulfur, C₅-C₇ cycloalkylidene, or cyclohexylidene which is substituted by from 1 to 4 C₁-C₄ alkyl radicals in position 3, 4 and/or 5;
D₁, if p is 1, is C₁-C₄ alkyl and, if p is 2, is —CH₂OCH₂—;
D₂ is C₁-C₄ alkyl;
E, if y is 1, is C₁-C₁₈ alkyl, —OR₁ or halogen;
E, if y is 2, is —O-A₂-O—, wherein A₂ is as defined for A₁ when n is 2;
E, if y is 3, is a radical of the formula R₄C(CH₂O)₃ or N(CH₂CH₂O—)₃;
Q is the radical of an at least z-valent mono- or poly-alcohol or phenol, this radical being attached via the oxygen atom of the OH group of the mono- or poly-alcohol or phenol to the phosphorus atom;
R₁, R₂ and R₃ are each independently C₁-C₁₈ alkyl which is unsubstituted or substituted by halogen, —COOR₄, —CN or —CONR₄R₄; C₂-C₁₈ alkyl interrupted by oxygen, sulfur or —NR₄—; C₇-C₉ phenylalkyl; C₅-C₁₂ cycloalkyl, phenyl or naphthyl; naphthyl or phenyl substituted by halogen, 1 to 3 alkyl radicals or alkoxy radicals having a total of 1 to 18 carbon atoms or by C₇-C₉ phenylalkyl; or a radical of the formula

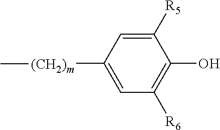

in which m is an integer from the range 3 to 6;
R₄ is hydrogen, C₁-C₅ alkyl, C₅-C₁₂ cycloalkyl or C₇-C₉ phenylalkyl;
R₅ and R₆ are each independently hydrogen, C₁-C₅ alkyl or C₅-C₆ cycloalkyl,
R₇ and R₈, if q is 2, are each independently C₁-C₄ alkyl or together are a 2,3-dehydropentamethylene radical; and R₇ and R₈, if q is 3, are each methyl;
each instance of R₁₄ is independently chosen from hydrogen, C₁-C₉ alkyl or cyclohexyl;
each instance of R₁₅ is independently hydrogen or methyl;
X and Y are each a direct bond or oxygen;
Z is a direct bond, methylene, —C(R₁₆)₂— or sulfur, and
R₁₆ is C₁-C₈ alkyl; or
ii) a trisarylphosphite according to Formula 8:

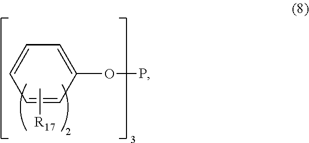

wherein:
R₁₇ is a substituent present at from 0 to 5 positions of the aromatic ring of Formula 8 and is independently C₁-C₂₀ alkyl, C₃-C₂₀ cycloalkyl, C₄-C₂₀ alkyl cycloalkyl, C₆-C₁₀ aryl, or C₇-C₂₀ alkylaryl.

The phosphite or phosphonite can be, for example, at least one of:
triphenyl phosphite,
diphenyl alkyl phosphites,
phenyl dialkyl phosphites,
trilauryl phosphite,
trioctadecyl phosphite,
distearyl pentaerythritol phosphite,
tris(2,4-di-tert-butylphenyl) phosphite (IRGAFOS™ 168),
tris(4-nonylphenyl) phosphite,
a compound of Formulae (A), (B), (C), (D), (E), (F), (G), (H), (J), (K), or (L):

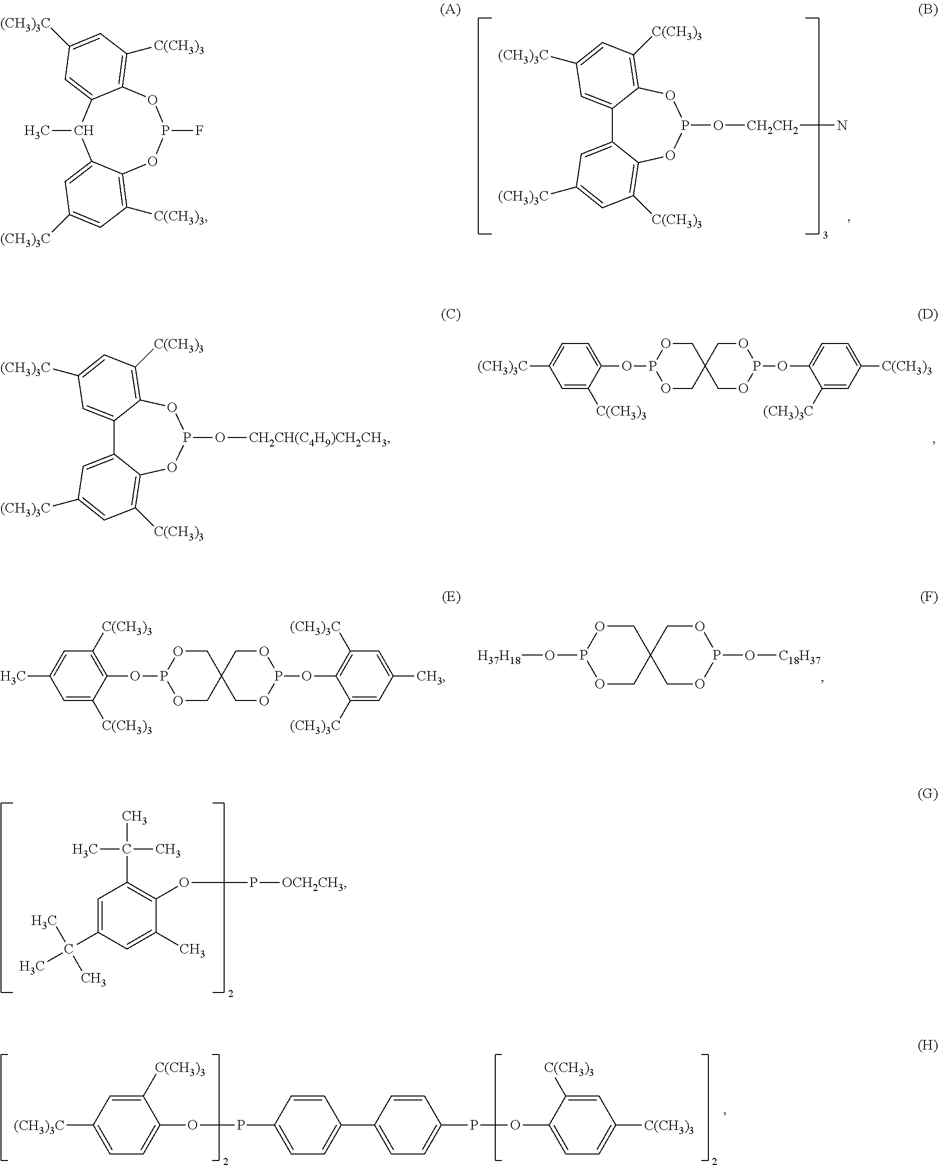

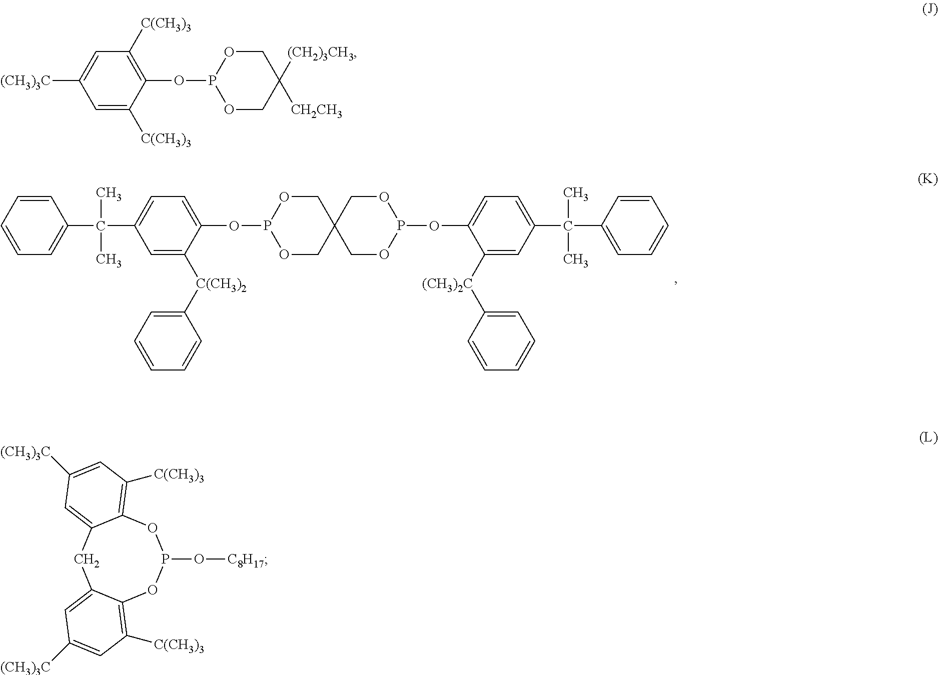

2-butyl-2-ethyl-1,3-propanediol 2,4,6-tri-tert-butylphenol phosphite,
bis(2,6-di-tert-butyl-4-methlphenyl) pentaerythritol diphosphite,
2-butyl-2-ethyl-1,3-propanediol 2,4-di-cumylphenol phosphite,
2-butyl-2-ethyl-1,3-propanediol 4-methyl-2,6-di-tert-butylphenol phosphite, or
bis(2,4,6-tri-tert-butyl-phenyl) pentaerythritol diphosphate.

In any or all embodiments, the phosphite or phosphonite can be at least one of tris(2,4-di-tert-butylphenyl)phosphite (IRGAFOS™ 168), bis(2,4-dicumylphenyl)pentaerythritol diphosphite (DOVERPHOS™ S9228), tetrakis(2,4-di-tert-butylphenyl)-4,4′-biphenylene-diphosphonite (IRGAFOS™ P-EPQ), tris(4-nonylphenyl) phosphite, triphenyl phosphite, trilauryl phosphite, trioctadecyl phosphite, or distearyl pentaerythritol phosphite. In any or all embodiments, the polymer composition can further comprise 0.001 to 5 wt. %, preferably 0.005 to 3 wt. %, and more preferably 0.01 to 1 wt. %, of the organic phosphite or phosphonite, based on the weight of the polymer composition.

In any or all embodiments, the polymer composition can further comprise a hindered phenol. The hindered phenol can have at least one group according to Formulae (IVa), (IVb), or (IVc):

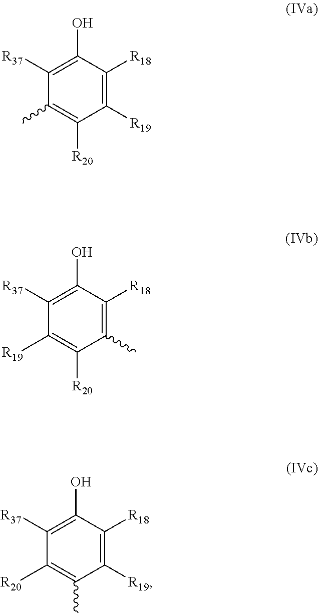

wherein:
“ [symbol] ” indicates the point of attachment (via a carbon-carbon single bond) of the molecular fragment to a parent compound;
R₁₈ of Formula (IVa), (IVb), and (IVc) is independently hydrogen or Cia hydrocarbyl;
each of R₁₉ and R₂₀ of Formula (IVa), (IVb), and (IVc) is independently hydrogen or C₁-C₂₀ hydrocarbyl; and
R₃₇ of Formula (IVa), (IVb), and (IVc) is C₁-C₁₂ hydrocarbyl.
   For example, R₁₈ and R₃₇ can each independently be methyl or tert-butyl.

The hindered phenol can be at least one of any of the following hindered phenols, sorted by chemical genus'.
a) Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-iso-butylphenol, 2,6-di-cyclopentyl-4-methylphenol, 2-α-methylcyclohexyl)-4,6-dimethylphenol, 2,6-di-octadecyl-4-methylphenol, 2,4,6-tri-cyclohexylphenol, 2,6-di-tert-butyl-4-methoxymethylphenol, or 2,6-dinonyl-4-methylphenol.
b) Alkylated hydroquinones, for example 2,6-di-tert-butyl-4-methoxyphenol, 2,5-di-tert-butylhydroquinone, 2,5-di-tert-amylhydroquinone, or 2,6-diphenyl-4-octadecyloxyphenol.
c) Hydroxylated thiodiphenyl ethers, for example 2,2′-thiobis-(6-tert-butyl-4-methylphenol), 2,2′-thiobis-(4-octylphenol), 4,4′-thiobis-(6-tert-butyl-3-methylphenol), or 4,4′-thiobis-(6-tert-butyl-2-methylphenol).
d) Alkylidenebisphenols, for example 2,2′-methylenebis-(6-tert-butyl-4-methylphenol), 2,2′-methylenebis-(6-tert-butyl-4-ethylphenol), 2,2′-methylenebis-[4-methyl-6-(α-methylcyclohexyl)-phenol], 2,2′-methylenebis-(4-methyl-6-cyclohexylphenol), 2,2′-methylenebis-(6-nonyl-4-methylphenol), 2,2′-methylenebis-(4,6-di-tert-butylphenol), 2,2′-ethylidenebis-(4,6-di-tert-butylphenol), 2,2′-ethylidenebis-(6-tert-butyl-4-isobutylphenol), 2,2′-methylenebis-[6-(α-methylbenzyl)-4-nonylphenol], 2,2′-methylenebis-[6-(α,α-dimethylbenzyl)-4-nonylphenol], 4,4′-methylenebis-(2,6-di-tert-butylphenol), 4,4′-methylenebis-(6-tert-butyl-2-methylphenol), 1,1-bis-(5-tert-butyl-4-hydroxy-2-methylphenyl)-butane, 2,6-bis-(3-tert-butyl-5-methyl-2-hydroxybenzyl)-4-methylphenol, 1,1,3-tris-(5-tert-butyl-4-hydroxy-2-methylphenyl)-butane, 1,1-bis-(5-tert-butyl-4-hydroxy-2-methylphenyl)-3-n-dodecylmercaptobutane, ethylene glycol bis-[3,3-bis-(3′-tert-butyl-4′-hydroxyphenyl)-butyrate], bis-(3-tert-butyl-4-hydroxy-5-methylphenyl)-dicyclopentadiene, or bis-[2-(3′-tert-butyl-2′-hydroxy-5′-methylbenzyl)-6-tert-butyl-4-methylphenyl]terephthalate.
e) Benzyl compounds, for example 1,3,5-tris-(3,5-di-tert-butyl-4-hydroxybenzyl)-2,4,6-trimethylbenzene, bis-(3,5-di-tert-butyl-4-hydroxybenzyl)sulfide, isooctyl 3,5-di-tert-butyl-4-hydroxybenzylmercaptoacetate, bis-(4-tert-butyl-3-hydroxy-2,6-dimethylbenzyl)-dithiol terephthalate, 1,3,5-tris-(3,5-di-tert-butyl-4-hydroxybenzyl)isocyanurate, 1,3,5-tris-(4-tert-butyl-3-hydroxy-2,6-dimethylbenzyl)isocyanurate, dioctadecyl 3,5-di-tert-butyl-4-hydroxybenzylphosphonate, the Ca salt of monoethyl 3,5-di-tert-butyl-4-hydroxybenzylphosphonate, or 1,3,5-tris-(3,5-dicyclohexyl-4-hydroxybenzyl)isocyanurate.
f) Acylaminophenols, for example 4-hydroxylauranilide, 4-hydroxystearanilide, 2,4-bis-(octylmercapto)-6-(3,5-di-tert-butyl-4-hydroxyanilino)-s-triazine, or octyl N-(3,5-di-tert-butyl-4-hydroxyphenyl)-carbamate.
g) Esters of β-(3,5-di-tert-butyl-4-hydroxyphenyl)-propionic acid with monohydric or polyhydric alcohols, for example methanol, octadecanol, 1,6-hexanediol, neopentyl glycol, thiodiethylene glycol, diethylene glycol, triethylene glycol, pentaerythritol, tris-(hydroxyethyl)isocyanurate, or N,N′-bis-(hydroxyethyl)-oxamide.
h) Esters of β-(5-tert-butyl-4-hydroxy-3-methylphenyl)propionic acid with monohydric or polyhydric alcohols, for example methanol, octadecanol, 1,6-hexanediol, neopentyl glycol, thiodiethylene glycol, diethylene glycol, triethylene glycol, pentaerythritol, tris-(hydroxyethyl)isocyanurate and N,N′-bis-(hydroxyethyl)-oxamide.
i) Esters of β-(3,5-dicyclohexyl-4-hydroxyphenyl)-propionic acid with monohydric or polyhydric alcohols, for example methanol, octadecanol, 1,6-hexanediol, neopentyl glycol, thiodiethylene glycol, diethylene glycol, triethylene glycol, pentaerythritol, tris-(hydroxyethyl)isocyanurate and N,N′-bis-(hydroxyethyl)-oxamide.
j) Amides of β-(3,5-di-tert-butyl-4-hydroxyphenyl)-propionic acid, for example N,N′-bis-(3,5-di-tert-butyl-4-hydroxyphenyl-propionyl)-hexamethylenediamine, N,N′-bis-(3,5-di-tert-butyl-4-hydroxyphenylpropionyl)-trimethylenediamineand N,N′-bis-(3,5-di-tert-butyl-4-hydroxyphenylpropionyl)-hydrazine.

In any of some embodiments, the hindered phenol can be, for example, at least one of: 1,3,5-tris-(3,5-di-tert-butyl-4-hydroxybenzyl)-2,4,6-trimethylbenzene (ETHANOX™ 330), bis-(3,5-di-tert-butyl-4-hydroxybenzyl)sulfide, 1,3,5-tris-(3,5-di-tert-butyl-4-hydroxybenzyl)isocyanurate (ETHANOX™ 314), 1,3,5-tris-(4-tert-butyl-3-hydroxy-2,6-dimethylbenzyl)isocyanurate (CYANOX™ 1790), dioctadecyl 3,5-di-tert-butyl-4-hydroxybenzylphosphonate, esters of β-(3,5-di-tert-butyl-4-hydroxyphenyl)propionic acid with monohydric or polyhydric alcohols, for example methanol, octadecanol (IRGANOX™ 1076), 1,6-hexanediol, neopentyl glycol, thiodiethylene glycol, diethylene glycol, triethylene glycol, pentaerythritol (IRGANOX™ 1010), tris-(hydroxyethyl)isocyanurate and N,N′-bis-(hydroxyethyl)oxamide, esters of β-(5-tert-butyl-4-hydroxy-3-methylphenyl)propionic acid with monohydric or polyhydric alcohols, for example methanol, octadecanol, 1,6-hexanediol, neopentyl glycol, thiodiethylene glycol, diethylene glycol, triethylene glycol, pentaerythritol, tris-(hydroxyethyl)isocyanurate and N,N′-bis-(hydroxyethyl)-oxamide, amides of β-(3,5-di-tert-butyl-4-hydroxyphenyl)propionic acid, for example N,N′-bis-(3,5-di-tert-butyl-4-hydroxyphenyl-propionyl)-hexamethylenediamine, or N,N′-bis-(3,5-di-tert-butyl-4-hydroxyphenylpropionyl)-trimethylenediamine.

In any of all embodiments, the polymer composition can further comprise 0.001 to 5 wt. %, preferably 0.005 to 2 wt. %, and more preferably 0.01 to 1 wt. %, of the hindered phenol, based on the weight of the polymer composition.

In any or all embodiments, the polymer composition can further comprise a basic co-additive. Basic co-additives are also referred to as “acid scavengers” in the art. The basic co-additive can be a nitrogen-containing organic compound, for example, an amine, a hydrazine derivative, a urea derivative, a polyamide, or a polyurethane. Specific examples of suitable nitrogen-containing compounds include dicyandiamide, melamine, triallyl cyanurate, and polyvinylpyrrolidone. The basic co-additive can also be a metal salt of a carboxylic acid or phenol, for example, calcium stearate, zinc stearate, magnesium stearate, magnesium behenate, sodium ricinoleate, calcium lactate, potassium palmitate, antimony pyrocatecholate, or zinc pyrocatecholate. The basic co-additive can also be a basic inorganic compound, for example zinc oxide, hydrotalcite, or hydrocalumite. In any or all embodiments, the basic co-additive can be at least one of zinc stearate, calcium stearate, zinc oxide, hydrotalcite, or hydrocalumite. In any of all embodiments, the polymer composition can comprise from 0.001 to 5 wt. %, preferably 0.005 to 2 wt. %, and more preferably 0.01 to 1 wt. %, of the basic co-additive, based on the weight of the polymer composition. For example, in any or all embodiments, the polymer composition can comprise 0.01 to 1 wt. % of at least one of zinc stearate, calcium stearate, zinc oxide, hydrotalcite, or hydrocalumite. In any or all embodiments, the at least one basic co-additive can be zinc stearate.

The polymer composition can further comprise at least one stabilizer or other co-additive, which are further described below. Thus, in any or all embodiments, the polymer composition can further comprise 0.01 to 25 wt. %, preferably 0.01 to 10 wt. %, preferably 0.02 to 5 wt. %, preferably 0.05 to 3 wt. %, based on the weight of the polymer composition, of at least one tocopherol, tocopherol ester, hydroxylamine, tertiary amine oxide, hindered amine light stabilizer (HALS), ultraviolet light absorber (UVA), hindered benzoate, thiosynergist, benzofuranone, indolinone, nitrone, or nickel phenolate.

In any or all embodiments, the polymer composition can further comprise a tocopherol. The tocopherol can be at least one of α-tocopherol, β-tocopherol, γ-tocopherol, δ-tocopherol, or esters thereof. The tocopherol ester can be at least one of α-tocopherol acetate, α-tocopherol acid succinate, or α-tocopherol polyethylene glycol 1000 succinate. The tocopherol can comprise, for example α-tocopherol (Vitamin E). The tocopherol can also comprise α-tocopherol acetate (Vitamin E acetate).

In any or all embodiments, the polymer composition can further comprise at least one hydroxylamine or tertiary amine oxide. The hydroxylamine can be at least one compound according to Formula (VIII):

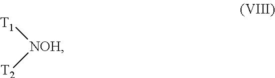

wherein:
T₁ is C₁-C₃₆ hydrocarbyl, C₅-C₁₂ cycloalkyl, or C₇-C₉ aralkyl, optionally substituted; and
T₂ is hydrogen or T₁.

The tertiary amine oxide can be at least one compound according to Formula (IX):

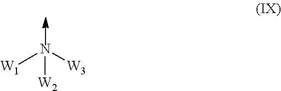

wherein:
W₁ and W₂ are each independently a straight or branched chain C₆-C₃₆ alkyl, C₆-C₁₂ aryl, C₇-C₃₆ aralkyl, C₇-C₃₆ alkaryl, C₅-C₃₆ cycloalkyl, C₆-C₃₆ alkylcycloalkyl, and C₆-C₃₆ cycloalkylalkyl; and
W₃ is a C₁-C₃₆ a straight or branched chain C₁-C₃₆ alkyl, C₆-C₁₂ aryl, C₇-C₃₆ aralkyl, C₇-C₃₆ alkaryl, C₅-C₃₆ cycloalkyl, C₆-C₃₆ alkylcycloalkyl; and C₆-C₃₆ cycloalkylalkyl;
with the proviso that at least one of W₁, W₂ and W₃ contains a R carbon-hydrogen bond; and
wherein said alkyl, aralkyl, alkaryl, cycloalkyl, alkylcycloalkyl and cycloalkylalkyl group may be interrupted by one to sixteen —O—, —S—, —SO—, —SO₂—, —COO—, —OCO—, —CO—, —NW₄—, —CONW₄— or —NW₄CO— groups, substituted by one to sixteen of —OW₄, —SW₄, —COOW₄, —OCOW₄, —COW₄, —N(W₄)₂, —CON(W₄)₂, —NW₄COW₄, or 5- and 6-membered rings containing the —C(CH₃)(CH₂Rₓ)NL(CH₂Rₓ)(CH₃)C— group, or both interrupted and substituted by the groups mentioned above; and
wherein:
W₄ is hydrogen or C₁-C₈ alkyl;
Rₓ is hydrogen or methyl;
L is C₁-C₃₀ alkyl, —C(O)R wherein R is a C₁-C₃₀ straight or branched chain alkyl, or
   —OR wherein R is a C₁-C₃₀ straight or branched chain alkyl; and
said aryl groups are optionally substituted by one to three halogen, C₁-C₈ alkyl, or C₁-C₈ alkoxy.

The compound according to Formula (VIII) can be a N,N-dihydrocarbylhydroxylamine wherein T₁ and T₂ are each independently benzyl, ethyl, octyl, lauryl, dodecyl, tetradecyl, hexadecyl, heptadecyl, octadecyl, or the alkyl mixture of hydrogenated tallow amine.

In any or all embodiments, the polymer composition can further comprise at least one of N,N-dibenzylhydroxylamine, N,N-diethylhydroxylamine, N,N-dioctylhydroxylamine, N,N-dilaurylhydroxylamine, N,N-didodecylhydroxylamine, N,N-ditetradecylhydroxylaamine, N,N-dihexadecylhydroxylamine, N,N-dioctadecylhydroxylamine N-hexadecyl-N-tetradecylhydroxylamine, N-hexadecyl-N-heptadecylhydroxylamine, N-hexadecyl-N-octadecylhydroxylamine, N-heptadecyl-N-octadecylhydroxylamine, or N,N-di(hydrogenated tallow)hydroxylamine (IRGASTAB™ FS-042). The hydroxylamine can be, for example, N,N-di(hydrogenated tallow)hydroxylamine (IRGASTAB™ FS-042). In any or all embodiments, the polymer composition can further comprise di(C₁₄-C₂₄)alkyl methyl amine oxide (GENOX™ EP).

In any or all embodiments, the polymer composition can further comprise a hindered amine light stabilizer (HALS). The hindered amine light stabilizer can comprise at least one functional group according to Formula (II):

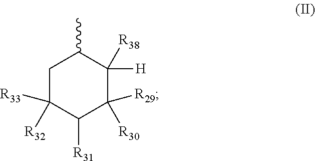

wherein:
R₃₁ is hydrogen, OH, C₁-C₂₀ hydrocarbyl, —CH₂CN, C₁-C₁₂ acyl, or C₁-C₁₈ alkoxy;
R₃₈ is hydrogen or C₁-C₈ hydrocarbyl; and
R₂₉, R₃₀, R₃₂, and R₃₃ are each independently C₁-C₂₀ hydrocarbyl, or R₂₉ and R₃₀ and/or R₃₂ and R₃₃ taken together with the carbon to which they are attached form a C₅-C₁₀ cycloalkyl; or
at least one functional group according to Formula (IIa):

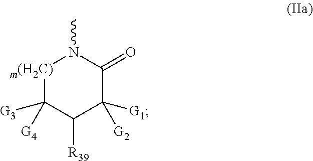

wherein:
m is an integer from 1 to 2;
R₃₉ is hydrogen, OH, C₁-C₂₀ hydrocarbyl, —CH₂CN, C₁-C₁₂ acyl, or C₁-C₁₈ alkoxy; and
G₁-G₄ are each independently C₁-C₂₀ hydrocarbyl.

The hindered amine light stabilizer (HALS) can be, for example, at least one of
bis(2,2,6,6-tetramethylpiperidin-4-yl) sebacate (TINUVIN™ 770); bis(2,2,6,6-tetramethylpiperidin-4-yl)succinate; bis(1,2,2,6,6-pentamethylpiperidin-4-yl)sebacate; bis(1-octyloxy-2,2,6,6-tetramethylpiperidin-4-yl)sebacate (TINUVIN™ 123); bis(1,2,2,6,6-pentamethylpiperidin-4-yl) n-butyl 3,5-di-tert-butyl-4-hydroxybenzylmalonate; a condensate of 1-(2-hydroxyethyl)-2,2,6,6-tetramethyl-4-hydroxypiperidine and succinic acid; 2,2,6,6-tetramethylpiperidin-4-yl stearate; 2,2,6,6-tetramethylpiperidin-4-yl dodecanate; 1,2,2,6,6-pentamethylpiperidin-4-yl stearate; 1,2,2,6,6-pentamethylpiperidin-4-yl dodecanate; a condensate of N,N′-bis(2,2,6,6-tetramethylpiperidin-4-yl)hexamethylenediamine and 4-tert-octylamino-2,6-dichloro-1,3,5-triazine; tris(2,2,6,6-tetramethylpiperidin-4-yl) nitrilotriacetate; 4-benzoyl-2,2,6,6-tetramethylpiperidine; 4-stearyloxy-2,2,6,6-tetramethylpiperidine; bis(1,2,2,6,6-pentamethylpiperidyl)-2-n-butyl-2-(2-hydroxy-3,5-di-tert-butylbenzyl)malonate; 3-n-octyl-7,7,9,9-tetramethyl-1,3,8-triazaspiro[4.5]decan-2,4-dione; bis(1-octyloxy-2,2,6,6-tetramethylpiperidyl)sebacate; bis(1-octyloxy-2,2,6,6-tetramethylpiperidyl)succinate; a condensate of N,N′-bis(2,2,6,6-tetramethylpiperidin-4-yl)hexamethylenediamine and 4-morpholino-2,6-dichloro-1,3,5-triazine; a condensate of N,N′-bis(2,2,6,6-tetramethylpiperidin-4-yl)hexamethylenediamine and 4-morpholino-2,6-dichloro-1,3,5-triazine, methylated; a condensate of 2-chloro-4,6-bis(4-n-butylamino-2,2,6,6-tetramethylpiperidyl)-1,3,5-triazine and 1,2-bis(3-aminopropylamino)ethane; a condensate of 2-chloro-4,6-bis(4-n-butylamino-1,2,2,6,6-pentamethylpiperidyl)-1,3,5-triazine and 1,2-bis-(3-aminopropylamino)ethane; 8-acetyl-3-dodecyl-7,7,9,9-tetramethyl-1,3,8-triazaspiro[4.5]decane-2,4-dione; 3-dodecyl-1-(2,2,6,6-tetramethylpiperidin-4-yl)pyrrolidin-2,5-dione; 3-dodecyl-1-(1-ethanoyl-2,2,6,6-tetramethylpiperidin-4-yl)pyrrolidin-2,5-dione; 3-dodecyl-1-(1,2,2,6,6-pentamethylpiperidin-4-yl)pyrrolidine-2,5-dione; a mixture of 4-hexadecyloxy- and 4-stearyloxy-2,2,6,6-tetramethylpiperidine, a mixture of 4-hexadecyloxy- and 4-stearyloxy-1,2,2,6,6-pentamethylpiperidine; a condensate of N,N′-bis(2,2,6,6-tetramethylpiperidin-4-yl)hexamethylenediamine and 4-cyclohexylamino-2,6-dichloro-1,3,5-triazine; a condensate of 1,2-bis(3-aminopropylamino)ethane, 2,4,6-trichloro-1,3,5-triazine and 4-butylamino-2,2,6,6-tetramethylpiperidine; 2-undecyl-7,7,9,9-tetramethyl-1-oxa-3,8-diaza-4-oxospiro[4.5]decane; oxo-piperanzinyl-triazines; a reaction product of 7,7,9,9-tetramethyl-2-cycloundecyl-1-oxa-3,8-diaza-4-oxospiro[4.5]decane and epichlorohydrin; 1,2,3,4-butanetetracarboxylic acid, 2,2,6,6-tetramethyl-4-piperidinyl tridecyl ester; 1,2,3,4-butanetetracarboxylic acid, 1,2,2,6,6-pentamethyl-4-piperidinyl tridecyl ester; tetrakis(2,2,6,6-tetramethylpiperidin-4-yl)-1,2,3,4-butanetetracarboxylate; tetrakis(1,2,2,6,6-pentamethylpiperidin-4-yl)-1,2,3,4-butanetetracarboxylate; 1,2,3,4-butanetetracarboxylic acid, polymer with β,β,β′,β′-tetramethyl-2,4,8,10-tetraoxaspiro[5.5]-undecane-3,9-diethanol, 2,2,6,6-tetramethylpiperdin-4-yl ester; 1,2,3,4-butanetetracarboxylic acid, polymer with β,β,β′,β′-tetramethyl-2,4,8,10-tetraoxaspiro[5.5]-undecane-3,9-diethanol, 1,2,2,6,6-pentamethylpiperdin-4-yl ester; bis(1-undecanoxy-2,2,6,6-tetramethylpiperidin-4-yl)carbonate; 1-(2-hydroxy-2-methylpropoxy)-2,2,6,6-tetramethyl-4-piperdinol; 1-(2-hydroxy-2-methylpropoxy)-4-octadecanoyloxy-2,2,6,6-tetramethylpiperidine; 1-(4-octadecanoyloxy-2,2,6,6-tetramethylpiperidin-1-yloxy)-2-octadecanoyloxy-2-methylpropane; 1-(2-hydroxyethyl)-2,2,6,6-tetramethyl-4-piperdinol; a reaction product of 1-(2-hydroxyethyl)-2,2,6,6-tetramethyl-4-piperdinol and dimethyl succinate; 2,2,4,4-tetramethyl-7-oxa-3,20-diazadispiro[5.1.11.2]heneicosan-21-one; esters of 2,2,6,6-tetramethyl-4-piperidinol with higher fatty acids; 3-dodecyl-1-(2,2,6,6-tetramethyl-4-piperidyl)pyrrolidine-2,5-dione; 1H-Pyrrole-2,5-dione, 1-octadecyl-, polymer with (1-methylethenyl)benzene and 1-(2,2,6,6-tetramethyl-4-piperidinyl)-1H-pyrrole-2,5-dione; 1,1′,1″-[1,3,5-triazine-2,4,6-triyl-tris[(cyclohexylimino)-2,1-ethanediyl]]tris[3,3,5,5-tetramethylpiperazin-2-one]; 1,1′,1″-[1,3,5-triazine-2,4,6-triyl-tris[(cyclohexylimino)-2,1-ethanediyl]]tris[3,3,4,5,5-pentamethylpiperazin-2-one]; the reaction product of 7,7,9,9-tetramethyl-2-cycloundecyl-1-oxa-3,8-diaza-4-oxospiro[4.5]decane and epichlorohydrin; the condensate of N,N′-bis(2,2,6,6-tetramethylpiperidin-4-yl)hexamethylenediamine and 4-cyclohexylamino-2,6-dichloro-1,3,5-triazine; the condensate of 1,2-bis(3-aminopropylamino)ethane, 2,4,6-trichloro-1,3,5-triazine and 4-butylamino-2,2,6,6-tetramethylpiperidine; the condensate of N,N′-bis(2,2,6,6-tetramethylpiperidin-4-yl)hexamethylenediamine and 4-morpholino-2,6-dichloro-1,3,5-triazine; the condensate of 2-chloro-4,6-bis(4-n-butylamino-2,2,6,6-tetramethylpiperidyl)-1,3,5-triazine and 1,2-bis(3-aminopropylamino)ethane; the condensate of 2-chloro-4,6-bis(4-n-butylamino-1,2,2,6,6-pentamethylpiperidyl)-1,3,5-triazine and 1,2-bis-(3-aminopropylamino)ethane; 2-[(2-hydroxyethyl)amino]-4,6-bis[N-(1-cyclohexyloxy-2,2,6,6-tetramethylpiperidin-4-yl)butylamino-1,3,5-triazine; propanedioic acid, [(4-methoxyphenyl)-methylene]-bis-(1,2,2,6,6-pentamethyl-4-piperidinyl) ester; benzenepropanoic acid, 3,5-bis(1,1-dimethylethyl)-4-hydroxy-, 1-[2-[3-[3,5-bis(1,1-dimethylethyl)-4-hydroxyphenyl]-1-oxopropoxy]ethyl]-2,2,6,6-tetramethyl-4-piperidinyl ester, N-(1-octyloxy-2,2,6,6-tetramethylpiperidin-4-yl)-N′-dodecyl-oxalamide; tris(2,2,6,6-tetramethylpiperidin-4-yl) nitrilotriacetate; 1,5-dioxaspiro{5,5}undecane-3,3-dicarboxylic acid, bis(1,2,2,6,6-pentamethyl-4-piperidinyl); 1,5-dioxaspiro{5,5}undecane-3,3-dicarboxylic acid, bis(2,2,6,6-tetramethyl-4-piperidinyl); the condensate of 1-(2-hydroxyethyl)-2,2,6,6-tetramethyl-4-hydroxypiperidine and succinic acid; the condensate of N,N′-bis(2,2,6,6-tetramethylpiperidin-4-yl)hexamethylenediamine and 4-tert-octylamino-2,6-dichloro-1,3,5-triazine; a mixture of 2,2,4,4-tetramethyl-21-oxo-7-oxa-3.20-diazaspiro(5.1.11.2)-heneicosane-20-propanoic acid-dodecyl ester and 2,2,4,4-tetramethyl-21-oxo-7-oxa-3.20-diazaspiro(5.1.11.2)-heneicosane-20-propanoic acid-tetradecyl ester; 1H,4H,5H,8H-2,3a,4a,6,7a,8a-hexaazacyclopenta[def]fluorene-4,8-dione, hexahydro-2,6-bis(2,2,6,6-tetramethyl-4-piperidinyl); polymethyl[propyl-3-oxy(2′,2′,6′,6′-tetramethyl-4,4′-piperidinyl)]siloxane; polymethyl[propyl-3-oxy(1′,2′,2′,6′,6′-pentamethyl-4,4′-piperidinyl)]siloxane; copolymer of methyl methacrylate with ethyl acrylate and 2,2,6,6-tetramethylpiperidin-4-yl acrylate; copolymer of mixed C₂₀ to C₂₄ alpha-olefins and (2,2,6,6-tetramethylpiperidin-4-yl)succinimide; 1,3-benzenedicarboxamide, N,N′-bis(2,2,6,6-tetramethyl-4-piperidinyl); 1,1′-1,10-dioxo-1,10-decanediyl)-bis(hexahydro-2,2,4,4,6-pentamethylpyrimidine; ethane diamide, N-(1-acetyl-2,2,6,6-tetramethylpiperidinyl)-N′-dodecyl; formamide, N,N′-1,6-hexanediylbis[N-(2,2,6,6-tetramethyl-4-piperidinyl) (UVINUL™ 4050); d-glucitol, 1,3:2,4-bis-O-(2,2,6,6-tetramethyl-4-piperidinylidene)-; 2,2,4,4-tetramethyl-7-oxa-3,20-diaza-21-oxo-dispiro[5.1.11.2]heneicosane; propanamide, 2-methyl-N-(2,2,6,6-tetramethyl-4-piperidinyl)-2-[(2,2,6,6-tetramethyl-4-piperidinyl)amino]-; 7-oxa-3,20-diazadispiro[5.1.11.2]heneicosane-20-propanoic acid, 2,2,4,4-tetramethyl-21-oxo-, dodecyl ester; N-(2,2,6,6-tetramethylpiperidin-4-yl)-β-aminopropionic acid dodecyl ester; N-(2,2,6,6-tetramethylpiperidin-4-yl)-N′-aminooxalamide; N-(2,2,6,6-tetramethyl-4-piperidinyl)-3-[(2,2,6,6-tetramethyl-4-piperidinyl)amino]-propanamide; 3-dodecyl-1-(1,2,2,6,6-pentamethylpiperidin-4-yl)pyrrolidine-2,5-dione, 3-dodecyl-1-(1-ethanoyl-2,2,6,6-pentamethylpiperidin-4-yl)pyrrolidine-2,5-dione; bis(2,2,6,6-tetramethylpiperidin-4-yl)succinate; bis(1,2,2,6,6-pentamethylpiperidin-4-yl) n-butyl 3,5-di-tert-butyl-4-hydroxybenzylmalonate; tris(2,2,6,6-tetramethylpiperidin-4-yl) nitrilotriacetate; 1,1′-(1,2-ethanediyl)bis(3,3,5,5-tetramethylpiperazin-2-one); 4-benzoyl-2,2,6,6-tetramethylpiperidine; 4-stearyloxy-2,2,6,6-tetramethylpiperidine; bis(1,2,2,6,6-pentamethylpiperidyl)-2-n-butyl-2-(2-hydroxy-3,5-di-tert-butylbenzyl)malonate; 3-n-octyl-7,7,9,9-tetramethyl-1,3,8-triazaspiro[4.5]decan-2,4-dione; bis(1-octyloxy-2,2,6,6-tetramethylpiperidyl)sebacate; bis(1-octyloxy-2,2,6,6-tetramethylpiperidyl)succinate; 8-acetyl-3-dodecyl-7,7,9,9-tetramethyl-1,3,8-triazaspiro[4.5]decane-2,4-dione; 3-dodecyl-1-(2,2,6,6-tetramethylpiperidin-4-yl)pyrrolidin-2,5-dione; 3-dodecyl-1-(1-ethanoyl-2,2,6,6-tetramethylpiperidin-4-yl)pyrrolidin-2,5-dione; 3-dodecyl-1-(1,2,2,6,6-pentamethylpiperidin-4-yl)pyrrolidine-2,5-dione; 2-undecyl-7,7,9,9-tetramethyl-1-oxa-3,8-diaza-4-oxospiro[4.5]decane; 1,5-dioxaspiro{5,5}undecane-3,3-dicarboxylic acid, bis(2,2,6,6-tetramethyl-4-piperidinyl) ester; 1,5-dioxaspiro{5,5}undecane-3,3-dicarboxylic acid, bis(1,2,2,6,6-pentamethyl-4-piperidinyl) ester; N¹-(D-hydroxyethyl)-3,3-pentamethylene-5,5-dimethylpiperazin-2-one; N¹-tert-octyl-3,3,5,5-tetramethyl-diazepin-2-one; N¹-tert-octyl-3,3-pentamethylene-5,5-hexamethylene-diazepin-2-one; N¹-tert-octyl-3,3-pentamethylene-5,5-dimethyl-piperazin-2-one; trans-1,2-cyclohexane-bis-(N¹-5,5-dimethyl-3,3-pentamethylene-piperazin-2-one); trans-1,2-cyclohexane-bis(N¹-3,3,5,5-dispiropentamethylene-piperazin-2-one); N¹-isopropyl-1,4-diazadispiro-3,3,5,5-pentamethylenepiperazin-2-one; N¹-isopropyl-1,4-diazadispiro-3,3-pentamethylene-5,5-tetramethylene-piperazin-2-one; N¹-isopropyl-5,5-dimethyl-3,3-pentamethylene-piperazin-2-one; trans-1,2-cyclohexane-bis-N¹-(dimethyl-3,3-pentamethylene-piperazin-2-one); N¹-octyl-5,5-dimethyl-3,3-pentamethylene-1,4-diazepin-2-one; N¹-octyl-1,4-diazadispiro-(3,3,5,5)pentamethylene-1,5-diazepin-2-one; a condensate of N,N′-bis(2,2,6,6-tetramethyl-1-(propyloxy)-piperidin-4-yl)hexamethylenediamine, N-butyl-1-propyloxy-2,2,6,6-tetramethyl-4-piperidinamine, di-n-butyl amine, and 2,4,6-trichloro-1,3,5-triazine (TINUVIN™ NOR HALS 371); N,N′-bis(2,2,6,6-tetramethyl-4-piperidin-4-yl)hexamethylene diamine, polymer with 2,4,6-trichloro-1,3,5-triazine, reaction products with 3-bromo-1-propene, di-n-butylamine, and N-butyl-2,2,6,6-tetramethyl-4-piperidinamine, oxidized, hydrogenated (TINUVIN™ XT 200); TINUVIN™ XT-850/XT-855; N-butyl-2,2,6,6-tetramethyl-4-piperidinamine-2,4,6-trichloro-1,3,5-triazine (FLAMESTAB™ NOR 116).

In any or all embodiments, the hindered amine light stabilizer (HALS), can be at least one of:
bis(2,2,6,6-tetramethylpiperidin-4-yl) sebacate (TINUVIN™ 770);
bis(2,2,6,6-tetramethylpiperidin-4-yl) succinate;
bis(1,2,2,6,6-pentamethylpiperidin-4-yl) sebacate;
bis(1-octyloxy-2,2,6,6-tetramethylpiperidyl) succinate;
bis(1-octyloxy-2,2,6,6-tetramethylpiperidin-4-yl) sebacate (TINUVIN™ 123);
bis(1,2,2,6,6-pentamethylpiperidin-4-yl) n-butyl 3,5-di-tert-butyl-4-hydroxybenzylmalonate;
a condensate of 1-(2-hydroxyethyl)-2,2,6,6-tetramethyl-4-hydroxypiperidine and succinic acid (TINUVIN™ 622);
2,2,6,6-tetramethylpiperidin-4-yl stearate;
2,2,6,6-tetramethylpiperidin-4-yl dodecanate;
1,2,2,6,6-pentamethylpiperidin-4-yl stearate;
1,2,2,6,6-pentamethylpiperidin-4-yl dodecanate;
   a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);
   tris(2,2,6,6-tetramethylpiperidin-4-yl) nitrilotriacetate; 4-stearyloxy-2,2,6,6-tetramethylpiperidine;
   a condensate of N,N′-bis(2,2,6,6-tetramethylpiperidin-4-yl)hexamethylenediamine and 4-morpholino-2,6-dichloro-1,3,5-triazine (CYASORB™ UV-3346);
   a condensate of N,N′-bis(2,2,6,6-tetramethylpiperidin-4-yl)hexamethylenediamine and 4-morpholino-2,6-dichloro-1,3,5-triazine, methylated (CYASORB™ UV-3529);
   a condensate of 2-chloro-4,6-bis(4-n-butylamino-2,2,6,6-tetramethylpiperidyl)-1,3,5-triazine and 1,2-bis(3-aminopropylamino)ethane (CHIMASSORB™ 119);
   a condensate of 2-chloro-4,6-bis(4-n-butylamino-1,2,2,6,6-pentamethylpiperidyl)-1,3,5-triazine and 1,2-bis-(3-aminopropylamino)ethane;
   a condensate of N,N′-bis(2,2,6,6-tetramethylpiperidin-4-yl)hexamethylenediamine, N-butyl-2,2,6,6-tetramethyl-4-piperidinamine, di-n-butyl amine, and 2,4,6-trichloro-1,3,5-triazine (CHIMASSORB™ 2020);
   a mixture of 4-hexadecyloxy- and 4-stearyloxy-2,2,6,6-tetramethylpiperidine (CYASORB™ UV-3853);
   a mixture of 4-hexadecyloxy- and 4-stearyloxy-1,2,2,6,6-pentamethylpiperidine;
   a condensate of N,N′-bis(2,2,6,6-tetramethylpiperidin-4-yl)hexamethylenediamine and 4-cyclohexylamino-2,6-dichloro-1,3,5-triazine;
   a condensate of 1,2-bis(3-aminopropylamino)ethane, 2,4,6-trichloro-1,3,5-triazine, and 4-butylamino-2,2,6,6-tetramethylpiperidine;
   a condensate of N,N′-bis(2,2,6,6-tetramethylpiperidin-4-yl)hexamethylenediamine and 4-cyclohexylamino-2,6-dichloro-1,3,5-triazine;
   tetrakis(2,2,6,6-tetramethylpiperidin-4-yl)-1,2,3,4-butanetetracarboxylate;
   tetrakis(1,2,2,6,6-pentamethylpiperidin-4-yl)-1,2,3,4-butanetetracarboxylate;
1,2,3,4-butanetetracarboxylic acid, 2,2,6,6-tetramethylpiperidinyl-4-yl tridecyl ester;
1,2,3,4-butanetetracarboxylic acid, 1,2,2,6,6-pentamethylpiperidin-4-yl tridecyl ester;
   formamide, N,N′-1,6-hexanediylbis[N-(2,2,6,6-tetramethylpiperidin-4-yl) (UVINUL™ 4050);
   a condensate of N,N′-bis(2,2,6,6-tetramethyl-1-(propyloxy)-piperidin-4-yl)hexamethylenediamine, N-butyl-1-propyloxy-2,2,6,6-tetramethyl-4-piperidinamine, di-n-butyl amine, and 2,4,6-trichloro-1,3,5-triazine (TINUVIN™ NOR HALS 371;
   N,N′-bis(2,2,6,6-tetramethyl-4-piperidin-4-yl)hexamethylene diamine, polymer with 2,4,6-trichloro-1,3,5-triazine, reaction products with 3-bromo-1-propene, di-n-butylamine, and N-butyl-2,2,6,6-tetramethyl-4-piperidinamine, oxidized, hydrogenated (TINUVIN™ XT 200);
   TINUVIN™ XT-850/XT-855); or
   N¹,N^{1′}-1,2-ethanediylbis(1,3-propanediamine), reaction products with cyclohexane and peroxidized N-butyl-2,2,6,6-tetramethyl-4-piperidinamine-2,4,6-trichloro-1,3,5-triazine (FLAMESTAB™ NOR 116).

In any of all embodiments, the polymer composition can further comprise an ultraviolet light absorber (UVA). The UVA can be, for example, at least one of a 2-hydroxybenzophenone, a 2-(2′-hydroxyphenyl)benzotriazole, a 2-(2′-hydroxyphenyl)-s-triazine, or a benzoxazinone. In any or all embodiments, the UVA can be a 2-(2′-hydroxyphenyl)-s-triazine. 2-(2′-Hydroxyphenyl)-s-triazines are well known in the art. They are disclosed, for example, in U.S. Pat. Nos. 6,051,164 and 6,843,939, which are incorporated herein by reference.

In any or all embodiments, the 2-(2′-hydroxyphenyl)-s-triazine can be a compound according to Formula (I):

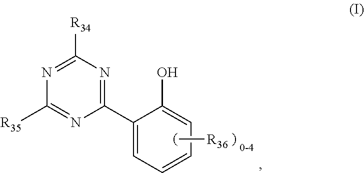

wherein each R₃₄ and R₃₅ is independently a C₆-C₁₀ aryl group, mono- or di-C₁-C₁₂ hydrocarbyl-substituted amino, C₂-C₁₂ alkanoyl, C₁-C₁₂ alkyl, C₁-C₁₀ acyl, or C₁-C₁₀ alkoxyl;
the C₆-C₁₀ aryl group is optionally substituted at from 1 to 3 substitutable positions with at least one of OH, halogen, C₁-C₁₂ alkyl, C₁-C₁₂ alkoxy, C₁₋₁₂ alkoxyester, C₂₋₁₂ alkanoyl, or phenyl, wherein the phenyl is optionally substituted at from 1 to 3 substitutable positions with at least one of OH, halogen, C₁₋₁₂ alkyl, C₁₋₁₂ alkoxy, C₁₋₁₂ alkoxyester, or C₂₋₁₂ alkanoyl; and
each R₃₆ is independently OH, halogen, C₁-C₁₂ alkyl, C₁-C₁₂ alkoxy, C₁-C₁₂ alkoxyester, C₂-C₁₂ alkanoyl, phenyl, or C₁-C₁₂ acyl.

The 2-(2′-hydroxyphenyl)-s-triazine can be, for example, at least one of: 4,6-bis-(2,4-dimethylphenyl)-2-(2-hydroxy-4-octyloxyphenyl)-s-triazine (CYASORB™ 1164); 4,6-bis-(2,4-dimethylphenyl)-2-(2,4-dihydroxyphenyl)-s-triazine; 2,4-bis(2,4-dihydroxyphenyl)-6-(4-chlorophenyl)-s-triazine; 2,4-bis[2-hydroxy-4-(2-hydroxy-ethoxy)phenyl]-6-(4-chlorophenyl)-s-triazine; 2,4-bis[2-hydroxy-4-(2-hydroxy-4-(2-hydroxy-ethoxy)phenyl]-6-(2,4-dimethylphenyl)-s-triazine; 2,4-bis[2-hydroxy-4-(2-hydroxyethoxy)phenyl]-6-(4-bromophenyl)-s-triazine; 2,4-bis[2-hydroxy-4-(2-acetoxyethoxy)phenyl]-6-(4-chlorophenyl)-s-triazine; 2,4-bis(2,4-dihydroxyphenyl)-6-(2,4-dimethylphenyl)-s-triazine; 2,4-bis(4-biphenylyl)-6-[2-hydroxy-4-[(octyloxycarbonyl)ethylideneoxy]phenyl]-s-triazine; 2,4-bis(4-biphenylyl)-6-[2-hydroxy-4-(2-ethylhexyloxy)phenyl]-s-triazine; 2-phenyl-4-[2-hydroxy-4-(3-sec-butyloxy-2-hydroxypropyloxy)phenyl]-6-[2-hydroxy-4-(3-sec-amyloxy-2-hydroxypropyloxy)phenyl]-s-triazine; 2,4-bis(2,4-dimethylphenyl)-6-[2-hydroxy-4-(3-benzyloxy-2-hydroxypropyloxy)phenyl]-s-triazine; 2,4-bis(2-hydroxy-4-n-butyloxyphenyl)-6-(2,4-di-n-butyloxyphenyl)-s-triazine; 2,4-bis(2,4-dimethylphenyl)-6-[2-hydroxy-4-(3-nonyloxy-2-hydroxypropyloxy)-5-α-cumylphenyl]-s-triazine; methylenebis-{2,4-bis(2,4-dimethylphenyl)-6-[2-hydroxy-4-(3-butyloxy-2-hydroxypropoxy)phenyl]-s-triazine}; methylene bridged dimer mixture bridged in the 3:5′, 5:5′ and 3:3′ positions in a 5:4:1 ratio; 2,4,6-tris(2-hydroxy-4-isooctyloxycarbonyliso-propylideneoxy-phenyl)-s-triazine; 2,4-bis(2,4-dimethylphenyl)-6-(2-hydroxy-4-hexyloxy-5-α-cumylphenyl)-s-triazine; 2-(2,4,6-trimethylphenyl)-4,6-bis[2-hydroxy-4-(3-butyloxy-2-hydroxypropyloxy)phenyl]-s-triazine; 2,4,6-tris[2-hydroxy-4-(3-sec-butyloxy-2-hydroxypropyloxy)-phenyl]-s-triazine; mixture of 4,6-bis-(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine (TINUVIN™ 400); 4,6-bis-(2,4-dimethylphenyl)-2-(2-hydroxy-4(3-(2-ethylhexyloxy)-2-hydroxypropoxy)-phenyl)-s-triazine; 4,6-diphenyl-2-(4-hexyloxy-2-hydroxyphenyl)-s-triazine (TINUVIN™ 1577).

In any or all embodiments, the 2-(2′-hydroxyphenyl)-1,3,5-triazine can be at least one of:
4,6-diphenyl-2-(4-hexyloxy-2-hydroxyphenyl)-s-triazine (TINUVIN™ 1577),
4,6-bis-(2,4-dimethylphenyl)-2-(2-hydroxy-4-octyloxyphenyl)-s-triazine (CYASORB™ 1164),
2,4-bis[2-hydroxy-4-(2-hydroxy-4-(2-hydroxyethoxy)phenyl]-6-(2,4-dimethylphenyl)-s-triazine,
   mixture of 4,6-bis(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine (TINUVIN™ 400),
4,6-bis(2,4-dimethylphenyl)-2-(2-hydroxy-4(3-(2-ethylhexyloxy)-2-hydroxypropoxy)-phenyl)-s-triazine (TINUVIN™ 405),
4,6-bis(2,4-dimethylphenyl)-2-(2-hydroxy-4(3-(2-ethylhexyloxy)-2-hydroxypropoxy)-phenyl)-s-triazine,
2,4-bis(2,4-dimethylphenyl)-6-[2-hydroxy-4-[(octyloxycarbonyl)ethylideneoxy]phenyl]-s-triazine (TINUVIN™ 479),
2,4-bis(4-biphenylyl)-6-[2-hydroxy-4-[(octyloxycarbonyl)ethylideneoxy]phenyl]-s-triazine,
2,4-bis(4-biphenylyl)-6-[2-hydroxy-4-(2-ethylhexyloxy)phenyl]-s-triazine (TINUVIN™ 1600),
2,4-bis(2-hydroxy-4-butyloxyphenyl)-6-(2,4-bis-butyloxyphenyl)-s-triazine (TRIAZINE™ 460),
2,4,6-tris[2-hydroxy-4-(3-sec-butyloxy-2-hydroxypropyloxy)-phenyl]-s-triazine, or
2,4,6-tris[2-hydroxy-4-[(octyloxycarbonyl)ethylideneoxy]phenyl]-s-triazine (TINUVIN™ 477).

In any or all embodiments, the UVA can be a 2-hydroxybenzophenone. 2-Hydroxybenzophenones are well known in the art. They are disclosed, for example, in U.S. Pat. Nos. 2,976,259, 3,049,443, and 3,399,169, which are incorporated herein by reference. The 2-hydroxybenzophenone can be, for example, at least one of 2-hydroxy-4-methoxybenzophenone (CYASORB™ UV-9), 2,2′-dihydroxy-4-methoxybenzophenone (CYASORB™ UV-24), 2-hydroxy-4-octyloxybenzophenone (CYASORB™ UV-531), 2,2′-dihydroxy-4,4′-di-methoxybenzophenone, 2,2′-dihydroxybenzophenone, 2,2′,4,4′-tetrahydroxybenzophenone, 2,2′-dihydroxy-4,4′-dimethoxybenzophenone, 2,2′-dihydroxy-4,4′-diethoxybenzophenone, 2,2′-dihydroxy-4,4′-dipropoxybenzophenone, 2,2′-dihydroxy-4,4′-dibutoxybenzophenone, 2,2′-dihydroxy-4-methoxy-4′-ethoxybenzophenone, 2,2′-dihydroxy-4-methoxy-4′-propoxybenzophenone, 2,2′-dihydroxy-4-methoxy-4′-butoxybenzophenone, 2,2′-dihydroxy-4-ethoxy-4′-propoxybenzophenone, 2,2′-dihydroxy-4-ethoxy-4′-butoxybenzophenone, 2,3′-dihydroxy-4,4′-dimethoxybenzophenone, 2,3′-dihydroxy-4-methoxy-4′-butoxybenzophenone, 2-hydroxy-4,4′,5′-trimethoxybenzophenone, 2-hydroxy-4,4′,6′-tributoxybenzophenone, 2-hydroxy-4-butoxy-4′,5′-dimethoxybenzophenone, 2-hydroxy-4-ethoxy-2′,4′-dibutylbenzophenone, 2-hydroxy-4-propoxy-4′,6′-dichlorobenzophenone, 2-hydroxy-4-propoxy-4′,6′-dibromobenzophenone, 2,4-dihydroxybenzophenone, 2-hydroxy-4-ethoxybenzophenone, 2-hydroxy-4-propoxybenzophenone, 2-hydroxy-4-butoxybenzophenone, 2-hydroxy-4-methoxy-4′-methylbenzophenone, 2-hydroxy-4-methoxy-4′-ethylbenzophenone, 2-hydroxy-4-methoxy-4′-propylbenzophenone, 2-hydroxy-4-methoxy-4′-butylbenzophenone, 2-hydroxy-4-methoxy-4′-tert-butylbenzophenone, 2-hydroxy-4-methoxy-4′-chlorobenzophenone, 2-hydroxy-4-methoxy-2′-chlorobenzophenone, 2-hydroxy-4-methoxy-4′-bromobenzophenone, 2-hydroxy-4,4′-dimethoxybenzophenone, 2-hydroxy-4,4′-dimethoxy-3-methylbenzophenone, 2-hydroxy-4,4′-dimethoxy-2′-ethylbenzophenone, 2-hydroxy-4,4′,5′-trimethoxybenzophenone, 2-hydroxy-4-ethoxy-4′-methylbenzophenone, 2-hydroxy-4-ethoxy-4′-ethylbenzophenone, 2-hydroxy-4-ethoxy-4′-propylbenzophenone, 2-hydroxy-4-ethoxy-4′-butylbenzophenone, 2-hydroxy-4-ethoxy-4′-methoxybenzophenone, 2-hydroxy-4,4′-diethoxybenzophenone, 2-hydroxy-4-ethoxy-4′-propoxybenzophenone, 2-hydroxy-4-ethoxy-4′-butoxybenzophenone, 2-hydroxy-4-ethoxy-4′-chlorobenzophenone, or 2-hydroxy-4-ethoxy-4′-bromobenzophenone.

In any or all embodiments, the UVA can be a 2-(2′-hydroxyphenyl)benzotriazole. The 2-hydroxyphenyl benzotriazole can be, for example, at least one of 2-(2′-hydroxy-5′-methylphenyl)benzotriazole (TINUVIN™ P), 2-(2′-hydroxy-5′-tert-butylphenyl)benzotriazole, 2-(2′-hydroxy-3′-methyl-5′-tert-butylphenyl)benzotriazole, 2-(2′-hydroxy-5′-cyclohexylphenyl)benzotriazole, 2-(2′-hydroxy-3′,5′-dimethylphenyl)benzotriazole, 2-(2′-hydroxy-5′-tert-butylphenyl)-5-chloro-benzotriazole, 2-(2′-hydroxy-5′-tert-octylphenyl)benzotriazole (CYASORB™ UV-5411), 2-(3′,5′-di-tert-butyl-2′-hydroxyphenyl)-5-chlorobenzotriazole, 2-(3′,5′-di-tert-amyl-2′-hydroxyphenyl)benzotriazole (CYASORB™ UV-2337), 2-(3′,5′-bis(α,α-dimethylbenzyl)-2′-hydroxyphenyl)benzotriazole (TINUVIN™ 900), 2-(3′-tert-butyl-2′-hydroxy-5′-(2-octyloxycarbonylethyl)phenyl)benzotriazole, 2,2′-methylenebis[4-(1,1,3,3-tetramethylbutyl)-6-benzotriazole-2-ylphenol], the transesterification product of 2-[3′-tert-butyl-5′-(2-methoxycarbonylethyl)-2′-hydroxyphenyl]-2H-benzotriazole with polyethylene glycol 300 (TINUVIN™ 1130), 2-[2′-hydroxy-3′-(α,α-dimethylbenzyl)-5′-(1,1,3,3-tetramethylbutyl)phenyl]benzotriazole, 5-trifluoromethyl-2-(2-hydroxy-3-α-cumyl-5-tert-octylphenyl)benzotriazole, 2-(2′-hydroxy-5′-(2-hydroxyethyl)phenyl)benzotriazole, 2-(2′-hydroxy-5′-(2-methacryloyloxyethyl)phenyl)benzotriazole, 2-(2′-hydroxy-3′-tert-butyl-5′-methylphenyl)-5-chlorobenzotriazole (TINUVIN™ 326), 2-(3′-sec-butyl-5′-tert-butyl-2′-hydroxyphenyl)benzotriazole, 2-(3′,5′-di-tert-butyl-2′-hydroxyphenyl)benzotriazole, 2-(3′-dodecyl-5′-methyl-2′-hydroxyphenyl)-benzotriazole, 2-(3′-tert-butyl-5′-(2-octyloxycarbonylethyl)-2′-hydroxyphenyl)-5-chlorobenzotriazole, 2-(5′-methyl-2′-hydroxyphenyl)benzotriazole, or 2-(5′-tert-butyl-2′-hydroxyphenyl)benzotriazole.

In any or all embodiments, the UVA can be a benzoxazinone. Benzoxazinones are well known in the art. They are disclosed, for example, in U.S. Pat. Nos. 4,446,262 and 6,774,232, which are incorporated herein by reference. The benzoxazinone can be, for example, at least one of 2-methyl-3,1-benzoxazin-4-one, 2-butyl-3,1-benzoxazin-4-one, 2-phenyl-3,1-benzoxazin-4-one, 2-(1- or 2-naphthyl)-3,1-benzoxazin-4-one, 2-(4-biphenyl)-3,1-benzoxazin-4-one, 2-p-nitrophenyl-3,1-benzoxazin-4-one, 2-m-nitrophenyl-3,1-benzoxazin-4-one, 2-p-benzoylphenyl-3,1-benzoxazin-4-one, 2-p-methoxyphenyl-3,1-benzoxazin-4-one, 2-O-methoxyphenyl-3,1-benzoxazin-4-one, 2-cyclohexyl-3,1-benzoxazin-4-one, 2-p-(or m-)phthalimidephenyl-3,1-benzoxazin-4-one, N-phenyl-4-(3,1-benzoxazin-4-one-2-yl)phthalimide, N-benzoyl-4-(3,1-benzoxazine-4-one-2-yl)aniline, N-benzoyl-N-methyl-4-(3,1-benzoxazin-4-one-2-yl)-aniline, 2-[p-(N-phenylcarbamonyl)phenyl]-3,1-benzoxazin-4-one, 2-[p-(N-phenyl N-methylcarbamoyl)phenyl]-3,1-benzoxazin-4-one, 2,2′-bis(3,1-benzoxazin-4-one), 2,2′-ethylenebis(3,1-benzoxazin-4-one), 2,2′-tetramethylenebis(3,1-benzoxazin-4-one), 2,2′-hexamethylenebis(3,1-benzoxazin-4-one), 2,2′-decamethylenebis(3,1-benzoxazin-4-one), 2,2′-p-phenylenebis(3,1-benzoxazin-4-one) (CYASORB™ UV-3638), 2,2′-m-phenylenebis(3,1-benzoxazin-4-one), 2,2′-(4,4′-diphenylene)bis(3,1-benzoxazin-4-one), 2,2′-(2,6- or 1,5-naphthalene)bis(3,1-benzoxazin-4-one), 2,2′-(2-methyl-p-phenylene)bis(3,1-benzoxazin-4-one), 2,2′-(2-nitro-p-phenylene)bis(3,1-benzoxazin-4-one), 2,2′-(2-chloro-p-phenylene)bis(3,1-benzoxazin-4-one), 2,2′-(1,4-cyclohexylene)bis(3,1-benzoxazin-4-one), N-p-(3,1-benzoxazin-4-on-2-yl)phenyl, 4-(3,1-benzoxazin-4-on-2-yl)phthalimide, N-p-(3,1-benzoxazin-4-on-2-yl)benzoyl, 4-(3,1-benzoxazin-4-on-2-yl)aniline, 1,3,5-tri(3,1-benzoxazin-4-on-2-yl)benzene, 1,3,5-tri(3,1-benzoxazin-4-on-2-yl)naphthalene, or 2,4,6-tri(3,1-benzoxazin-4-on-2-yl)naphthalene.

For stabilization against the deleterious effects of UV light, it can be advantageous to use a combination of a 2-(2′-hydroxyphenyl)-s-triazine and a HALS in a weight ratio of 1:5 to 30:1, and preferably from 3:1 to 20:1. Combinations of at least one of a 2-(2′-hydroxyphenyl)-s-triazin, 2-hydroxybenzophenone, 2-(2′-hydroxyphenyl)benzotriazole, or a benzoxazinone and a HALS can also be used.

In any or all embodiments, the light stabilizer comprises a hindered benzoate or benzamide. The hindered benzoate or benzamide can be a compound according to Formula (VI):

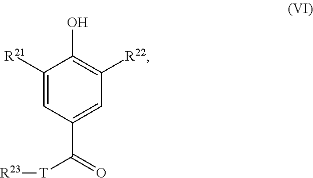

wherein:
each of R²¹ and R²² is independently a C₁-C₁₂ alkyl;
T is —O— or —NR²⁴—, wherein R²⁴ is H or a C₁-C₃₀ hydrocarbyl; and
R²³ is H or a C₁_C₃₀ hydrocarbyl.
   In any of all embodiments, the hindered benzoate can be at least one of 2,4-di-tert-butylphenyl 3,5-di-tert-butyl-4-hydroxybenzoate (TINUVIN™ 120), hexadecyl 3,5-di-tert-butyl-4-hydroxybenzoate (CYASORB™ UV-2908), octadecyl 3,5-di-tert-butyl-4-hydroxybenzoate, octyl 3,5-di-tert-butyl-4-hydroxybenzoate, decyl 3,5-di-tert-butyl-4-hydroxybenzoate, dodecyl 3,5-di-tert-butyl-4-hydroxybenzoate, tetradecyl 3,5-di-tert-butyl-4-hydroxybenzoate, behenylyl 3,5-di-tert-butyl-4-hydroxybenzoate, 2-methyl-4,6-di-tert-butylphenyl 3,5-di-tert-butyl-4-hydroxybenzoate, or butyl 3-[3-tert-butyl-4-(3,5-di-tert-butyl-4-hydroxybenzoyloxy)phenyl]propionate. For stabilization against the deleterious effects of UV light, it can be advantageous to use a combination of a 2-(2′-hydroxyphenyl)-s-triazine, a HALS, and a hindered benzoate.

In any or all embodiments, the polymer composition can further comprise a benzofuranone or indolinone. Suitable benzofuranones and indolinones are disclosed in U.S. Pat. Nos. 4,325,863, 4,338,244, 5,175,312, 5,216,052, 5,252,643, 5,369,159, 5,488,117, 5,356,966, 5,367,008, 5,428,162, 5,428,177, and 5,516,920, DE-A-4316611, DE-A-4316622, DE-A-4316876, EP-A-0589839, and EP-A-0591102. The benzofuranone or indolinone can be, for example, at least one of 3-[4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, or 3-(2,3-dimethylphenyl)-5,7-di-tert-butyl-benzofuran-2-one.

In any or all embodiments, the polymer composition can further comprise a thiosynergist. The thiosynergist can be an ester of 3,3′-thiodipropionic acid, an ester of 3-alkylthiopropionic acid, a thioether, or other organosulfur compound. The thiosynergist can be, for example, at least one of dilauryl 3,3′-thiodipropionate, dimyristyl 3,3′-thiodipropionate, ditridecyl 3,3′-thiodipropionate, distearyl 3,3′-thiodipropionate, pentaerythritol tetrakis-(3-dodecylthiopropionate), a tetraalkyl thioethyl thiodisuccinate, 2,12-dihydroxy-4,10-dithia-7-oxatridecamethylene bis[3-(dodecylthio)propionate], 2-mercaptobenzimidazole, 2-mercaptobenzimidazole, zinc salt, zinc dibutyldithiocarbamate, or dioctadecyl disulfide.

In any or all embodiments, the polymer composition can further comprise a nitrone. The nitrone can be at least one of N-benzyl-alpha-phenyl-nitrone, N-ethyl-α-methyl-nitrone, N-octyl-α-heptyl-nitrone, N-lauryl-α-undecyl-nitrone, N-tetradecyl-α-tridecyl-nitrone, N-hexadecyl-α-pentadecyl-nitrone, N-octadecyl-α-heptadecyl-nitrone, N-hexadecyl-α-heptadecyl-nitrone, N-octadecyl-α-pentadecyl-nitrone, N-heptadecyl-α-heptadecyl-nitrone, N-octadecyl-α-hexadecyl-nitrone, or a nitrone derived from N,N-di(hydrogenated tallow)hydroxylamine.

In any or all embodiments, the polymer composition can further comprise a co-additive. The co-additive can be at least one of a metal chelating agent, nucleating agent, filler, reinforcing agent, lubricant, plasticizer, compatibilizer, blowing agent, flame retardant, anti-block agent, slip agent, anti-static agent, metal oxide, optical brightener, dye, or pigment.

Metal chelating agents are also referred to as “metal deactivators” in the art. The metal chelating agent can be, for example, at least one of N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl) hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, or N,N′-bis(salicyloyl)thiopropionyl dihydrazide.

The nucleating agent can be, for example, talc, barium sulfate, molybdenum(IV) sulfide, sodium benzoate, lithium benzoate, norbornane dicarboxylic acid, disodium salt, aluminum hydroxy bis(4-tert-butylbenzoate), aluminum hydroxy 2,2′-methylenebis(4,6-tert-butylphenyl)]phosphate, sodium di(4-tert-butylphenyl)phosphate, sodium 2,2′-methylenebis(4,6-tert-butylphenyl)phosphate (NMTBP), dibenzylidene sorbitol (DBS), bis(3,4-dimethylbenzylidene) sorbitol (DMDBS), or bis(p-methylbenzylidene) sorbitol (MDBS).

The terms “filler” and “reinforcing agent” are used interchangeably in the art. The filler can be, for example, at least one of natural calcium carbonate, precipitated calcium carbonate (PCC), dolomite, magnesium carbonate, calcium sulfate, barium sulfate, glass beads, ceramic beads, synthetic silica, natural silica, feldspar, nepheline-syenite, aluminium trihydroxide, magnesium hydroxide, carbon black, wood flour, talc, mica, kaolin, graphite, wollastonite, whiskers, chopped glass fibers, aramid fibres, carbon fibres, conductive fillers, lubricant fillers, or natural or synthetic organic fillers.

The rotational molding densification accelerator (RMDA) selected from the group consisting of alkoxylated aliphatic alcohols, alkoxylated aliphatic esters, alkoxylated aliphatic amines, alkoxylated aliphatic amides, and combinations thereof, can be used in a rotational molding process for producing a hollow article.

The rotational molding process results in the production of a hollow article. All of the features of the organic polymer and RMDA in the polymer composition of the rotational molding process described above likewise apply to the organic polymer and RMDA in the polymer composition of the hollow article.

In any of all embodiments of the rotational molding process for producing the hollow article, peak internal air temperature (PIAT) of the mold can be from 70° C. to 400° C., preferably from 280° C. to 400° C., and more preferably from 310° C. to 400° C.

As discussed above, there are three main physical processes that occur in polymer particles used in rotational molding: sintering or coalescence brought about by melting the polymer particles to form a continuous phase, densification of the polymer continuous phase caused by bubble removal, and crystallization of the polymer brought about by cooling. Bubble removal and the resulting densification of the polymer continuous phase is an important part of the rotomolding process, which affects the physical properties of the part formed. Advantageously, use of the present RMDAs reduce microstructural defects such as trapped air bubbles by acceleration of bubble removal. Thus, in any of all embodiments, visible air bubbles are substantially removed from the hollow article in a shorter time than a control polymer composition without the RMDA.

The shorter time can be at least 4%, at least 5%, at least 10%, at least 15%, at least 20%, at least 25%, at least 40%, or at least 50% less, compared to the bubble removal time for a control polymer composition without the RMDA. In any or all embodiments, the shorter time can be, for example, 5 to 50% less, preferably 10 to 40% less, than the time for the bubbles to be substantially removed from the control polymer composition without the RMDA. The control polymer composition is identical to the polymer composition except for the absence of the RMDA. For example, the control polymer composition can have the same organic polymer, amounts of the same phosphite or phosphonite, basic co-additive, and hindered phenol as the polymer composition.

Bubble removal time can be evaluated by inspection of cross-sections of the hollow article with an optical microscope. Bubble removal is judged complete when the cross-section is substantially free of bubbles. The phrase “substantially free of bubbles” means the time for at least 95% of a cross-sectional area of the hollow article to be free of bubbles when viewed with the optical microscope as described herein. Bubble removal time can also be measured by monitoring the density of the hollow article. A reduced time for bubble removal can then be indicated by a reduced time to a target density, or by a higher density at the same time interval, both compared to a control polymer composition.

Since bubble removal time is proportional to internal air temperature (IAT) when the IAT is increasing in step (b), the method can also provide reduced bubble content or increased density at a given IAT. IAT increased with time in present Ex. 1 to 7 (FIG. 1A to 7B).

In view of the above, a method for reducing the time for bubble removal from a polymer composition in a rotational molding process for producing a hollow article comprises: a) filling a mold with a polymer composition comprising: i) an organic polymer; and ii) a rotational molding densification accelerator (RMDA) selected from the group consisting of alkoxylated aliphatic alcohols, alkoxylated aliphatic esters, alkoxylated aliphatic amines, alkoxylated aliphatic amides, and combinations thereof; and b) rotating the mold around at least one axis while heating the mold in an oven, thereby fusing the composition and spreading it to the walls of the mold, wherein the time for bubble removal in step (b) is reduced compared to the time for bubble removal for a control polymer composition without the RMDA, thereby reducing the cycle time for the rotational molding process. Cycle time for a rotational molding process is the elapsed time from start to finish for producing the hollow article. Since reducing the time for bubble removal will also the reduce the time for producing a hollow article, the method for reducing the time for bubble removal is also a method for reducing cycle time.

The method for reducing the time for bubble removal can further expand the processing window, i.e., the method can provide broader time and temperature ranges over which optimal properties are obtained for the hollow article. The optimal properties can include impact strength and color. Thus, a method for expanding the processing window in a rotational molding process for producing a hollow article comprises: a) filling a mold with a polymer composition comprising: i) an organic polymer; and ii) a rotational molding densification accelerator (RMDA) selected from the group consisting of alkoxylated aliphatic alcohols, alkoxylated aliphatic esters, alkoxylated aliphatic amines, alkoxylated aliphatic amides, and combinations thereof; and b) rotating the mold around at least one axis while heating the mold in an oven, thereby fusing the composition and spreading it to the walls of the mold, wherein the processing window is expanded compared to a control polymer composition without the RMDA. The control polymer composition is identical to the polymer composition except for the absence of the RMDA. For example, the control polymer composition can have the same amounts of the same phosphite or phosphonite, basic co-additive, and hindered phenol as the polymer composition.

The polymer compositions described herein can be contained in a kit. The kit can have single or multiple components, each component selected from the group consisting of the organic polymer, the RMDA, the organic phosphite or phosphonite, other additives and co-additives described herein, and combinations thereof. Thus, one or more components of a polymer composition can be in a first container, and one or more other components of the polymer composition can optionally be in a second or more containers. The containers can be packaged together, and the kit can include administration or mixing instructions on a label or on an insert included with the kit, optionally with a web address or bar code for further information. In addition to the components of the polymer composition, the kit can include additional functional parts or means for administering or mixing the components, including solvents.

A rotational molding process for producing a hollow article comprises the steps of: a) filling a mold with a polymer composition comprising: i) an organic polymer; and ii) a rotational molding densification accelerator (RMDA) selected from the group consisting of alkoxylated aliphatic alcohols, alkoxylated aliphatic esters, alkoxylated aliphatic amines, alkoxylated aliphatic amides, and combinations thereof; b) rotating the mold around at least one axis while heating the mold in an oven, thereby fusing the composition and spreading it to the walls of the mold; c) cooling the mold; d) opening the mold; and e) removing the hollow article from the mold. Visible air bubbles are substantially removed from the hollow article in a shorter time than a control polymer composition without the RMDA. The organic polymer comprises at least one of a polyolefin, polyolefin copolymer or terpolymer, polyamide, copolyamide, polyester, such as poly(ethylene terephthalate) or poly(butylene terephthalate), polystyrene, polycarbonate, polyacrylate, or poly(vinyl chloride). The polymer composition comprises 0.001 to 5 wt. %, preferably 0.01 to 2 wt. %, and more preferably 0.01 to 1 wt. %, based on the weight of the polymer composition, of the RMDA. The RMDA can be at least one alkoxylated aliphatic alcohol according to Formula (I):

R—(OCHR¹CH₂)_{y}—OH (I),

wherein R is C₁₂-C₆₀ hydrocarbyl; R¹ is H or C₁-C₄ alkyl; and y is an integer from 1 to 100. The RMDA can be, for example, at least one ethoxylated aliphatic ether according to Formula (Ia):

R—(OCH₂CH₂)_{y}—OH (Ia),

wherein R is C₁₂-C₆₀ hydrocarbyl; and y is an integer from 2 to 60. The RMDA can also be at least one alkoxylated aliphatic ester according to Formula (II):

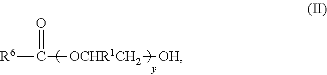

wherein R⁶ is C₁-C₅₉ hydrocarbyl; R′ is H or C₁-C₄ alkyl; and y is an integer from 1 to 100. For example, the RMDA can be at least one ethoxylated aliphatic ester according to Formula (IIa):

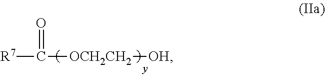

wherein R⁷ is C₁₁-C₂₉ hydrocarbyl; and y is an integer from 2 to 60. The RMDA can also be at least one alkoxylated aliphatic amine according to Formula (III):

R⁴—NR²R³ (III), or

alkoxylated aliphatic amide according to Formula (IV):

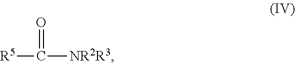

wherein R⁴ of Formula (III) is a C₈-C₆₀ hydrocarbyl and R⁵ of Formula (IV) is a C₇-C₅₉ hydrocarbyl, each optionally interrupted by one or more heteroatom; R² and R³ of Formula (III) and Formula (IV) are each independently H, C₁-C₃₀ alkyl, or —(CH₂CHR¹O)ₙ—H; at least one of R² or R³ of Formula (III) and Formula (IV) is —(CH₂CHR¹O)ₙ—H; R¹ is H or methyl; and each n is independently an integer from 1 to 100. The polymer composition can further comprise 0.001 to 5 wt. %, preferably 0.005 to 3 wt. %, and more preferably 0.01 to 1 wt. %, of an organic phosphite or phosphonite, based on the weight of the polymer composition. The polymer composition can also further comprise 0.001 to 5 wt. %, preferably 0.005 to 2 wt. %, and more preferably 0.01 to 1 wt. %, of a hindered phenol, based on the weight of the polymer composition. The polymer composition can further comprise 0.01 to 1 wt. % of at least one of zinc stearate, calcium stearate, zinc oxide, hydrotalcite, or hydrocalumite. The polymer composition can also further comprise 0.01 to 25 wt. %, preferably 0.01 to 10 wt. %, preferably 0.02 to 5 wt. %, and more preferably 0.05 to 3 wt. %, based on the weight of the polymer composition, of at least one tocopherol, tocopherol ester, hydroxylamine, tertiary amine oxide, hindered amine light stabilizer (HALS), ultraviolet light absorber (UVA), hindered benzoate, thiosynergist, benzofuranone, indolinone, nitrone, or nickel phenolate. The rotational molding densification accelerator (RMDA) selected from the group consisting of alkoxylated aliphatic alcohols, alkoxylated aliphatic esters, alkoxylated aliphatic amines, alkoxylated aliphatic amides, and combinations thereof, can be used in a rotational molding process for producing a hollow article. A hollow article is prepared by the process.

As described herein, the present disclosure includes at least the following embodiments.

Embodiment 1. A rotational molding process for producing a hollow article, the process comprising the steps of: a) filling a mold with a polymer composition comprising: i) an organic polymer; and ii) a rotational molding densification accelerator (RMDA) selected from the group consisting of alkoxylated aliphatic alcohols, alkoxylated aliphatic esters, alkoxylated aliphatic amines, alkoxylated aliphatic amides, and combinations thereof; b) rotating the mold around at least one axis while heating the mold in an oven, thereby fusing the composition and spreading it to the walls of the mold; c) cooling the mold; d) opening the mold; and e) removing the hollow article from the mold.

Embodiment 2. The process of Embodiment 1, wherein visible air bubbles are substantially removed from the hollow article in a shorter time than a control polymer composition without the RMDA.

Embodiment 3. The process of Embodiment 2, wherein the shorter time is 5 to 50% less, preferably 10 to 40% less, than the time for the bubbles to be substantially removed from the control without the RMDA.

Embodiment 4. The process of any of Embodiments 1 to 3, wherein the peak internal air temperature (PIAT) of the mold is from 70° C. to 400° C.

Embodiment 5. The rotational molding process of any of Embodiments 1 to 4, wherein the organic polymer comprises at least one of polyolefins, thermoplastic olefins (TPO), poly(ethylene-vinyl acetate) (EVA), polyesters, polyethers, polyketones, polyamides, natural and synthetic rubbers, polyurethanes, polystyrenes, polyacrylates, polymethacrylates, polybutyl acrylates, polyacetals, polyacrylonitriles, polybutadienes, acrylonitrile-butadiene-styrene (ABS), styrene-acrylonitrile (SAN), acrylonitrile-styrene-acrylate (ASA), cellulosic acetate butyrate, cellulosic polymers, polyimides, polyamideimides, polyetherimides, polyphenylene sulfides, polyphenylene oxides, polysulfones, polyethersulfones, polyvinyl chlorides, polycarbonates, amino resin cross-linked polyacrylates and polyesters, polyisocyanate cross-linked polyesters and polyacrylates, phenol/formaldehyde, urea/formaldehyde and melamine/formaldehyde resins, alkyd resins, polyester resins, acrylate resins cross-linked with melamine resins, urea resins, isocyanates, isocyanurates, carbamates, or epoxy resins, cross-linked epoxy resins derived from aliphatic, cycloaliphatic, heterocyclic, and aromatic glycidyl ethers, which are cross-linked with anhydrides or amines, polysiloxanes, Michael addition polymers, addition polymers of amines or blocked amines with activated unsaturated and activated methylene compounds, addition polymers of ketimines with activated unsaturated and activated methylene compounds, polyketimines in combination with unsaturated acrylic polyacetoacetate resins, coating compositions, radiation curable compositions, epoxy melamine resins, organic dyes, cosmetics, cellulose based paper, photographic film paper, fibers, waxes, or inks.

Embodiment 6. The process of any of Embodiments 1 to 4, wherein the organic polymer comprises at least one of a polyolefin, polyolefin copolymer or terpolymer, polyamide, copolyamide, polyester, such as poly(ethylene terephthalate) or poly(butylene terephthalate), polystyrene, polycarbonate, polyacrylate, or poly(vinyl chloride).

Embodiment 7. The process of any of Embodiments 1 to 4, wherein the organic polymer comprises at least one of a polyamide or copolyamide.

Embodiment 8. The process of any of Embodiments 1 to 5, wherein the organic polymer comprises a polyolefin.

Embodiment 9. The process of Embodiment 8, wherein the polyolefin comprises at least one of polyethylene or polypropylene.

Embodiment 10. The process of Embodiment 8, wherein the polyolefin comprises at least one of linear low density polyethylene (LLDPE), medium density polyethylene (MDPE), or high density polyethylene (HDPE).

Embodiment 11. The process of Embodiment 8, wherein the polyolefin comprises polyethylene prepared by catalytic polymerization using a metallocene catalyst.

Embodiment 12. The process of any of Embodiments 1 to 11, wherein the polymer composition comprises 0.001 to 5 wt. %, preferably 0.01 to 2 wt. %, and more preferably 0.01 to 1 wt. %, based on the weight of the polymer composition, of the RMDA.

Embodiment 13. The process of any of Embodiments 1 to 12, wherein the RMDA is at least one alkoxylated aliphatic alcohol according to Formula (I):

R—(OCHR¹CH₂)_{y}—OH (I),
wherein R is C₁₂-C₆₀ hydrocarbyl;
R¹ is H or C₁-C₄ alkyl; and
y is an integer from 1 to 100.

Embodiment 14. The process of any of Embodiments 1 to 13, wherein the RMDA is at least one ethoxylated aliphatic ether according to Formula (Ia):

R—(OCH₂CH₂)_{y}—OH (Ia),
wherein R is C₁₂-C₆₀ hydrocarbyl; and
y is an integer from 2 to 60.

Embodiment 15. The process of Embodiment 13 or 14, wherein R is derived from a fatty alcohol having the same number of carbon atoms.

Embodiment 16. The process of any of Embodiments 13 to 15, wherein the RMDA is at least one of an ethoxylated and/or propoxylated laurel alcohol, C₁₂-C₁₃ alcohol, C₁₂-C₁₄ secondary alcohol, C₁₂-C₁₅ oxo alcohol, tridecyl alcohol, cetyl alcohol, C₁₆/C₁₈ alkyl alcohol, stearyl alcohol, oleyl alcohol, docosyl alcohol, or saturated, linear C₂₀-C₅₀ synthetic alcohol.

Embodiment 17. The process of any of Embodiments 1 to 12, wherein the RMDA is at least one alkoxylated aliphatic ester according to Formula (II):

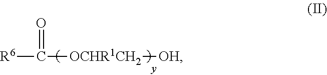

wherein R⁶ is C₁-C₅₉ hydrocarbyl;
R′ is H or C₁-C₄ alkyl; and
y is an integer from 1 to 100.

Embodiment 18. The process of any of Embodiments 1 to 12, wherein the RMDA is at least one ethoxylated aliphatic ester according to Formula (IIa):

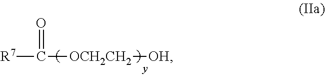

wherein R⁷ is C₁-C₂₉ hydrocarbyl; and
y is an integer from 2 to 60.

Embodiment 19. The process of Embodiment 17 or 18, wherein the RMDA is at least one of an ethoxylated and/or propoxylated laurate, C₁₆-C₁₈ alkanoate, stearate, oleate, or tallowate.

Embodiment 20. The process of any of Embodiments 1 to 12, wherein the RMDA is at least one alkoxylated aliphatic amine according to Formula (III):

R⁴—NR²R³ (III), or
alkoxylated aliphatic amide according to Formula (IV):

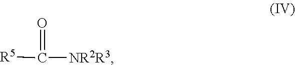

wherein R⁴ of Formula (III) is a C₈-C₆₀ hydrocarbyl and R⁵ of Formula (IV) is a C₇-C₅₉ hydrocarbyl, each optionally interrupted by one or more heteroatom;
R² and R³ of Formula (III) and Formula (IV) are each independently H, C₁-C₃₀ alkyl, or —(CH₂CHR¹O)ₙ—H;
at least one of R² or R³ of Formula (III) and Formula (IV) is —(CH₂CHR¹O)ₙ—H;
R¹ is H or methyl; and
each n is independently an integer from 1 to 100.

Embodiment 21. The process of Embodiment 20, wherein R⁴ of Formula (III) is C₈-C₃₆ alkyl and R⁵ of Formula (IV) is a C₇-C₃₅ alkyl, both optionally interrupted by one or more heteroatom.

Embodiment 22. The process of Embodiment 20, wherein R⁴ of Formula (III) is C₁₂-C₃₆ alkyl and R⁵ of Formula (IV) is a C₁₁-C₂₉ alkyl, optionally interrupted by one or more heteroatom.

Embodiment 23. The process of any of Embodiments 20 to 22, wherein each n is independently an integer from 1 to 10.

Embodiment 24. The process of any of Embodiments 20 to 23, wherein R⁴ of Formula (III) is derived from a fatty acid having the same number of carbon atoms, and R⁵ of Formula (IV) is derived from a fatty acid having one more carbon atom.

Embodiment 25. The process of any of Embodiments 20 to 24, wherein the RMDA is at least one of an ethoxylated and/or propoxylated stearyl amine, oleyl amine, tallow amine, hydrogenated tallow amine, cetyl amine, capryl amine, or coco amine.

Embodiment 26. The process of any of Embodiments 20 to 24, wherein the RMDA is at least one of cocoamide monoethanol amine, cocoamide diethanol amine, a cocoamide ethoxylate; lauramide diethanol amine; oleamide diethanol amine, or oleic acid monoethanol amide.

Embodiment 27. The process of any of Embodiments 1 to 26, wherein the polymer composition further comprises an organic phosphite or phosphonite.

Embodiment 28. The process of Embodiment 27, wherein the phosphite or phosphonite is at least one of:
i) a compound according to any of Formulae (1) to (7):

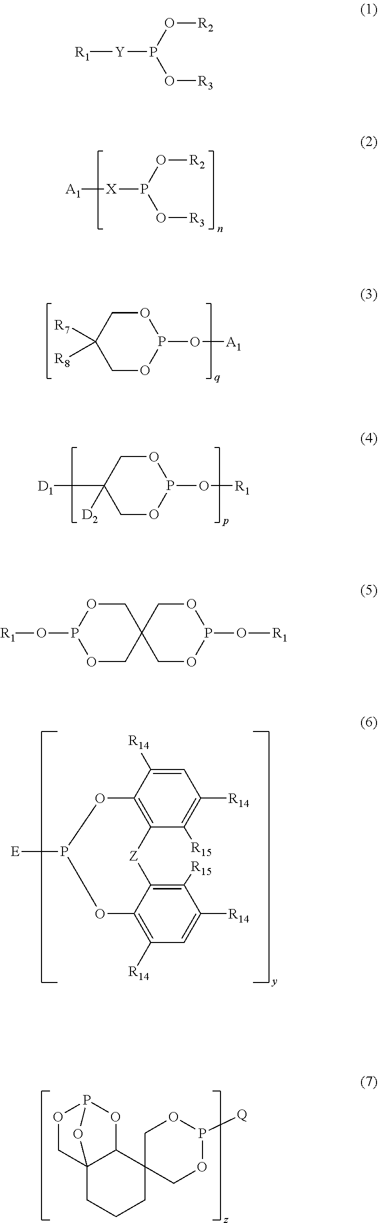

wherein:
the indices are integral and n is 2, 3 or 4; p is 1 or 2; q is 2 or 3; y is 1, 2 or 3; and z is 1 to 6;
A₁, if n or q is 2, is C₂-C₁₂ alkylene; C₂-C₁₂ alkylene interrupted by oxygen, sulfur or —NR₄—, a radical of the formulae:

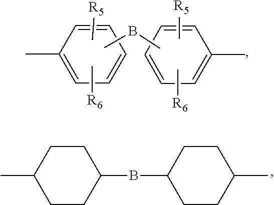

or phenylene;
A₁, if n or q is 3, is a divalent radical of the formula —CᵣH₂ᵣ₋₁—, wherein r is an integer from 4 to 12;
A₁, if n is 4, is

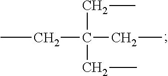

B is a direct bond, —CH₂—, —CHR₄—, —CR₁R₄—, sulfur, C₅-C₇ cycloalkylidene, or cyclohexylidene which is substituted by from 1 to 4 C₁-C₄ alkyl radicals in position 3, 4 and/or 5;
D₁, if p is 1, is C₁-C₄ alkyl and, if p is 2, is —CH₂OCH₂—;
D₂ is C₁-C₄ alkyl;
E, if y is 1, is C₁-C₁₈ alkyl, —OR₁ or halogen;
E, if y is 2, is —O-A₂-O—, wherein A₂ is as defined for A₁ when n is 2;
E, if y is 3, is a radical of the formula R₄C(CH₂O)₃ or N(CH₂CH₂O—)₃;
Q is the radical of an at least z-valent mono- or poly-alcohol or phenol, this radical being attached via the oxygen atom of the OH group of the mono- or poly-alcohol or phenol to the phosphorus atom;
R₁, R₂ and R₃ are each independently C₁-C₁₈ alkyl which is unsubstituted or substituted by halogen, —COOR₄, —CN or —CONR₄R₄; C₂-C₁₈ alkyl interrupted by oxygen, sulfur or —NR₄—; C₇-C₉ phenylalkyl; C₅-C₁₂ cycloalkyl, phenyl or naphthyl; naphthyl or phenyl substituted by halogen, 1 to 3 alkyl radicals or alkoxy radicals having a total of 1 to 18 carbon atoms or by C₇-C₉ phenylalkyl; or a radical of the formula

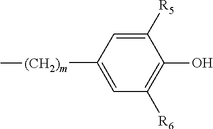

in which m is an integer from the range 3 to 6;
R₄ is hydrogen, C₁-C₅ alkyl, C₅-C₁₂ cycloalkyl or C₇-C₉ phenylalkyl;
R₅ and R₆ are each independently hydrogen, C₁-C₅ alkyl or C₅-C₆ cycloalkyl,
R₇ and R₈, if q is 2, are each independently C₁-C₄ alkyl or together are a 2,3-dehydropentamethylene radical; and R₇ and R₈, if q is 3, are each methyl;
each instance of R₁₅ is independently chosen from hydrogen, C₁-C₉ alkyl or cyclohexyl;
each instance of R₁₅ is independently hydrogen or methyl;
X and Y are each a direct bond or oxygen;
Z is a direct bond, methylene, —C(R₁₆)₂— or sulfur, and
R₁₆ is C₁-C₈ alkyl; or
ii) a trisarylphosphite according to Formula 8:

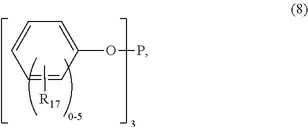

wherein:
R₁₇ is a substituent present at from 0 to 5 positions of the aromatic ring of Formula 8 and is independently C₁-C₂₀ alkyl, C₃-C₂₀ cycloalkyl, C₄-C₂₀ alkyl cycloalkyl, C₆-C₁₀ aryl, or C₇-C₂₀ alkylaryl.

Embodiment 29. The process of Embodiment 27, wherein the phosphite or phosphonite is at least one of:
triphenyl phosphite,
diphenyl alkyl phosphites,
phenyl dialkyl phosphites,
trilauryl phosphite,
trioctadecyl phosphite,
distearyl pentaerythritol phosphite,
tris(2,4-di-tert-butylphenyl) phosphite (IRGAFOS™ 168),
tris(4-nonylphenyl) phosphite,
a compound of Formulae (A), (B), (C), (D), (E), (F), (G), (H), (J), (K), or (L):

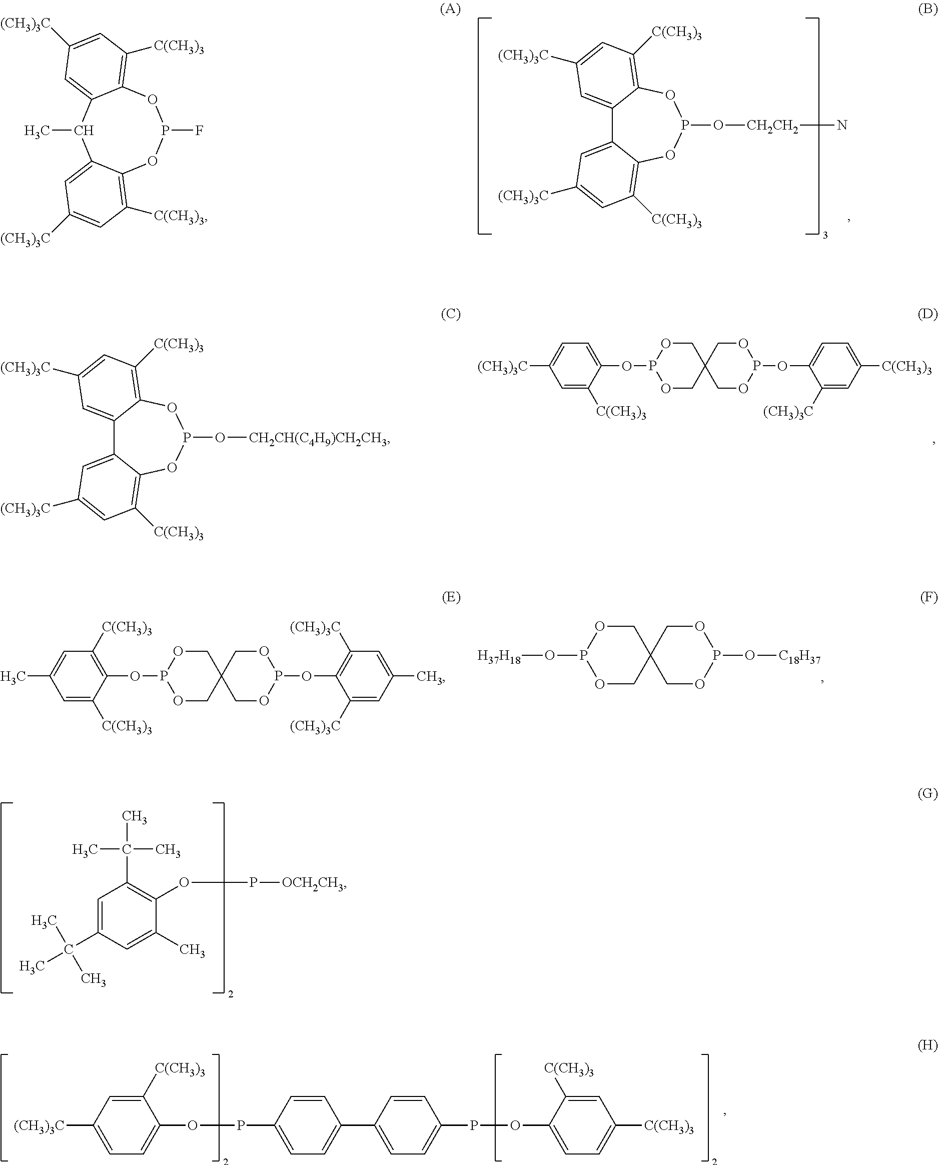

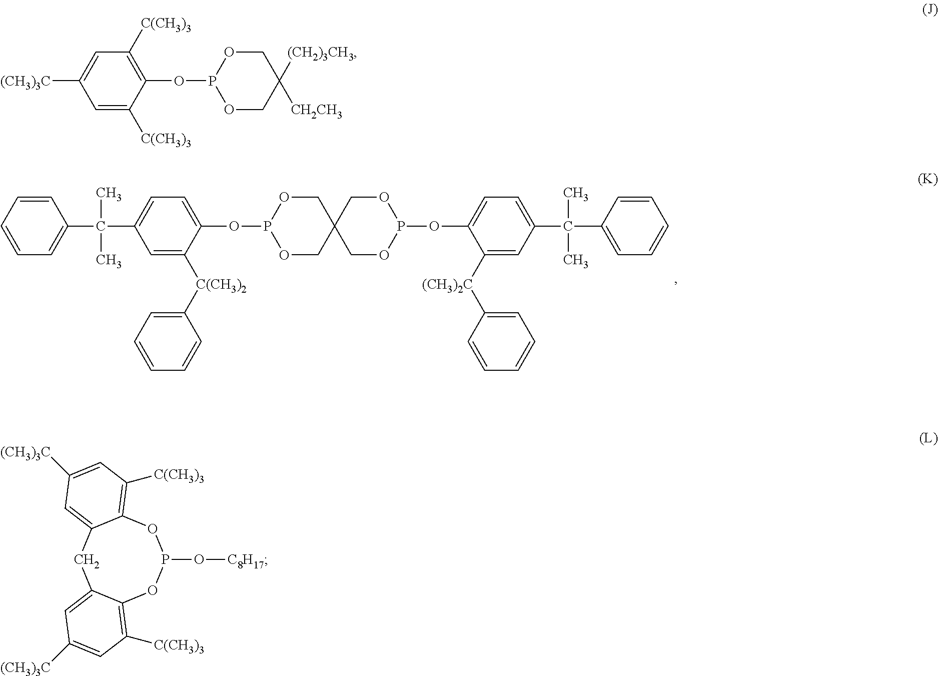

2-butyl-2-ethyl-1,3-propanediol 2,4,6-tri-tert-butylphenol phosphite,
   bis(2,6-di-tert-butyl-4-methlphenyl) pentaerythritol diphosphite,
2-butyl-2-ethyl-1,3-propanediol 2,4-di-cumylphenol phosphite,
2-butyl-2-ethyl-1,3-propanediol 4-methyl-2,6-di-tert-butylphenol phosphite, or
   bis(2,4,6-tri-tert-butyl-phenyl) pentaerythritol diphosphate.

Embodiment 30. The process of claim 27, wherein the organic phosphite or phosphonite is at least one of tris(2,4-di-tert-butylphenyl)phosphite (IRGAFOS™ 168), bis(2,4-dicumylphenyl)pentaerythritol diphosphite (DOVERPHOS™ S9228), tetrakis(2,4-di-tert-butylphenyl)-4,4′-biphenylene-diphosphonite (IRGAFOS™ P-EPQ), tris(4-nonylphenyl) phosphite, triphenyl phosphite, trilauryl phosphite, trioctadecyl phosphite, or distearyl pentaerythritol phosphite.

Embodiment 31. The process of any of Embodiments 27 to 30, wherein the polymer composition comprises 0.001 to 5 wt. %, preferably 0.005 to 3 wt. %, and more preferably 0.01 to 1 wt. %, of the organic phosphite or phosphonite, based on the weight of the polymer composition.

Embodiment 32. The process of any of Embodiments 1 to 31, wherein the polymer composition further comprises a hindered phenol.

Embodiment 33. The process of Embodiment 32, wherein the hindered phenol has at least one group according to Formulae (IVa), (IVb), or (IVc):

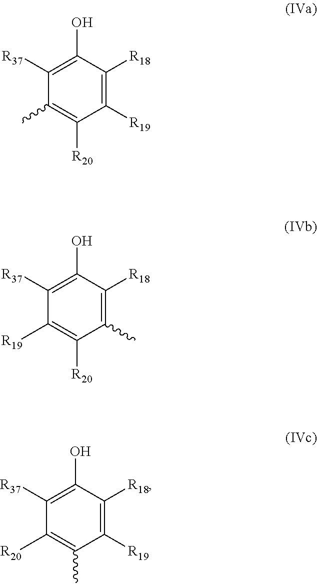

wherein
“ [symbol] ” indicates the point of attachment (via a carbon-carbon single bond) of the molecular fragment to a parent compound;
R₁₈ of Formula (IVa), (IVb), and (IVc) is independently hydrogen or C₁₋₄ hydrocarbyl;
each of R₁₉ and R₂₀ of Formula (IVa), (IVb), and (IVc) is independently hydrogen or C₁-C₂₀ hydrocarbyl; and
R₃₇ of Formula (IVa), (IVb), and (IVc) is C₁-C₁₂ hydrocarbyl.

Embodiment 34. The process of Embodiment 33, wherein R₁₈ and R₃₇ are each independently methyl or tert-butyl.

Embodiment 35. The process of Embodiment 32, wherein the hindered phenol is at least one of: 1,3,5-tris-(3,5-di-tert-butyl-4-hydroxybenzyl)-2,4,6-trimethylbenzene (ETHANOX™ 330), bis-(3,5-di-tert-butyl-4-hydroxybenzyl)sulfide, 1,3,5-tris-(3,5-di-tert-butyl-4-hydroxybenzyl)isocyanurate (ETHANOX™ 314), 1,3,5-tris-(4-tert-butyl-3-hydroxy-2,6-dimethylbenzyl)isocyanurate (CYANOX™ 1790), dioctadecyl 3,5-di-tert-butyl-4-hydroxybenzylphosphonate, esters of β-(3,5-di-tert-butyl-4-hydroxyphenyl)propionic acid with monohydric or polyhydric alcohols, for example methanol, octadecanol (IRGANOX™ 1076), 1,6-hexanediol, neopentyl glycol, thiodiethylene glycol, diethylene glycol, triethylene glycol, pentaerythritol (IRGANOX™ 1010), tris-(hydroxyethyl)isocyanurate and N,N′-bis-(hydroxyethyl)oxamide, esters of β-(5-tert-butyl-4-hydroxy-3-methylphenyl)propionic acid with monohydric or polyhydric alcohols, for example methanol, octadecanol, 1,6-hexanediol, neopentyl glycol, thiodiethylene glycol, diethylene glycol, triethylene glycol, pentaerythritol, tris-(hydroxyethyl)isocyanurate and N,N′-bis-(hydroxyethyl)-oxamide, amides of β-(3,5-di-tert-butyl-4-hydroxyphenyl)propionic acid, for example N,N′-bis-(3,5-di-tert-butyl-4-hydroxyphenyl-propionyl)-hexamethylenediamine, or N,N′-bis-(3,5-di-tert-butyl-4-hydroxyphenylpropionyl)-trimethylenediamine.

Embodiment 36. The process of any of Embodiments 32 to 35, wherein the polymer composition comprises 0.001 to 5 wt. %, preferably 0.005 to 2 wt. %, and more preferably 0.01 to 1 wt. %, of the hindered phenol, based on the weight of the polymer composition.

Embodiment 37. The process of any of Embodiments 1 to 36, wherein the polymer composition further comprises 0.01 to 1 wt. % of at least one of zinc stearate, calcium stearate, zinc oxide, hydrotalcite, or hydrocalumite.

Embodiment 38. The process of any of Embodiments 1 to 37, wherein the polymer composition further comprises 0.01 to 25 wt. %, preferably 0.01 to 10 wt. %, preferably 0.02 to 5 wt. %, and more preferably 0.05 to 3 wt. %, based on the weight of the polymer composition, of at least one tocopherol, tocopherol ester, hydroxylamine, tertiary amine oxide, hindered amine light stabilizer (HALS), ultraviolet light absorber (UVA), hindered benzoate, thiosynergist, benzofuranone, indolinone, nitrone, or nickel phenolate.

Embodiment 39. The process of any of Embodiments 1 to 38, wherein the polymer composition further comprises at least one of α-tocopherol, β-tocopherol, γ-tocopherol, δ-tocopherol, or esters thereof.

Embodiment 40. The process of any of Embodiments 1 to 38, wherein the polymer composition further comprises α-tocopherol (Vitamin E).

Embodiment 41. The process of any of Embodiments 1 to 38, wherein the tocopherol comprises α-tocopherol acetate (Vitamin E acetate).

Embodiment 42. The process of any of Embodiments 1 to 41, wherein the polymer composition further comprises at least one hydroxylamine or tertiary amine oxide.

Embodiment 43. The process of any of Embodiments 1 to 42, wherein the polymer composition further comprises at least one of N,N-dibenzylhydroxylamine, N,N-diethylhydroxylamine, N,N-dioctylhydroxylamine, N,N-dilaurylhydroxylamine, N,N-didodecylhydroxylamine, N,N-ditetradecylhydroxylaamine, N,N-dihexadecylhydroxylamine, N,N-dioctadecylhydroxylamine N-hexadecyl-N-tetradecylhydroxylamine, N-hexadecyl-N-heptadecylhydroxylamine, N-hexadecyl-N-octadecylhydroxylamine, N-heptadecyl-N-octadecylhydroxylamine, or N,N-di(hydrogenated tallow)hydroxylamine (IRGASTAB™ FS-042).

Embodiment 44. The process of any of Embodiments 1 to 42, wherein the polymer composition further comprises N,N-di(hydrogenated tallow)hydroxylamine (IRGASTAB™ FS-042).

Embodiment 45. The process of any of Embodiments 1 to 44, wherein the polymer composition further comprises a hindered amine light stabilizer (HALS).

Embodiment 46. The polymer composition of Embodiment 45, wherein the hindered amine light stabilizer (HALS) is at least one of:
bis(2,2,6,6-tetramethylpiperidin-4-yl) sebacate (TINUVIN™ 770);
bis(2,2,6,6-tetramethylpiperidin-4-yl) succinate;
bis(1,2,2,6,6-pentamethylpiperidin-4-yl) sebacate;
bis(1-octyloxy-2,2,6,6-tetramethylpiperidyl) succinate;
bis(1-octyloxy-2,2,6,6-tetramethylpiperidin-4-yl) sebacate (TINUVIN™ 123);
bis(1,2,2,6,6-pentamethylpiperidin-4-yl) n-butyl 3,5-di-tert-butyl-4-hydroxybenzylmalonate;
a condensate of 1-(2-hydroxyethyl)-2,2,6,6-tetramethyl-4-hydroxypiperidine and succinic acid (TINUVIN™ 622);
2,2,6,6-tetramethylpiperidin-4-yl stearate;
2,2,6,6-tetramethylpiperidin-4-yl dodecanate;
1,2,2,6,6-pentamethylpiperidin-4-yl stearate;
1,2,2,6,6-pentamethylpiperidin-4-yl dodecanate;
   a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);
   tris(2,2,6,6-tetramethylpiperidin-4-yl) nitrilotriacetate;
4-stearyloxy-2,2,6,6-tetramethylpiperidine;
   a condensate of N,N′-bis(2,2,6,6-tetramethylpiperidin-4-yl)hexamethylenediamine and 4-morpholino-2,6-dichloro-1,3,5-triazine (CYASORB™ UV-3346);
   a condensate of N,N′-bis(2,2,6,6-tetramethylpiperidin-4-yl)hexamethylenediamine and 4-morpholino-2,6-dichloro-1,3,5-triazine, methylated (CYASORB™ UV-3529);
   a condensate of 2-chloro-4,6-bis(4-n-butylamino-2,2,6,6-tetramethylpiperidyl)-1,3,5-triazine and 1,2-bis(3-aminopropylamino)ethane (CHIMASSORB™ 119);
   a condensate of 2-chloro-4,6-bis(4-n-butylamino-1,2,2,6,6-pentamethylpiperidyl)-1,3,5-triazine and 1,2-bis-(3-aminopropylamino)ethane;
   a condensate of N,N′-bis(2,2,6,6-tetramethylpiperidin-4-yl)hexamethylenediamine, N-butyl-2,2,6,6-tetramethyl-4-piperidinamine, di-n-butyl amine, and 2,4,6-trichloro-1,3,5-triazine (CHIMASSORB™ 2020);
   a mixture of 4-hexadecyloxy- and 4-stearyloxy-2,2,6,6-tetramethylpiperidine (CYASORB™ UV-3853);
   a mixture of 4-hexadecyloxy- and 4-stearyloxy-1,2,2,6,6-pentamethylpiperidine; a condensate of N,N′-bis(2,2,6,6-tetramethylpiperidin-4-yl)hexamethylenediamine and 4-cyclohexylamino-2,6-dichloro-1,3,5-triazine;
   a condensate of 1,2-bis(3-aminopropylamino)ethane, 2,4,6-trichloro-1,3,5-triazine, and 4-butylamino-2,2,6,6-tetramethylpiperidine;
   a condensate of N,N′-bis(2,2,6,6-tetramethylpiperidin-4-yl)hexamethylenediamine and 4-cyclohexylamino-2,6-dichloro-1,3,5-triazine;
   tetrakis(2,2,6,6-tetramethylpiperidin-4-yl)-1,2,3,4-butanetetracarboxylate;
   tetrakis(1,2,2,6,6-pentamethylpiperidin-4-yl)-1,2,3,4-butanetetracarboxylate;
1,2,3,4-butanetetracarboxylic acid, 2,2,6,6-tetramethylpiperidinyl-4-yl tridecyl ester;
1,2,3,4-butanetetracarboxylic acid, 1,2,2,6,6-pentamethylpiperidin-4-yl tridecyl ester;
   formamide, N,N′-1,6-hexanediylbis[N-(2,2,6,6-tetramethylpiperidin-4-yl) (UVINUL™ 4050);
   a condensate of N,N′-bis(2,2,6,6-tetramethyl-1-(propyloxy)-piperidin-4-yl)hexamethylenediamine, N-butyl-1-propyloxy-2,2,6,6-tetramethyl-4-piperidinamine, di-n-butyl amine, and 2,4,6-trichloro-1,3,5-triazine (TINUVIN™ NOR HALS 371);
   N,N′-bis(2,2,6,6-tetramethyl-4-piperidin-4-yl)hexamethylene diamine, polymer with 2,4,6-trichloro-1,3,5-triazine, reaction products with 3-bromo-1-propene, di-n-butylamine, and N-butyl-2,2,6,6-tetramethyl-4-piperidinamine, oxidized, hydrogenated (TINUVIN™ XT 200);
   TINUVIN™ XT-850/XT-855); or
   N¹,N^{1′}-1,2-ethanediylbis(1,3-propanediamine), reaction products with cyclohexane and peroxidized N-butyl-2,2,6,6-tetramethyl-4-piperidinamine-2,4,6-trichloro-1,3,5-triazine (FLAMESTAB™ NOR 116).

Embodiment 47. The process of any of Embodiments 1 to 46, wherein the polymer composition further comprises an ultraviolet light absorber (UVA).

Embodiment 48. The process of Embodiment 47, wherein the ultraviolet light absorber is at least one of a 2-hydroxybenzophenone, a 2-(2′-hydroxyphenyl)benzotriazole, a 2-(2′-hydroxyphenyl)-s-triazine, or a benzoxazinone.

Embodiment 49. The process of Embodiment 47, wherein the ultraviolet light absorber is a 2-(2′-hydroxyphenyl)-s-triazine.

Embodiment 50. The process of Embodiment 49, wherein the 2-(2′-hydroxyphenyl)-s-triazine is at least one of:
4,6-diphenyl-2-(4-hexyloxy-2-hydroxyphenyl)-s-triazine (TINUVIN™ 1577),
4,6-bis-(2,4-dimethylphenyl)-2-(2-hydroxy-4-octyloxyphenyl)-s-triazine (CYASORB™ 1164),
2,4-bis[2-hydroxy-4-(2-hydroxy-4-(2-hydroxyethoxy)phenyl]-6-(2,4-dimethylphenyl)-s-triazine,
   mixture of 4,6-bis(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine (TINUVIN™ 400),
4,6-bis(2,4-dimethylphenyl)-2-(2-hydroxy-4(3-(2-ethylhexyloxy)-2-hydroxypropoxy)-phenyl)-s-triazine (TINUVIN™ 405),
4,6-bis(2,4-dimethylphenyl)-2-(2-hydroxy-4(3-(2-ethylhexyloxy)-2-hydroxypropoxy)-phenyl)-s-triazine,
2,4-bis(2,4-dimethylphenyl)-6-[2-hydroxy-4-[(octyloxycarbonyl)ethylideneoxy]phenyl]-s-triazine (TINUVIN™ 479),
2,4-bis(4-biphenylyl)-6-[2-hydroxy-4-[(octyloxycarbonyl)ethylideneoxy]phenyl]-s-triazine,
2,4-bis(4-biphenylyl)-6-[2-hydroxy-4-(2-ethylhexyloxy)phenyl]-s-triazine (TINUVIN™ 1600),
2,4-bis(2-hydroxy-4-butyloxyphenyl)-6-(2,4-bis-butyloxyphenyl)-s-triazine (TRIAZINE™ 460),
2,4,6-tris[2-hydroxy-4-(3-sec-butyloxy-2-hydroxypropyloxy)-phenyl]-s-triazine, or
2,4,6-tris[2-hydroxy-4-[(octyloxycarbonyl)ethylideneoxy]phenyl]-s-triazine (TINUVIN™ 477).

Embodiment 51. The process of any of Embodiments 1 to 50, wherein the polymer composition further comprises at least one of a metal chelating agent, nucleating agent, lubricant, plasticizer, compatibilizer, blowing agent, flame retardant, anti-block agent, slip agent, anti-static agent, filler, reinforcing agent, metal oxide, optical brightener, dye, or pigment.

Embodiment 52. A hollow article prepared by the process of any of Embodiments 1 to 51.

Embodiment 53. Use of a rotational molding densification accelerator (RMDA) selected from the group consisting of alkoxylated aliphatic alcohols, alkoxylated aliphatic esters, alkoxylated aliphatic amines, alkoxylated aliphatic amides, and combinations thereof, in a rotational molding process for producing a hollow article.

### EXAMPLES

The following examples are provided to assist one skilled in the art to further understand certain embodiments of the present invention. These examples are intended for illustration purposes and are not to be construed as limiting the scope of the various embodiments of the present invention.

The performances of various individual additive materials as well as their specific combinations are evaluated in regard to protecting polymers from UV-C induced discoloration and photodegradation. Polypropylene homopolymer (Pro-fax 6301 NT) from LyondellBasell is chosen as the polymer matrix for the weathering studies in the examples. Information regarding the suppliers, commercial names, and chemical names of various additive materials in formulating the examples is listed in Table 1. In some cases, these same chemicals may be available from other suppliers under different trade names. All additive materials are used as received.

TABLE 1
Additive Types, Trade names, Chemical
Names, and Suppliers of Additives

| Additive | | |
|---|---|---|
| Type | Trade Name (Source) | Chemical Name |
| Acid | ZnSt | Zinc stearate |
| scavenger | | |
| Antioxidant | CYANOX ™ 1790 | Tris(4-tert-butyl-3-hydroxy- |
| | (Solvay) | 2,6-dimethylbenzyl) |
| | | isocyanurate |
| Antioxidant | IRGAFOS ™ 168 | Tris(2,4-di-tert-butylphenyl) |
| | (BASF) | phosphite |
| Antioxidant | IRGASTAB ™ FS-042 | Bis(hydrogenated tallow |
| | (“Hydroxylamine”, BASF) | alkyl)amines |
| Antioxidant | Vitamin E Acetate | dl-α-Tocopherol acetate |
| RMDA | LEUNAPON ™ F1618-55 | Aliphatic (C₁₆-C₁₈) |
| | (Vantage Leuna, | alcohol ethoxylate |
| | Leuna, Germany) | |
| RMDA | PEGOSPERSE ™ 100-S | Diethylene glycol (DEG) |
| | (Lonza, Basel, Switzerland) | monostearate |
| RMDA | BRIJ ™ S-2 | Diethylene glycol (DEG) |
| | (Croda) | monostearate |
| RMDA | FENTACARE ™ 1802 | N,N-bis(2- |
| | (Solvay) | hydroxyethyl)octadecylamine |

### Examples 1-7—General Procedure

4 Kg batches of LLDPE were dry blended with 0.05 weight percent (wt. %) of zinc stearate (ZnSt), 0.10 wt. % IRGAFOS™ 168 (AO in figures), and the other additives indicated below, and compounded at 190° C. on a Werner & Pfleiderer Coperion twin screw extruder, type ZSK-30. The extruder had 30-mm diameter co-rotating screws, electrical heaters, water-cooled barrel, 30:1 l/d, (9) total barrel segments with (1) feed, (3) vented, (1) side feeder, (4) non-vented, (1) Spacer, 10.4:1 gearbox ratio, driven by 15 hp, AC motor with vfd controller, with control panel with Eurotherm controllers. The resulting pellets were ground to a uniform particle size (150-500 m) prior to the rotational molding process on a Powder King PKA-18 Table Top Lab Mill Pulverizer. Using enough powder to produce a ⅛″-¼″ thick-walled part, the formulation was rotationally molded using laboratory scale equipment (e.g., a Ferry E-40 shuttle rotational molder). The ground resin was placed in a cast aluminum mold, which was rotated biaxially in a gas-fired oven heated to a temperature of 288° C. The arm ratio for the cast aluminum mold was 8:2. After rotating in the oven for specific time intervals, the mold was removed from the oven and air cooled for 19 minutes while still rotating, followed by a 2-minute water spray, and then 2 minutes in circulating air. After the cooling cycle, the mold was opened and the hollow part was removed and then tested by measuring the density and visualizing the part bubbles. The density was measured using a Micromeritics AccuPycII 1340 Pycnometer. Samples of the hollow part were cut using a pneumatic press to fit in a 10-mL sample cell and were pre-weighed prior to sample analysis. Each sample was measured using a precision tolerance of 0.03%. The part bubbles were visualized by cutting the part open and using a Stanley Block Plane to slice off a uniform section of the part wall which was then imaged with a Leica S9i Microscope. Formulations that achieved the highest density (over 0.930 g/mL), and lowest visual bubbles, at the shortest rotational molding time intervals are desirable (reduced cycle time). The color (or yellowness) of the molded part was also be tested. The sample was read using a GretagMacbeth Color i7 spectrophotometer. The yellowness according to ASTM D1925 was reported for the mold side of the rotomolded part. Positive yellowness values indicate presence and magnitude of yellowness (generally unfavorable), while a negative yellowness value indicates that a material appears bluish (generally favorable).

### Example 1

The control contained 0.05 wt. % ZnSt and 0.10 wt. % IRGAFOS™ 168, and the examples also contained 0.05 wt. % LEUNAPON™ F1618-55 or 0.05 wt. % PEGOSPERSE™ 100-S. The results are summarized in FIG. 1A (density) and FIG. 1B (cross-sections of rotomolded parts showing air bubbles).

### Example 2

The control contained 0.05 wt. % ZnSt and 0.10 wt. % IRGAFOS™ 168, and the examples also contained 0.05, 0.10, or 0.50 wt. % LEUNAPON™ F1618-55. The results are summarized in FIG. 2A (density) and FIG. 2B (cross-sections of rotomolded parts showing air bubbles).

### Example 3

The control contained 0.05 wt. % ZnSt and 0.10 wt. % IRGAFOS™ 168, and the examples also contained 0.05 wt. % hydroxylamine, 0.05 wt. % LEUNAPON™ F1618-55 or 0.05 wt. % PEGOSPERSE™ 100-S. The results are summarized in FIG. 3A (density) and FIG. 3B (cross-sections of rotomolded parts showing air bubbles).

### Example 4

The control contained 0.05 wt. % ZnSt and 0.10 wt. % IRGAFOS™ 168, and the examples also contained 0.05 wt. % Vitamin E Acetate, 0.05 wt. % LEUNAPON™ F1618-55 or 0.05 wt. % PEGOSPERSE™ 100-S. The results are summarized in FIG. 4A (density) and FIG. 4B (cross-sections of rotomolded parts showing air bubbles).

### Example 5

The control contained 0.05 wt. % ZnSt and 0.10 wt. % IRGAFOS™ 168, and the examples also contained 0.05 or 0.10 wt. % Vitamin E Acetate, or 0.05 or 0.10 wt. % LEUNAPON™ F1618-55. The results are summarized in FIG. 5A (density) and FIG. 5B (cross-sections of rotomolded parts showing air bubbles).

### Example 6

The control contained 0.05 wt. % ZnSt, 0.10 wt. % IRGAFOS™ 168, and 0.025 wt. % CYANOX™ 1790, and the examples also contained 0.05, 0.10, or 0.50 wt. % LEUNAPON™ F1618-55. The results are summarized in FIG. 6A (density) and FIG. 6B (cross-sections of rotomolded parts showing air bubbles).

### Example 7

The control contained 0.05 wt. % ZnSt and 0.10 pph IRGAFOS™ 168, and the example also contained 0.05 wt. % FENTACARE™ 1812. The results are summarized in FIG. 7A (density) and FIG. 7B (cross-sections of rotomolded parts showing air bubbles).

### Examples 8-9—General Procedure

The additives were added to powder LLDPE. Dry blended and then compounded on a Davis Standard XL-125 single screw extruder set at a melting point of 190° C. and screw speed of 65 rpm. The pellets were then collected and ground into a fine powder.

The powder was then weighed into an aluminum mold and placed on a PHI heated press set to 475° F. (246° C.). The top and bottom of the press plates separated as far as possible so the top plate does not come in contact with the mold. The resin is allowed to set for designated times and then removed. While cooling the operator makes visual observations on the number of air bubbles. Once cooled the plaque is read for yellowness on the Gretag Macbeth Color 17 spectrophotometer. A section of the plaque is then cut and tested for density.

Samples were prepared at different concentration using the additives of the current invention and compared with the commercial additives. Samples were then tested using the simulation technique for air bubbles (visual observation), color/yellowness index (Gretag Macbeth Color 17 spectrophotometer), and density.

### Example 8

This example shows the effect on cycle time for BRIJ™ S2 (DEG monostearate) compared to α-tocopherol acetate and IRGASTAB™ FS-042 at 1 wt. % and 2 wt. % loadings in ¼″ PE plaques. Air bubbles were visually observed at the 12-, 14-, 16-, 18-, and 20-minute intervals and ratings of 2.5, 5, 7.5, or 10 were assigned based on the number of bubbles counted, with 10 meaning many bubbles, 7.5 meaning less bubbles, 5 meaning few bubbles, and 2.5 meaning no bubbles. The results are tabulated in Table 2 below and depicted in bar charts in FIG. 8A.

TABLE 2
Visually Rated Bubble Density in Polypropylene
Plaques as Function of Time at 246° C.

| | | Time at 246° C. (min) | | | | |
|---|---|---|---|---|---|---|
| Sample | Formulation (wt. %) | 12 | 14 | 16 | 18 | 20 |
| 8-1 | 1% IRGASTAB ™ FS-042 | 10 | 7.5 | 7.5 | 7.5 | 2.5 |
| 8-2 | 2% IRGASTAB ™ FS-042 | — | 10 | 7.5 | 7.5 | 5 |
| 8-3 | 1% Vitamin E Acetate | — | 10 | 10 | 10 | 10 |
| 8-4 | 2% Vitamin E Acetate | — | 10 | 10 | 10 | 10 |
| 8-5 | 1% BRIJ ™ S2 | 10 | 7.5 | 7.5 | 7.5 | 2.5 |
| 8-6 | 2% BRIJ ™ S2 | — | 10 | 7.5 | 7.5 | 2.5 |

The yellowness index and density of the polypropylene plaques were also measured at each interval. The results are tabulated in Tables 3 and 4 and FIGS. 8B and 8C. BRIJ™ S2 provided the lowest bubble density at 20 min. (Table 3 and FIG. 8A), the lowest yellowness index (Table 4 and FIG. 8B), and comparable or higher plaque density (Table 4 and FIG. 8C) at both 1 wt. % and 2 wt. % loading levels.

TABLE 3
Yellow Index of Polypropylene Plaques
as Function of Time at 246° C.

| | | Time at 246° C. (min) | | | | |
|---|---|---|---|---|---|---|
| Sample | Formulation (wt. %) | 12 | 14 | 16 | 18 | 20 |
| 8-1 | 1% IRGASTAB ™ FS-042 | −3.75 | −3.62 | −1.26 | 0.76 | −0.23 |
| 8-2 | 2% IRGASTAB ™ FS-042 | 1.60 | −0.89 | 1.89 | 4.44 | 4.43 |
| 8-3 | 1% Vitamin E Acetate | — | 7.52 | 6.64 | 9.21 | 6.45 |
| 8-4 | 2% Vitamin E Acetate | — | 7.29 | 9.48 | 9.68 | 11.64 |
| 8-5 | 1% BRIJ ™ S2 | −9.37 | −8.79 | −8.53 | −8.83 | −8.50 |
| 8-6 | 2% BRIJ ™ S2 | — | −8.24 | −7.04 | −6.02 | −6.74 |

TABLE 4
Density (g/mL) of Polypropylene Plaques as Function of Time at 246° C.

| | | Time at 246° C. (min) | | | | |
|---|---|---|---|---|---|---|
| Sample | Formulation (wt. %) | 12 | 14 | 16 | 18 | 20 |
| 8-1 | 1% IRGASTAB ™ FS-042 | 0.93580 | 0.93552 | 0.93406 | 0.93470 | 0.93708 |
| 8-2 | 2% IRGASTAB ™ FS-042 | 0.93334 | 0.94050 | 0.93958 | 0.93232 | 0.93428 |
| 8-3 | 1% Vitamin E Acetate | — | 0.93116 | 0.92998 | 0.93400 | 0.93732 |
| 8-4 | 2% Vitamin E Acetate | — | 0.93194 | 0.93452 | 0.92878 | 0.93008 |
| 8-5 | 1% BRIJ ™ S2 | 0.93498 | 0.93550 | 0.93320 | 0.93314 | 0.93950 |
| 8-6 | 2% BRIJ ™ S2 | 0.93840 | 0.93840 | 0.93990 | 0.93356 | 0.93504 |

### Example 9

This example shows the effects of BRIJ™ S2 (stearyl mono-ether of diethylene glycol) compared to α-tocopherol acetate and IRGASTAB™ FS-042 at 1 wt. % and 2 wt. % loadings in ½″ LLDPE plaques on cycle time reduction. The bubbles were visually observed and counted after 18-, 24-, 30-, and 34-minute intervals, and ratings of 2.5, 5, 7.5, or 10 were assigned based on the number of bubbles counted at each interval. The yellowness index and density of the plaques were also measured at each interval. As can be seen from the data below, BRIJ™ S2 and BRIJ™ S2 have comparable or lower bubbles (FIG. 9A), comparable or lower yellowness index, and higher density (bubble free) compared to α-tocopherol acetate and IRGASTAB™ FS-042.

TABLE 5
Density (g/mL) of ½″ Polypropylene
Plaques at 246° C. for 34 Minutes.

| Sample | Formulation (wt. %) | Density (g/mL) |
|---|---|---|
| 9-1 | IRGASTAB ™ FS-042 | 0.9280 |
| 9-2 | Vitamin E Acetate | 0.91798 |
| 9-3 | BRIJ ™ S2 | 0.9298 |
| 9-4 | BRIJ ™ 93 | 0.93056 |

The results demonstrate that the heating times required to achieve optimal cure of a polyolefin article using a standard rotomolding process can be reduced by using the polymer compositions described in detail herein. Reduction of heating times to remove bubbles provides the direct benefits of lower energy costs and increased production efficiency without compromising physical and/or mechanical properties of the rotomolded article. The new rotomolding processing polymer compositions described herein are also shown to provide a broad processing window, thereby enabling the production of parts having high impact strength over a broader range of peak internal air temperatures or heating times versus conventional processing systems. Accordingly, these new processing polymer compositions provide an excellent alternative to other approaches and/or systems to accelerate the sintering/densification of the polymer resin during the rotomolding process.

Various patent and/or scientific literature references have been referred to throughout this application. The disclosures of these publications in their entireties are hereby incorporated by reference as if written herein. In view of the above description and the examples, one of ordinary skill in the art will be able to practice the disclosure as claimed without undue experimentation.

Although the foregoing description has shown, described, and pointed out the fundamental novel features of the present teachings, it will be understood that various omissions, substitutions, and changes in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims.

We claim:

1. A rotational molding process for producing a hollow article, the process comprising the steps of:
a) filling a mold with a polymer composition comprising:
i) an organic polymer; and
ii) a rotational molding densification accelerator (RMDA) selected from the group consisting of alkoxylated aliphatic alcohols, alkoxylated aliphatic esters, alkoxylated aliphatic amines, alkoxylated aliphatic amides, and combinations thereof;
b) rotating the mold around at least one axis while heating the mold in an oven, thereby fusing the composition and spreading it to the walls of the mold;
c) cooling the mold;
d) opening the mold; and
e) removing the hollow article from the mold.

2. The process of claim 1, wherein visible air bubbles are substantially removed from the hollow article in a shorter time than a control polymer composition without the RMDA.

3. The process of claim 2, wherein the shorter time is 5 to 50% less, preferably 10 to 40% less, than the time for the bubbles to be substantially removed from the control without the RMDA.

4. The process of any of claims 1 to 3, wherein the peak internal air temperature (PIAT) of the mold is from 70° C. to 400° C.

5. The rotational molding process of any of claims 1 to 4, wherein the organic polymer comprises at least one of polyolefins, thermoplastic olefins (TPO), poly(ethylene-vinyl acetate) (EVA), polyesters, polyethers, polyketones, polyamides, natural and synthetic rubbers, polyurethanes, polystyrenes, polyacrylates, polymethacrylates, polybutyl acrylates, polyacetals, polyacrylonitriles, polybutadienes, acrylonitrile-butadiene-styrene (ABS), styrene-acrylonitrile (SAN), acrylonitrile-styrene-acrylate (ASA), cellulosic acetate butyrate, cellulosic polymers, polyimides, polyamideimides, polyetherimides, polyphenylene sulfides, polyphenylene oxides, polysulfones, polyethersulfones, polyvinyl chlorides, polycarbonates, amino resin cross-linked polyacrylates and polyesters, polyisocyanate cross-linked polyesters and polyacrylates, phenol/formaldehyde, urea/formaldehyde and melamine/formaldehyde resins, alkyd resins, polyester resins, acrylate resins cross-linked with melamine resins, urea resins, isocyanates, isocyanurates, carbamates, or epoxy resins, cross-linked epoxy resins derived from aliphatic, cycloaliphatic, heterocyclic, and aromatic glycidyl ethers, which are cross-linked with anhydrides or amines, polysiloxanes, Michael addition polymers, addition polymers of amines or blocked amines with activated unsaturated and activated methylene compounds, addition polymers of ketimines with activated unsaturated and activated methylene compounds, polyketimines in combination with unsaturated acrylic polyacetoacetate resins, coating compositions, radiation curable compositions, epoxy melamine resins, organic dyes, cosmetics, cellulose based paper, photographic film paper, fibers, waxes, or inks.

6. The process of any of claims 1 to 4, wherein the organic polymer comprises at least one of a polyolefin, polyolefin copolymer or terpolymer, polyamide, copolyamide, polyester, such as poly(ethylene terephthalate) or poly(butylene terephthalate), polystyrene, polycarbonate, polyacrylate, or poly(vinyl chloride).

7. The process of any of claims 1 to 4, wherein the organic polymer comprises at least one of a polyamide or copolyamide.

8. The process of any of claims 1 to 5, wherein the organic polymer comprises a polyolefin.

9. The process of claim 8, wherein the polyolefin comprises at least one of polyethylene or polypropylene.

10. The process of claim 8, wherein the polyolefin comprises at least one of linear low density polyethylene (LLDPE), medium density polyethylene (MDPE), or high density polyethylene (HDPE).

11. The process of claim 8, wherein the polyolefin comprises polyethylene prepared by catalytic polymerization using a metallocene catalyst.

12. The process of any of claims 1 to 11, wherein the polymer composition comprises 0.001 to 5 wt. %, preferably 0.01 to 2 wt. %, and more preferably 0.01 to 1 wt. %, based on the weight of the polymer composition, of the RMDA.

13. The process of any of claims 1 to 12, wherein the RMDA is at least one alkoxylated aliphatic alcohol according to Formula (I):
R—(OCHR¹CH₂)_{y}—OH (I),
wherein R is C₁₂-C₆₀ hydrocarbyl;
R¹ is H or C₁-C₄ alkyl; and
y is an integer from 1 to 100.

14. The process of any of claims 1 to 13, wherein the RMDA is at least one ethoxylated aliphatic ether according to Formula (Ia):
R—(OCH₂CH₂)_{y}—OH (Ia),
wherein R is C₁₂-C₆₀ hydrocarbyl; and
y is an integer from 2 to 60.

15. The process of claim 13 or 14, wherein R is derived from a fatty alcohol having the same number of carbon atoms.

16. The process of any of claims 13 to 15, wherein the RMDA is at least one of an ethoxylated and/or propoxylated laurel alcohol, C₁₂-C₁₃ alcohol, C₁₂-C₁₄ secondary alcohol, C₁₂-C₁₅ oxo alcohol, tridecyl alcohol, cetyl alcohol, C₁₆/C₁₈ alkyl alcohol, stearyl alcohol, oleyl alcohol, docosyl alcohol, or saturated, linear C₂₀-C₅₀ synthetic alcohol.

17. The process of any of claims 1 to 12, wherein the RMDA is at least one alkoxylated aliphatic ester according to Formula (II): 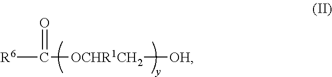
wherein R⁶ is C₁-C₅₉ hydrocarbyl;
R′ is H or C₁-C₄ alkyl; and
y is an integer from 1 to 100.

18. The process of any of claims 1 to 12, wherein the RMDA is at least one ethoxylated aliphatic ester according to Formula (IIa): 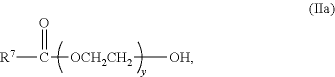
wherein R⁷ is C₁-C₂₉ hydrocarbyl; and
y is an integer from 2 to 60.

19. The process of claim 17 or 18, wherein the RMDA is at least one of an ethoxylated and/or propoxylated laurate, C₁₆-C₁₈ alkanoate, stearate, oleate, or tallowate.

20. The process of any of claims 1 to 12, wherein the RMDA is at least one alkoxylated aliphatic amine according to Formula (III):
R⁴—NR²R³ (III), or
alkoxylated aliphatic amide according to Formula (IV): 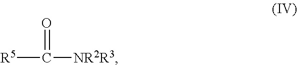
wherein R⁴ of Formula (III) is a C₈-C₆₀ hydrocarbyl and R⁵ of Formula (IV) is a C₇-C₅₉ hydrocarbyl, each optionally interrupted by one or more heteroatom;
R² and R³ of Formula (III) and Formula (IV) are each independently H, C₁-C₃₀ alkyl, or —(CH₂CHR¹O)ₙ—H;
at least one of R² or R³ of Formula (III) and Formula (IV) is —(CH₂CHR¹O)ₙ—H;
R¹ is H or methyl; and
each n is independently an integer from 1 to 100.

21. The process of claim 20, wherein R⁴ of Formula (III) is C₈-C₃₆ alkyl and R⁵ of Formula (IV) is a C₇-C₃₅ alkyl, both optionally interrupted by one or more heteroatom.

22. The process of claim 20, wherein R⁴ of Formula (III) is C₁₂-C₃₀ alkyl and R⁵ of Formula (IV) is a C₁i-C₂₉ alkyl, optionally interrupted by one or more heteroatom.

23. The process of any of claims 20 to 22, wherein each n is independently an integer from 1 to 10.

24. The process of any of claims 20 to 23, wherein R⁴ of Formula (III) is derived from a fatty acid having the same number of carbon atoms, and R⁵ of Formula (IV) is derived from a fatty acid having one more carbon atom.

25. The process of any of claims 20 to 24, wherein the RMDA is at least one of an ethoxylated and/or propoxylated stearyl amine, oleyl amine, tallow amine, hydrogenated tallow amine, cetyl amine, capryl amine, or coco amine.

26. The process of any of claims 20 to 24, wherein the RMDA is at least one of cocoamide monoethanol amine, cocoamide diethanol amine, a cocoamide ethoxylate; lauramide diethanol amine; oleamide diethanol amine, or oleic acid monoethanol amide.

27. The process of any of claims 1 to 26, wherein the polymer composition further comprises an organic phosphite or phosphonite.

28. The process of claim 27, wherein the phosphite or phosphonite is at least one of:
i) a compound according to any of Formulae (1) to (7): 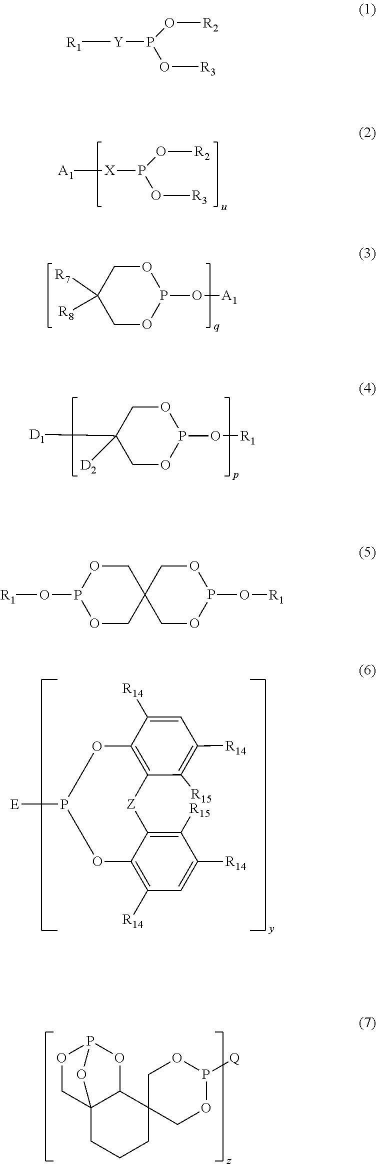
wherein:
the indices are integral and n is 2, 3 or 4; p is 1 or 2; q is 2 or 3; y is 1, 2 or 3; and z is 1 to 6;
A₁, if n or q is 2, is C₂-C₁₂ alkylene; C₂-C₁₂ alkylene interrupted by oxygen, sulfur or —NR₄—, a radical of the formulae: 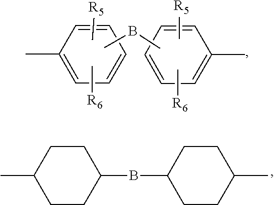
or phenylene;
A₁, if n or q is 3, is a divalent radical of the formula —CᵣH₂ᵣ₋₁—, wherein r is an integer from 4 to 12;
A₁, if n is 4, is 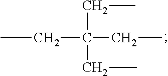
B is a direct bond, —CH₂—, —CHR₄—, —CR₁R₄—, sulfur, C₅-C₇ cycloalkylidene, or cyclohexylidene which is substituted by from 1 to 4 C₁-C₄ alkyl radicals in position 3, 4 and/or 5;
D₁, if p is 1, is C₁-C₄ alkyl and, if p is 2, is —CH₂OCH₂—;
D₂ is C₁-C₄ alkyl;
E, if y is 1, is C₁-C₁₈ alkyl, —OR₁ or halogen;
E, if y is 2, is —O-A₂-O—, wherein A₂ is as defined for A₁ when n is 2;
E, if y is 3, is a radical of the formula R₄C(CH₂O)₃ or N(CH₂CH₂O—)₃;
Q is the radical of an at least z-valent mono- or poly-alcohol or phenol, this radical being attached via the oxygen atom of the OH group of the mono- or poly-alcohol or phenol to the phosphorus atom;
R₁, R₂ and R₃ are each independently C₁-C₁₈ alkyl which is unsubstituted or substituted by halogen, —COOR₄, —CN or —CONR₄R₄; C₂-C₁₈ alkyl interrupted by oxygen, sulfur or —NR₄—; C₇-C₉ phenylalkyl; C₅-C₁₂ cycloalkyl, phenyl or naphthyl; naphthyl or phenyl substituted by halogen, 1 to 3 alkyl radicals or alkoxy radicals having a total of 1 to 18 carbon atoms or by C₇-C₉ phenylalkyl; or a radical of the formula 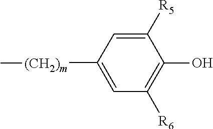
in which m is an integer from the range 3 to 6;
R₄ is hydrogen, C₁-C₈ alkyl, C₅-C₁₂ cycloalkyl or C₇-C₉ phenylalkyl;
R₅ and R₆ are each independently hydrogen, C₁-C₈ alkyl or C₅-C₆ cycloalkyl,
R₇ and R₈, if q is 2, are each independently C₁-C₄ alkyl or together are a 2,3-dehydropentamethylene radical; and R₇ and R₈, if q is 3, are each methyl;
each instance of R₁₄ is independently chosen from hydrogen, C₁-C₉ alkyl or cyclohexyl;
each instance of R₁₅ is independently hydrogen or methyl;
X and Y are each a direct bond or oxygen;
Z is a direct bond, methylene, —C(R₁₆)₂— or sulfur, and
R₁₆ is C₁-C₈ alkyl; or
ii) a trisarylphosphite according to Formula 8: 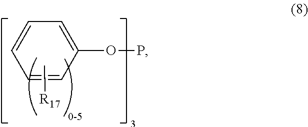
wherein:
R₁₇ is a substituent present at from 0 to 5 positions of the aromatic ring of Formula 8 and is independently C₁-C₂₀ alkyl, C₃-C₂₀ cycloalkyl, C₄-C₂₀ alkyl cycloalkyl, C₆-C₁₀ aryl, or C₇-C₂₀ alkylaryl.

29. The process of claim 27, wherein the phosphite or phosphonite is at least one of:
triphenyl phosphite,
diphenyl alkyl phosphites,
phenyl dialkyl phosphites,
trilauryl phosphite,
trioctadecyl phosphite,
distearyl pentaerythritol phosphite,
tris(2,4-di-tert-butylphenyl) phosphite (IRGAFOS™ 168),
tris(4-nonylphenyl) phosphite,
a compound of Formulae (A), (B), (C), (D), (E), (F), (G), (H), (J), (K), or (L): 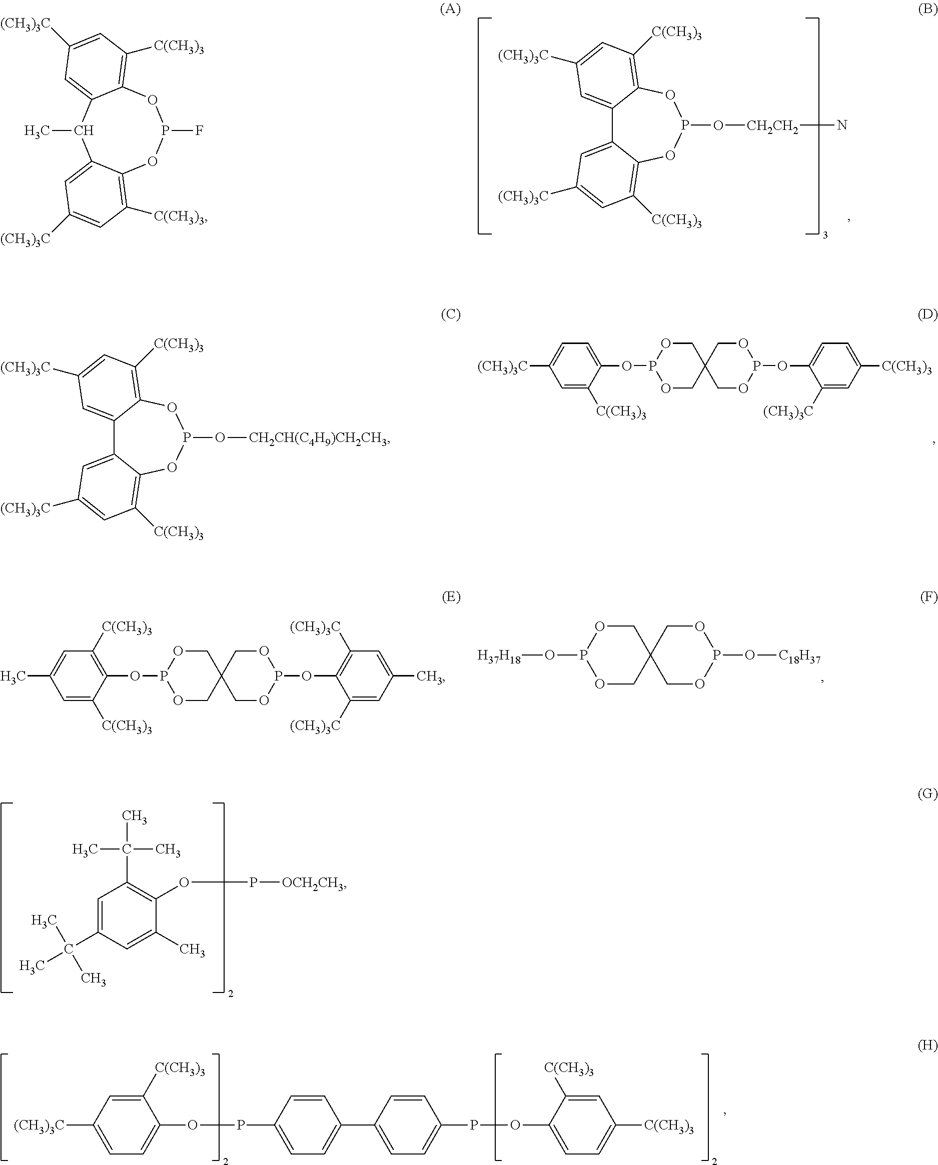 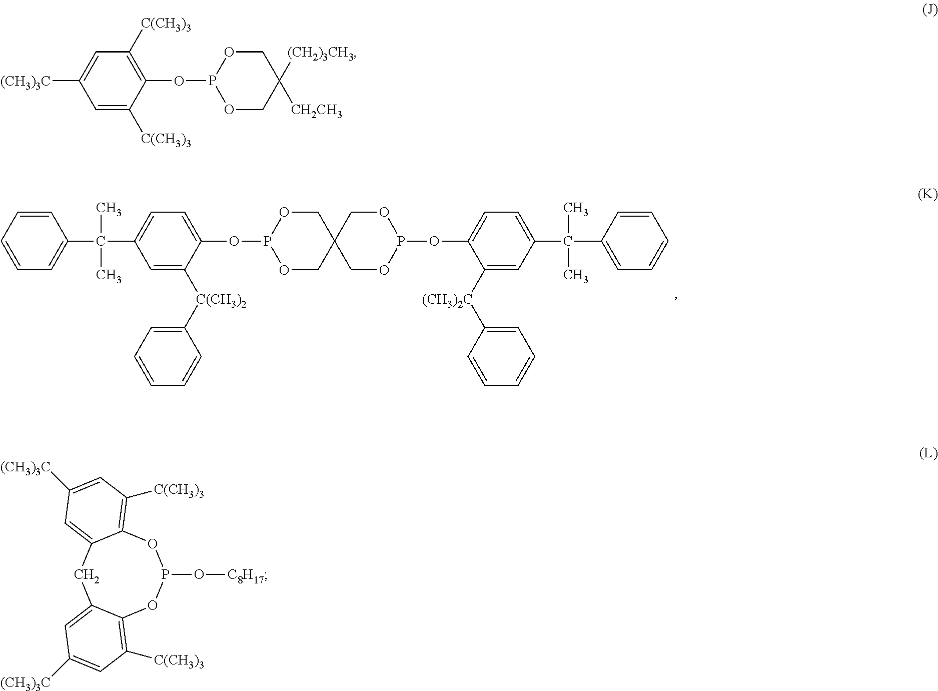
2-butyl-2-ethyl-1,3-propanediol 2,4,6-tri-tert-butylphenol phosphite,
bis(2,6-di-tert-butyl-4-methlphenyl) pentaerythritol diphosphite,
2-butyl-2-ethyl-1,3-propanediol 2,4-di-cumylphenol phosphite,
2-butyl-2-ethyl-1,3-propanediol 4-methyl-2,6-di-tert-butylphenol phosphite, or
bis(2,4,6-tri-tert-butyl-phenyl) pentaerythritol diphosphate.

30. The process of claim 27, wherein the organic phosphite or phosphonite is at least one of tris(2,4-di-tert-butylphenyl)phosphite (IRGAFOS™ 168), bis(2,4-dicumylphenyl)pentaerythritol diphosphite (DOVERPHOS™ S9228), tetrakis(2,4-di-tert-butylphenyl)-4,4′-biphenylene-diphosphonite (IRGAFOS™ P-EPQ), tris(4-nonylphenyl) phosphite, triphenyl phosphite, trilauryl phosphite, trioctadecyl phosphite, or distearyl pentaerythritol phosphite.

31. The process of any of claims 27 to 30, wherein the polymer composition comprises 0.001 to 5 wt. %, preferably 0.005 to 3 wt. %, and more preferably 0.01 to 1 wt. %, of the organic phosphite or phosphonite, based on the weight of the polymer composition.

32. The process of any of claims 1 to 31, wherein the polymer composition further comprises a hindered phenol.

33. The process of claim 32, wherein the hindered phenol has at least one group according to Formulae (IVa), (IVb), or (IVc): 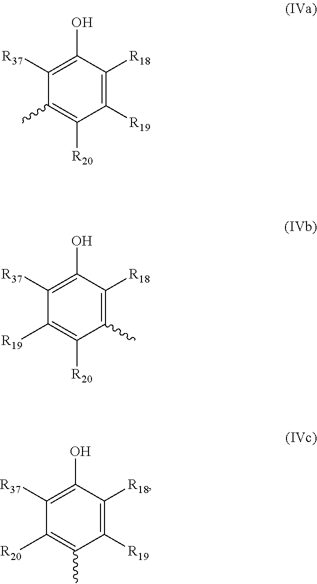
wherein:
“ [symbol] ” indicates the point of attachment (via a carbon-carbon single bond) of the molecular fragment to a parent compound;
R₁₈ of Formula (IVa), (IVb), and (IVc) is independently hydrogen or C₁₋₄ hydrocarbyl;
each of R₁₉ and R₂₀ of Formula (IVa), (IVb), and (IVc) is independently hydrogen or C₁-C₂₀ hydrocarbyl; and
R₃₇ of Formula (IVa), (IVb), and (IVc) is C₁-C₁₂ hydrocarbyl.

34. The process of claim 33, wherein R₁₈ and R₃₇ are each independently methyl or tert-butyl.

35. The process of claim 32, wherein the hindered phenol is at least one of: 1,3,5-tris-(3,5-di-tert-butyl-4-hydroxybenzyl)-2,4,6-trimethylbenzene (ETHANOX™ 330), bis-(3,5-di-tert-butyl-4-hydroxybenzyl)sulfide, 1,3,5-tris-(3,5-di-tert-butyl-4-hydroxybenzyl)isocyanurate (ETHANOX™ 314), 1,3,5-tris-(4-tert-butyl-3-hydroxy-2,6-dimethylbenzyl)isocyanurate (CYANOX™ 1790), dioctadecyl 3,5-di-tert-butyl-4-hydroxybenzylphosphonate, esters of β-(3,5-di-tert-butyl-4-hydroxyphenyl)propionic acid with monohydric or polyhydric alcohols, for example methanol, octadecanol (IRGANOX™ 1076), 1,6-hexanediol, neopentyl glycol, thiodiethylene glycol, diethylene glycol, triethylene glycol, pentaerythritol (IRGANOX™ 1010), tris-(hydroxyethyl)isocyanurate and N,N′-bis-(hydroxyethyl)oxamide, esters of β-(5-tert-butyl-4-hydroxy-3-methylphenyl)propionic acid with monohydric or polyhydric alcohols, for example methanol, octadecanol, 1,6-hexanediol, neopentyl glycol, thiodiethylene glycol, diethylene glycol, triethylene glycol, pentaerythritol, tris-(hydroxyethyl)isocyanurate and N,N′-bis-(hydroxyethyl)-oxamide, amides of β-(3,5-di-tert-butyl-4-hydroxyphenyl)propionic acid, for example N,N′-bis-(3,5-di-tert-butyl-4-hydroxyphenyl-propionyl)-hexamethylenediamine, or N,N′-bis-(3,5-di-tert-butyl-4-hydroxyphenylpropionyl)-trimethylenediamine.

36. The process of any of claims 32 to 35, wherein the polymer composition comprises from 0.001 to 5 wt. %, preferably 0.005 to 2 wt. %, and more preferably 0.01 to 1 wt. %, of the hindered phenol, based on the weight of the polymer composition.

37. The process of any of claims 1 to 36, wherein the polymer composition further comprises 0.01 to 1 wt. % of at least one of zinc stearate, calcium stearate, zinc oxide, hydrotalcite, or hydrocalumite.

38. The process of any of claims 1 to 37, wherein the polymer composition further comprises 0.01 to 25 wt. %, preferably 0.01 to 10 wt. %, preferably 0.02 to 5 wt. %, and more preferably 0.05 to 3 wt. %, based on the weight of the polymer composition, of at least one tocopherol, tocopherol ester, hydroxylamine, tertiary amine oxide, hindered amine light stabilizer (HALS), ultraviolet light absorber (UVA), hindered benzoate, thiosynergist, benzofuranone, indolinone, nitrone, or nickel phenolate.

39. The process of any of claims 1 to 38, wherein the polymer composition further comprises at least one of α-tocopherol, β-tocopherol, γ-tocopherol, δ-tocopherol, or esters thereof.

40. The process of any of claims 1 to 38, wherein the polymer composition further comprises α-tocopherol (Vitamin E).

41. The process of any of claims 1 to 38, wherein the tocopherol comprises α-tocopherol acetate (Vitamin E acetate).

42. The process of any of claims 1 to 41, wherein the polymer composition further comprises at least one hydroxylamine or tertiary amine oxide.

43. The process of any of claims 1 to 42, wherein the polymer composition further comprises at least one of N,N-dibenzylhydroxylamine,
N,N-diethylhydroxylamine, N,N-dioctylhydroxylamine, N,N-dilaurylhydroxylamine,
N,N-didodecylhydroxylamine, N,N-ditetradecylhydroxylaamine,
N,N-dihexadecylhydroxylamine, N,N-dioctadecylhydroxylamine N-hexadecyl-N-tetradecylhydroxylamine,
N-hexadecyl-N-heptadecylhydroxylamine, N-hexadecyl-N-octadecylhydroxylamine,
N-heptadecyl-N-octadecylhydroxylamine, or
N,N-di(hydrogenated tallow)hydroxylamine (IRGASTAB™ FS-042).

44. The process of any of claims 1 to 42, wherein the polymer composition further comprises N,N-di(hydrogenated tallow)hydroxylamine (IRGASTAB™ FS-042).

45. The process of any of claims 1 to 44, wherein the polymer composition further comprises a hindered amine light stabilizer (HALS).

46. The polymer composition of claim 45, wherein the hindered amine light stabilizer (HALS) is at least one of:
bis(2,2,6,6-tetramethylpiperidin-4-yl) sebacate (TINUVIN™ 770);
bis(2,2,6,6-tetramethylpiperidin-4-yl) succinate;
bis(1,2,2,6,6-pentamethylpiperidin-4-yl) sebacate;
bis(1-octyloxy-2,2,6,6-tetramethylpiperidyl) succinate;
bis(1-octyloxy-2,2,6,6-tetramethylpiperidin-4-yl) sebacate (TINUVIN™ 123);
bis(1,2,2,6,6-pentamethylpiperidin-4-yl) n-butyl 3,5-di-tert-butyl-4-hydroxybenzylmalonate;
a condensate of 1-(2-hydroxyethyl)-2,2,6,6-tetramethyl-4-hydroxypiperidine and succinic acid (TINUVIN™ 622);
2,2,6,6-tetramethylpiperidin-4-yl stearate;
2,2,6,6-tetramethylpiperidin-4-yl dodecanate;
1,2,2,6,6-pentamethylpiperidin-4-yl stearate;
1,2,2,6,6-pentamethylpiperidin-4-yl dodecanate;
a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);
tris(2,2,6,6-tetramethylpiperidin-4-yl) nitrilotriacetate;
4-stearyloxy-2,2,6,6-tetramethylpiperidine;
a condensate of N,N′-bis(2,2,6,6-tetramethylpiperidin-4-yl)hexamethylenediamine and 4-morpholino-2,6-dichloro-1,3,5-triazine (CYASORB™ UV-3346);
a condensate of N,N′-bis(2,2,6,6-tetramethylpiperidin-4-yl)hexamethylenediamine and 4-morpholino-2,6-dichloro-1,3,5-triazine, methylated (CYASORB™ UV-3529);
a condensate of 2-chloro-4,6-bis(4-n-butylamino-2,2,6,6-tetramethylpiperidyl)-1,3,5-triazine and 1,2-bis(3-aminopropylamino)ethane (CHIMASSORB™ 119);
a condensate of 2-chloro-4,6-bis(4-n-butylamino-1,2,2,6,6-pentamethylpiperidyl)-1,3,5-triazine and 1,2-bis-(3-aminopropylamino)ethane;
a condensate of N,N′-bis(2,2,6,6-tetramethylpiperidin-4-yl)hexamethylenediamine, N-butyl-2,2,6,6-tetramethyl-4-piperidinamine, di-n-butyl amine, and 2,4,6-trichloro-1,3,5-triazine (CHIMASSORB™ 2020);
a mixture of 4-hexadecyloxy- and 4-stearyloxy-2,2,6,6-tetramethylpiperidine (CYASORB™ UV-3853);
a mixture of 4-hexadecyloxy- and 4-stearyloxy-1,2,2,6,6-pentamethylpiperidine;
a condensate of N,N′-bis(2,2,6,6-tetramethylpiperidin-4-yl)hexamethylenediamine and 4-cyclohexylamino-2,6-dichloro-1,3,5-triazine;
a condensate of 1,2-bis(3-aminopropylamino)ethane, 2,4,6-trichloro-1,3,5-triazine, and 4-butylamino-2,2,6,6-tetramethylpiperidine;
a condensate of N,N′-bis(2,2,6,6-tetramethylpiperidin-4-yl)hexamethylenediamine and 4-cyclohexylamino-2,6-dichloro-1,3,5-triazine;
tetrakis(2,2,6,6-tetramethylpiperidin-4-yl)-1,2,3,4-butanetetracarboxylate;
tetrakis(1,2,2,6,6-pentamethylpiperidin-4-yl)-1,2,3,4-butanetetracarboxylate;
1,2,3,4-butanetetracarboxylic acid, 2,2,6,6-tetramethylpiperidinyl-4-yl tridecyl ester;
1,2,3,4-butanetetracarboxylic acid, 1,2,2,6,6-pentamethylpiperidin-4-yl tridecyl ester;
formamide, N,N′-1,6-hexanediylbis[N-(2,2,6,6-tetramethylpiperidin-4-yl) (UVINUL™ 4050);
a condensate of N,N′-bis(2,2,6,6-tetramethyl-1-(propyloxy)-piperidin-4-yl)hexamethylenediamine, N-butyl-1-propyloxy-2,2,6,6-tetramethyl-4-piperidinamine, di-n-butyl amine, and 2,4,6-trichloro-1,3,5-triazine (TINUVIN™ NOR HALS 371);
N,N′-bis(2,2,6,6-tetramethyl-4-piperidin-4-yl)hexamethylene diamine, polymer with 2,4,6-trichloro-1,3,5-triazine, reaction products with 3-bromo-1-propene, di-n-butylamine, and N-butyl-2,2,6,6-tetramethyl-4-piperidinamine, oxidized, hydrogenated (TINUVIN™ XT 200);
TINUVIN™ XT-850/XT-855); or
N¹,N^{1′}-1,2-ethanediylbis(1,3-propanediamine), reaction products with cyclohexane and peroxidized N-butyl-2,2,6,6-tetramethyl-4-piperidinamine-2,4,6-trichloro-1,3,5-triazine (FLAMESTAB™ NOR 116).

47. The process of any of claims 1 to 46, wherein the polymer composition further comprises an ultraviolet light absorber (UVA).

48. The process of claim 47, wherein the ultraviolet light absorber is at least one of a 2-hydroxybenzophenone, a 2-(2′-hydroxyphenyl)benzotriazole, a 2-(2′-hydroxyphenyl)-s-triazine, or a benzoxazinone.

49. The process of claim 47, wherein the ultraviolet light absorber is a 2-(2′-hydroxyphenyl)-s-triazine.

50. The process of claim 49, wherein the 2-(2′-hydroxyphenyl)-s-triazine is at least one of:
4,6-diphenyl-2-(4-hexyloxy-2-hydroxyphenyl)-s-triazine (TINUVIN™ 1577),
4,6-bis-(2,4-dimethylphenyl)-2-(2-hydroxy-4-octyloxyphenyl)-s-triazine (CYASORB™ 1164),
2,4-bis[2-hydroxy-4-(2-hydroxy-4-(2-hydroxyethoxy)phenyl]-6-(2,4-dimethylphenyl)-s-triazine,
mixture of 4,6-bis(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine (TINUVIN™ 400),
4,6-bis(2,4-dimethylphenyl)-2-(2-hydroxy-4(3-(2-ethylhexyloxy)-2-hydroxypropoxy)-phenyl)-s-triazine (TINUVIN™ 405),
4,6-bis(2,4-dimethylphenyl)-2-(2-hydroxy-4(3-(2-ethylhexyloxy)-2-hydroxypropoxy)-phenyl)-s-triazine,
2,4-bis(2,4-dimethylphenyl)-6-[2-hydroxy-4-[(octyloxycarbonyl)ethylideneoxy]phenyl]-s-triazine (TINUVIN™ 479),
2,4-bis(4-biphenylyl)-6-[2-hydroxy-4-[(octyloxycarbonyl)ethylideneoxy]phenyl]-s-triazine,
2,4-bis(4-biphenylyl)-6-[2-hydroxy-4-(2-ethylhexyloxy)phenyl]-s-triazine (TINUVIN™ 1600),
2,4-bis(2-hydroxy-4-butyloxyphenyl)-6-(2,4-bis-butyloxyphenyl)-s-triazine (TRIAZINE™ 460),
2,4,6-tris[2-hydroxy-4-(3-sec-butyloxy-2-hydroxypropyloxy)-phenyl]-s-triazine, or
2,4,6-tris[2-hydroxy-4-[(octyloxycarbonyl)ethylideneoxy]phenyl]-s-triazine (TINUVIN™ 477).

51. The process of any of claims 1 to 50, wherein the polymer composition further comprises at least one of a metal chelating agent, nucleating agent, lubricant, plasticizer, compatibilizer, blowing agent, flame retardant, anti-block agent, slip agent, anti-static agent, filler, reinforcing agent, metal oxide, optical brightener, dye, or pigment.

52. A hollow article prepared by the process of any of claims 1 to 51.

53. Use of a rotational molding densification accelerator (RMDA) selected from the group consisting of alkoxylated aliphatic alcohols, alkoxylated aliphatic esters, alkoxylated aliphatic amines, alkoxylated aliphatic amides, and combinations thereof, in a rotational molding process for producing a hollow article.
